(19) United States
(12) Patent Application Publication
(10) Pub. No.: US 2008/0279287 A1
(43) Pub. Date: Nov. 13, 2008

(54) Code Type Transmitting Device and Code Type Receiving Device

(76) Inventor: Tadashi Asahina, Saitama (JP)

Correspondence Address: WENDEROTH, LIND & PONACK, L.L.P., 2033 K STREET N. W., SUITE 800, WASHINGTON, DC, 20006-1021, US

(21) Appl. No.: 11/884,745

(22) PCT Filed: Feb. 22, 2006
(86) PCT No.: PCT/JP2006/303179

§ 371 Date: May 16, 2008

(30) Foreign Application Priority Data
Feb. 22, 2005 (JP) 2005-084755

(51) Int. Cl. H04B 14/04

(52) U.S. Cl. 375/242

(57) ABSTRACT

Provided is a communication system which exploits status information expressed in the shift time of a code series. A code type transmitting device 1 for converting input data into the shift time of a code pulse train and transmitting the shift time comprises means 80 for generating a synchronizing signal to trap or hold a synchronism, means 50 for generating a sequential pulse train at a timing based on the synchronizing signal, means 70 for generating such a data code pulse train sequentially with the sequential pulse train as has a shift time determined according to the input data, and means 70 for generating and sending out a transmission signal, with the signal which is based on a transmission signal generating pulse train containing a fundamental pulse train having at least the data code pulse train.

### TECHNICAL FIELD

This invention is related to code type transmitting devices and code type receiving devices for transmitting data by making use of the shift times of pulse sequences representing pseudo-random code sequences.

### CURRENT TECHNOLOGIES

In conventional technologies for data transmission by using pseudo-random codes sequences (PRC), at the transmitting side, data are divided into data blocks each of which is fit in with a pulse sequence among those of plural kinds of PRCs or a multi level pulse sequences that are made by combining pulse sequences representing plural kinds of PRCs. These pulse sequences modulate sub-carriers to generate modulated sub-carriers for transmission.

For the receiving side, systems based on the M-ary DS-SS (Direct Sequence-Spread Spectrum) systems for which sub-carriers are demodulated from the detected signals to find its pulse sequences through a cross-correlation processing, matched filtering, etc. to reduce noise affection and the data are estimated by using reverse mapping method are used. A parallel M-ary DS-SS method are also used for receivers.

The conventional systems also use pulse sequences representing PRCs with spread sub-carriers by a bit stream of data pulses for transmission. The receiver uses the DS-SS method to carry out demodulation of the sub-carriers and despread of the detected sub carriers to estimate the transmitted data. The DS-SS systems is also used to separate data pulses using despread of the signal and spread of the narrow band noise to the outside of the signal band reducing affection of noise while signals remain in the band.

A DS-SS system for use in multiple access environment is also commercialized. At the transmitting side of the system, inter-leave method is directly applied to primary data to modulate the sub carriers with different frequencies by the interleaved data, then modulated signals spread by a common PRC pulse sequence are generated and multiply added to be transmitted.

At the receiving side, the detected signal is despread, then reverse interleave method is applied to the signal to enable detection of the demodulated sub-carriers from which primary data are detected by suppressing interference between adjacent data sent through the transmission lines with large dispersion due to delay time. A method to apply the interleave process to SPC (Serial to Parallel Conversion) data pulse sequences is also available.

In these systems, the despreading and localization of the PRC pulses are executed through maintaining synchronization, so that a serial synchronization PRC pulse sequence of single code located prior to data signal(s) or modulated data signal(s) is transmitted and the receiver detects the signal to establish synchronization, and in the event that the system is in synchronization, uses it for maintaining the status.

The DS-SS method is one of the CDMA (Code Division Multiple Access) methods which divide a frequency band by using PRC code(s) so that two or more users can communicate simultaneously in it. A frequency hopping (FH) method is also used as a spread spectrum method. In this method, at the transmitting side, the hopping carrier modulated by data symbols hops in time domain in accordance with a PRC pulse sequence. At receiving side, the signal is detected in accordance with the sequence representing the hopping sequence and the primary data is estimated. The frequency hopping method reduces the fading effects and inter-station interferences and it makes use of PRCs that are engineered to reduce hit probability among signals by multiple users.

The PRCs that are used in the DS-SS system and the FH system include binary or multi-level codes of Maximum Length Code, Gold code, KAZAMI code and so forth.

A pulse transmission system of frequency division is also in use. In the system, a frequency band is divided into a number of narrow bands sub-carriers of which are modulated by multi-level pulses and multiply added to be sent. OFDM (Orthogonal Frequency Division Multiplexing) system, the sub-carriers of the adjacent narrow bands of which are intersect perpendicularly, belongs to this system and is now in use for digital TV (television), wireless LAN (local area network) and so forth. At the transmitting side of the OFDM system, each complex sub-carriers are modulated by complex signals obtained from a bit stream of data through serial to parallel transform and multiply added, so that the duplex signal for transmission is generated by using the main carrier which is modulated by the real part (I part) and the imaginary part (Q part) of the complex signal. In order to simplify the equipment and so forth, some transmitters make use of IDFT (Inverse Digital Fourier Transform) rather than the devices to modify the complex sub-carriers by the complex data in each narrow band respectively, so that the modulated sub-carriers are generated from parallel data in a lump.

At the receiving side, demodulation by a quadrature demodulator is conducted by making use of the detected signal, then, the primary data signal of each band is demodulated from its real part and imaginary part and the bit stream of the primary data is obtained through parallel-to-serial conversion. For simplification of the equipment and some other reasons, in some cases an FFT (Fast Fourier Transform) processing method is used to obtain demodulated data signals of the narrow bands from the real part and the imaginary part of the detected signals in a lump.

For modulation of OFDM systems, multi-level QAM (Quadrature Amplitude Modulation), QPSK (Quadrature Phase Shift Keying), DQPSK (Differential QPSK) and so forth are utilized. In addition, the OFDM system uses a guard interval for a transmission signal to reduce the distortion of its waveform due to multi-paths.

Other systems for transmitting pulses in use are those of multi-level QAM in which the carriers intersecting perpendicularly are modulated by the multi-level data pulses, DMT (Discrete Multiple Tone) for ADSL (Asymmetric Digital Subscriber Line) in which OFDM and multi-level QAM technologies are combined, and so forth.

The UWB (Ultra Wide Band) systems that uses ultra wide band for transmission of information are categorized into an impulse radio system that makes use of narrow pulses about several hundred pico-second in microwave or milli-wave range, a wide band system which uses over 500 MHz signal band, an MB-OFDM (Multi Band-OFDM) system that is an OFDM system having 14 sub-channels of about 500 MHz in the band from 3.1 GHz to 10.6 GHz 5 channels out of which are used for logics, a system having the band rate, defined as the band width used for transmission against central frequency is over 20%, and so forth. Standardization of UWB is in process at the IEEE 802.15 TG3a section.

For sub-carrier or main carrier modulation in any transmission system, the linear modulation by a binary signal or a multi-level signal is used and BPSK (Binary Phase Shift Keying), PSK (Phase Shift Keying), DPSK (Differential Phase Shift Keying) and so forth use binary modulation.

As to RF IC (Radio Frequency Integrated Circuit) tags which work in the high frequency band, some products with ROMs (Read Only Memories) are used exclusively for read the powers of which are supplied through electromagnetic induction by input signals. Some other products including micro processors with power sources have data processing function. Any of them has an antenna co-used by an input circuit and an output circuit and data, and bit data are used for them. A reader/writer to write bit data to the memories of the RFIC tags and read them are also in use.

The conventional technologies described hereinabove are written in the following non-patent literatures 1˜10:

[non-patent literature 1] Spread Spectrum Communications and their applications,
Hajime Marubayashi, et. al, The institute of Electronics Information and
Communication Engineers (IEICE)
   [non-patent literature 2] Modulation/Demodulation for digital wireless communication
Yoichi Saito, IEICE Publish.
   [non-patent literature 3] Report on transmitter/receiver circuits for ultra wideband wireless telecommunications, Takahide Terada, et al., 2004, Apr. 8 The report of the first Silicon-Analog RF Research,
   [non-patent literature 4] Analysis of the Capabilities of the Next Generation Wireless Communication Technologies, Nicholas Cravott, EDN Japan, 2003.1
   [non-patent literature 5] Spread Spectrum Communication, Yukiji Yamauchi, Tokyo Electric University Publishing Department,
   [non-patent literature 6] Technologies and Services of the Digital Broadcasting, Yamada, et al, Corona, p 146-161
   [non-patent literature 7] Digital Wireless Transmission Technologies, Seiichi Sanpei, Pearson Education Publishing
   [non-patent literature 8] UWB, Wikipedia
   [non-patent literature 9] IEEE802.15 TG3a, IEEE Standard
   [non-patent literature 10] Ubiquitous Technologies-IC Tag, Mitsuo Usami, et al., Ohmsha

### DISCLOSURE OF THE INVENTION

### Subject to be Solved by the Invention

Conventional data transmission systems that use code sequences have a problem in that the communication resources are not effectively used because status information represented by the shift time of the code sequences are not sufficiently in use. In addition, there is another problem that it is not so easy for this kind of methods to achieve a high transmission rate that the applications of even the multi-level M-ary which is one of the highest rate methods among those that use PRCs are limited to considerably low rate data transmission systems because the number of codes used for the system increases in accordance with the block size of the data transmitted, which requires complicated processing and structures especially for receivers.

Moreover, in the DS-SS systems that transmit data pulses spread by PRC pulse sequences, despread process cannot spread wide band noise such as thermal noise to the outside of the signal band. Moreover, the M-ary system requires many kinds of code sequences of enough length to eliminate narrow band noise, thermal noise and so forth in the process of calculating correlation, filtering by making use of matched filters and so forth causing long detection time, which decreases processing speeds and complicates the system structures. Because of these reasons, it is said that the conventional systems have the problem in that achieving the sufficient transmission speed by reducing noise affects under noise circumstances with narrow band and/or wide band noise is difficult.

On the other hands, the frequency hopping system the transmission signal of which consists of hopping carriers modulated by the data pulse stream has the problem in that to increase the speed by sending data signal using multi-level pulses is difficult because the hopping chips are detected individually and test without improving the SNR (signal to noise ratio).

In linear pulse modulation systems, information transmitted is in proportion to the number of bits of amplitude which makes the increase of the transmission rate slow against the increase of amplitude, so that it is difficult to achieve a high transmission rate. In addition, there is a problem that SNR cannot be improved enough in the process of detection.

In addition, since communications through lines with heavy attenuation is affected by near-end crosstalk, thermal noise and so forth, the communicable distance is limited.

In the UWB (Ultra Wide Band) communications systems which uses impulse sequences or modulated carriers by impulse sequences, the impulse width and its generating rate are limited to suppress the performance of the high transmission speed.

This invention described herein is proposed to solve these problems and the purpose of which is to provide transmitters and receivers that make use of the state information represented by the shift time of the code pulse sequences.

### Means to Solve the Problems

The present invention includes the transmitting side that converts data into shift times of the code pulse sequences and sends those pulses, and the receiving side that detects the shift time by localizing the detected signal and calculates data from the shift times. The use of the shift times enables use of the state information of the code pulse sequences.

The transmitting side generates signals with which the receiving means perform acquisition and tracking of synchronization. In addition, the transmitting side generates code pulse sequences for ordering in synchronization with the synchronous signals, then generates the data-mapped code pulse sequences the shift times of which are set in accordance with the ordering sequence and the data. Next, the transmitting side generates the transmission signals by making use of the transmission signal generating pulse sequences which contain the basic pulse sequences that have at least the data-mapped code pulse sequences, then the signals are sent.

The basic pulse sequences may contain encoded data for error correction and/or encoded pulse sequences for error correction. In addition, the transmission signal generating pulse sequences may have frames for packet transmissions.

The signals based on the transmission signal generating pulse sequences of the inventions include, at least, the multiply added basic pulse sequences, impulse sequences generated based on the multiply added basic pulse sequences, the pulse sequences of the bit stream generated by converting the amplitude of the chips of the multiply added basic pulse sequences into the binary pulses, the impulse sequences generated based on these pulse sequences of the bit stream, the signals modulated by these pulses or impulses, the modulated signals for OFDM systems generated by making use of these signals and the frequency hopping signals whose hopping carriers are modulated by these signals, and the transmitters and the receivers are configured to utilize one of these signals.

The receivers are configured to communicate with the transmitters and receive the transmitted signals to calculate the data. In the process, the signals including the data-mapped code pulse sequences are detected from the received signals, then, the data-mapped code pulse sequences are localized to obtain the shift times from the localized pulses, and by using the shift times data are calculated. If the transmitter signals are generated by encoding the data pulses, the basic pulse sequences or the multiply added basic pulse sequences to correct errors, the receivers execute decoding of error correction to calculate the original data. In addition, the receivers may have means to eliminate interference noise for detection of the data mapped code pulse sequences and/or the localized pulses.

The signals including the data-mapped code pulse sequences herein are, but not limited to, the signals of the data-mapped code pulse sequences, the modulated signals by the data-mapped code pulse sequences, etc.

The localization of the signals herein means generation of the characteristic pulses of the codes on the coordinate representing the correlation parameter tau (τ) by calculating the correlation between the signal that contains the code pulse sequence and the local code pulse sequence made of the same code, or generation of the characteristic output pulses of the matched filter made of the same code as the input signal. The variable may be, but not limited to, time or the shift time of the code pulse sequences. Localization needs the signal length of a period or periods.

The transmission signal herein represents, but not limited to, an impulse sequence generated based on the transmission signal generating pulse sequence, a modulated signal by the impulse sequence, a pulse sequence made of the transmission signal generating pulse sequence, a signal modulated by the pulse sequence, a signal that has sub-modulation by the transmission signal generating pulse sequence, a signal modulated by the sub-modulated signal, an OFDM signal with the sub-modulation, or a signal whose hopping carrier is modulated by the sub-modulated signal.

The primary modulation of the inventions for transmission of the amplitude information of the multiply added basic pulse sequences or those impulses employs a linear modulation or FM (Frequency Modulation) modulation. For Example, the linear modulation herein means, but not limited to, APSK (Amplitude Phase Shift Keying) and AM (Amplitude Modulation). On the other hands, the modulation by the bit stream converted from the amplitude of the multiply added basic pulse sequences employs a binary pulse modulation such as PSK (Phase Shift Keying) including BPSK (Binary Phase Shift Keying), FSK (Frequency Shift Keying), ASK (Amplitude Shift Keying), AM (Amplitude Modulation), FM (Frequency Modulation), etc. for transmission of binary data.

The synchronous signals of the inventions herein are the signals to carry the information on synchronization and form a part of the transmission signals. In the event that transmitters execute acquisition and/or tracking of synchronization by making use of data signals, the data signals are deemed to be synchronous signals.

On the other hands, the data signals are the signals that carry information on data and include, but not limited to, impulse sequences, pulse sequences and modulated signals by these sequences carrying data information. The impulse represents an isolated waveform the average amplitude of which is zero and some of the examples are, but not limited to, a short period waveform that has plural peaks and a modulated short signal whose average amplitude is zero.

The ordering code pulse sequence herein means a code pulse sequence the type of which represents the order or a code pulse sequence the shift time of which varies in ascending order, descending order or in fixed order to represent the order.

In the case that the ordering code pulse sequence is composed of a code pulse sequence or sequences which differ from the code that is used for the data-mapping, the ordering of the pulse sequence having the pulse length of N in the multiply added basic pulse sequences is done by using a PRN pulse sequence that has the pulse length of NK where K is the chip ratio defined as chip width of the code pulse sequence for data-mapping versus chip width of the code pulse sequence for ordering. Data mapping means to map data onto the shift time of the code pulse sequence or sequences. If the degree of multiple addition m which represents the number of the sequences multiply added exceeds NK, then another sequence is added. In other words, the number of the types of sequences required is 1+[m/(NK)], where [m/(NK)] represents the maximum integer not exceeds m/(NK).

On the other hands, ordering the data-mapped code pulse sequences having the code length of N to form p sets of the multiply added basic pulse sequences may be done by allocating the necessary number of different code pulse sequences that have the code length of NK and the chip rate of K to each of the sets, or by repeatedly using a set consisting of the necessary number of code pulse sequences for each of the p sets, or by using necessary number of code pulse sequences having the code length of pNK.

The basic pulse sequence herein means the data-mapped ordering basic pulse sequence consisting of the data-mapped ordering pulse sequence or the product basic pulse sequence containing the pulse sequence made of the data-mapped code pulse sequence multiplied by the ordering pulse sequence. These pulse sequences may contain control pulses which have positive or negative polarity fixed according to the ordering sequences in order that interference from other pulse sequences are minimized when the receiver detects the localized pulses.

As stated hereinabove, the control pulses are so composed to reduces internal interference noise in the data calculation process. In addition, the product basic pulse sequences may be composed to make the spectrum of the transmission signal generating pulse sequences flatter and to reduce the narrow band noise and the interference noise superimposed when the localized pulses are detected.

In addition, the use of the basic pulse sequences enables the transmission of the data by using the data-mapped code pulse sequences in accordance with the ordering pulse sequences, so that the increase of the number of the types of the codes are suppressed.

If the multiply added basic pulse sequence is made of a single basic pulse sequence or has the structure resistant to interference, data can also be represented by using both the amplitude of the control pulses and the shift time of the data-mapped code pulse sequences.

If the control pulse is applied, the localized pulse has the polarity determined by the control pulse.

In case of the multiply added product basic pulse sequences being employed, the receiver detects the transmission signal generating pulse sequences from the received signals which are multiplied by the ordering signals and filtered, then the filtered signals are localized to detect the shift times from which data are calculated. Making products of the detected transmission signal generating pulse sequence and the ordering pulse sequence separates the data-mapped code pulse sequence to spread internal interference noise. In addition to the SNR being improved in proportion to the chip ratio K through the despreading process, the data-mapped code pulse sequences are converted into the localized pulses and the narrow band noise including interference noise and wide band noise such as thermal noise become smaller, so that the SNR at the peaks of the localized pulses are improved. The noise energy employed to calculate the SNR may be covariance of the localized signal at its peak. The localized signal is generated by localizing the detected signal that includes the data-mapped code pulse sequences.

The chip herein means the basic pulse of the basic width composing the code pulse sequence. The code pulse sequence that has the code length of N consists of N chips. The number of the chips of the product basic pulse sequence is equal to the number of the chips of the ordering pulse sequence. The multiply added basic pulse sequence has the same number of chips as its basic pulse sequences and each of the chips has the multi level amplitude as the multiply added signal. In addition, the reciprocal of the chip width represents the chip speed. The chip of the hopping signal represents the interval between hopping.

The data herein means the original data or the encoded data for error correction. The encoded data are converted into the notation system of base N consisting of the figure number of m. The original data can be converted into the notation system of base N with m-figure number first, then encoded for error correction. The encoded data are decoded from the shift time indicated by the localized pulse of the data-mapped code pulse sequence. A set of chips of the basic pulse sequence encoded for error correction are also usable for transmitting signal. In addition, the chip set of the multiply added basic pulse sequences may be encoded for error correction. It is preferred that the encoded basic pulse sequences and the encoded multiply added basic pulse sequences be decoded first, then the data-mapped code pulse sequences are separated in the receiving devices.

The synchronous signals include the timing impulse sequences, the timing pulses sequences, or the code pulse sequences that carry the timing information to establish synchronization. Acquisition and tracking of the synchronization can also be done by using the pulse sequences of the data signals.

The data signals that are the transmission signals to transmit data information herein represent, but not limited to, the basic pulse sequences, the multiply added basic pulse sequences, the transmission signal generating pulse sequences consisting of the binary pulse sequences or the encoded binary pulse sequences for error correction converted from the multiply added basic pulse sequences, the impulse sequences generated based on the transmission signal generating pulse sequences, and the modulated signals or the multiply added modulated signals by these sequences.

The order is represented by the ordering pulse sequences. The basic pulse sequences contains the data-mapped code pulse sequences that are ordered and are divided into two categories one of which is the data-mapped ordering basic pulse sequence group and the other is the product basic pulse sequence group. The data-mapped ordering basic pulse sequence consists of either the data mapped ordering pulse sequence or the product of the data-mapped ordering pulse sequence and the control pulse. On the other hands, the product basic pulse sequence that employs different sequence or sequences for data mapping from the ordering sequence or sequences is either the product of the data-mapped pulse sequence and the ordering pulse sequence or the product sequence that includes the control pulse multiplied as well.

It is preferable that the code pulse sequences of the small absolute cross-correlation values be used to reduce the inner interference for detection of the localized pulses. Those devices that are used asynchronously at the same time are preferably to be so composed that they employ the code pulse sequences that have small partial auto-correlation or partial cross-correlation in addition to cross-correlation.

The modulation of the sub-carrier by the basic pulse sequence is conducted in the way, but not limited to, that first the sub-carrier is modulated by the data-mapped code pulse sequence or by the pulse sequence made of the data-mapped code pulse sequence multiplied by the control pulse, then the ordering pulsesequence is multiplied, or the sub-carrier is modulated by the basic pulse sequence first. Similarly, the modulation of the carrier by the basic pulse sequence is done. The sequence generated by multiplying the data-mapped code pulse sequence by the ordering pulsesequence or more pulse/pulses and/or pulse sequence/sequences represents the basic pulse sequence regardless of the order.

The control pulses are so controlled in accordance with the order that they reduces the internal interference from other basic pulse sequences when the data-mapped code pulse sequences or the localized pulses are detected.

The noise herein includes, but not limited to, the interference noise, the wide band noise such as thermal noise and the block noise which is externally generated to bring about piecewise affects to the detection of the signals. The interference noise is divided into the inner interference noise and the external interference noise. The inner interference noise appears from other basic pulse sequences when the data-mapped code pulse sequence is detected in the process of separation from the multiply added basic pulse sequences and/or the localized pulse is detected. On the other hands, the external interference noise includes the signals received from other transmitters than the communicating transmitter when multiple transmitters are used simultaneously.

### ADVANTAGEOUS EFFECT OF THE INVENTION

The inventions bring about the following outcomes:

The mapping of the data onto the shift times of the code pulse sequences enables the use of their state information, which anables effective use of telecommunications resources.

The multiply added pulse sequences can be so composed that the number of the codes used is reduced by converting the data into the shift time or the kinds of the code pulse sequences.

The introduction of the ordering pulse sequences enables the basic pulse sequences having the data-mapped code pulse sequences to be multiply added. In addition, the use of the multiply added basic pulse sequences which are made by multiplying the data-mapped code pulse sequences by the high speed ordering pulse sequences enables the despread of the signal for separation of the data-mapped code pulse sequences by reducing the effects of the inner noise and the localization of the separated sequences for detection of the shift time by decreasing the effects of the narrow band noise including the internal interference and the wide band noise like thermal noise. In addition, the use of the appropriate control pulse contributes to reduction of effects of the internal noise to improve the transmission quality.

The receivers of the telecommunications systems herein used including the UWB system, the pulse transmission system, the modulated signal transmission system, the frequency hopping system and so forth separate the pulse sequences and localize them to detect the shift time, so that the nonlinear distortion by the amplifiers, for example, is reduced.

The transmission rate in proportion to the degree of multiple addition is achieved by the invention since the data signals made of the multiply added basic pulse sequences carry the data in accordance with the following formula:

(m log₂N)/(TcKN),

where log₂N represents the logarithmic code length, m represents the degree of multiple addition and 1/Tc represents the chip rate. Since the transmission rate of the conventional pulse transmission technologies by converting a signal that has amplitude m is expressed by (log₂m)/Tc, the transmission rate of the present inventions represented by this formula increases monotonically and exceeds the conventional rate while m increases. Resultantly, the system of the invention can achieve the higher transmission rate than the conventional ones where m exceeds the value that the rate of the inventions and that of conventional ones become equal. In addition, the transmission quality of the inventions is improved larger than that of the conventional ones because, in the despreading process, the SNR in connection with the narrow band noise is improved to the extent of the chip speed K. Furthermore, it is improved in proportion to the code length against the narrow band noise and the wide band noise through the localization process. Resultantly, both high transmission rate and high channel capacity are achieved due to the inventions herein.

Because the shift time is detected by localizing the data mapped code pulse sequences, the ratio of (power of the localized pulse at the peak) to (noise power) is improved and the pulse detection that requires lower SNR is applied to the localized signals having improved SNR. Consequently, the transmission quality of the inventions herein is improved.

Encoding for error correction is applicable to the original data pulses, the basic pulse sequences and/or the multiply added basic pulse sequences, so that the error rate will be improved and confidentiality will increases.

The use of the product ordering sequences of the inventions enables composition of the large scale order, so that the degree of multiple addition of the basic pulse sequences and the number of the transmitting devices/receiving devices that can be used simultaneously will increase.

The invention lessens affects of the noise to extend the communicable reach because of the use of the pulse detection technique through the localization of the data-mapped code pulse sequences.

The invention is applicable to the wired and wireless frequency division systems including the OFDM system in which reflection, attenuation, interference, thermal noise and so forth differ from one sub-band to another because the transmitting means is so composed that the transmission is done by controlling the output power, the phase and so forth of each sub-band. The OFDM can have sub-bands over 500 MHz and/or the band width ratio which represents the spectrum width of the signal to the band width can be over 20%.

The SNR improvement ratio of the inventions is denoted as (SNR improvement ratio K by despread)*(SNR improvement ratio R by localization), so that the improvement ratio for the narrow band noise is synergistically achieved by the despread and the localization. For example, in the case that K and R are 50 and 50, respectively, the narrow band SNR improvement ratio is 2,500 (34 dB). As the result of improvement of the SNR, the communicable reach will be extended compared with that of conventional digital transmission systems used for ADSL communications, multilevel QAM and so forth.

In addition, the use of the control pulse and the canceller based on the localized pulse will contribute to the increase of the number of the equipment used simultaneously for multiple access communications by reducing both the internal interference and the external interference.

The present invention enables the improvement of the SNR for detection of the signals and the transmission of the high unit frequency transmission rate (bits/sec/Hz) in proportion to the degree of the multiple addition of the basic pulse sequences. For example, the transmission rate of the invention to that of the DMT (Discrete Multiple Tone) system used for conventional ADSL communications is proportional to m/log₂m which increases monotonically in accordance with the increase of m and is greater than 1 for m that exceeds a certain value. For detailed description, it is assumed that A is a constant and the ratio is represented as A m/log₂M. According to this presentation, the ratio for m=2⁸ and 2¹⁴ are 32A and about 1,100A, respectively. Additionally, for the sequence whose code length N and chip ratio K are 15 and 50, respectively and degree of multiple addition m for 1 the channel and the Q channel is 2¹⁴, the information transmitted by a chip of the systems of the inventions is 2×4×2¹⁴/15/50≈0.170 (bits/chip), and the transmission rate is about 2×4×2¹⁴/15/50/Tc≈0.170/Tc (bits/sec), where Tc represents the chip width. In addition, for the signal whose N and K are 7 and 20, respectively and m for both channels is 2¹⁴, the information per chip is 2×3×2¹⁴/7/20 which is about 700 (bits/chip), so that the transmission rate is about 700/Tc (bits/sec).

Since the signal fits in an ADC (Analog to Digital Converter) as large as 15 bits or more or a CCD (Charge Coupled Device), speed-up of the transmission rates of ADSL, VDSL (Very high-speed Digital Subscriber Line) and so forth based on DMT by using about 250 bins for 8 bit data, for example, can be suitably done by the inventions.

As is well know to those skilled in the arts, evaluating the effects of the noise on the reproducibility of the digitalized code pulse sequences is preferably required. The procedure including the evaluation of the localized pulse is that localizing the separated data-mapped code pulse sequences is executed first, then, evaluation be preferably done by using for example, the peak energy of the localized pulse and square of its variance.

The invention related to the transmission of the binary pulses obtained by converting the amplitude of the signal made of multiply added basic pulse sequences into the binary pulses enables achievement of the high transmission rate as written (m log₂N)/(TcKN log₂m) (bit/sec) while maintaining the SNR as the pulse transmission. The signal made of the multiply added basic pulse sequences is generated by multiply adding the product basic pulse sequences comprising the data-mapped code pulse sequences by the ordering code pulse sequences.

In addition, memorization of the binary pulses invented herein enables enlargement of the memory capacity of the cell to an extend that it is expressed as (m log₂N)/(KN log₂m) (bit/cell). The memorization system of the invention employing the procedure to generate the multiply added basic pulse sequences by using the original data, to convert their chips into binary pulses and to memorize those pulses is called the distributed memorization system. As an example, the cell memorization efficiency B of the invention is about 80 (bit/cell) for m=2¹⁶, K=20 and N=7 while the conventional memory systems have cell memorization efficiency Bc of 1 (bit/cell) under the same condition.

### BRIEF EXPLANATION OF THE DRAWINGS

FIG. 1 represents an embodiment of the code type transmitting device 1 of the present invention.

FIG. 2 represents an embodiment of the error correction encoding means 20.

FIG. 3 This figure represents the data-mapped code pulse sequence generating means 30 of the FIG. 1 for the transmission of impulses, pulses, modulated signals by the impulses or pulses, or frequency hopping signals.

FIG. 4 This figure represents an embodiment of the data-mapped code pulse sequence generating means 30 of the FIG. 1 for the parallel modulation, the orthogonal modulation or the frequency hopping.

FIG. 5 This figure represents the data-mapped code pulse sequence generating means 30 of the FIG. 1 for the OFDM system to a transmit stream modulation signal, an impulse, a frequency hopping signal or others.

FIG. 6A This figure represents the linear transmission signal generating means 70 of the FIG. 1 and contains the data-mapped code pulse sequence generating means of the FIG. 3.

FIG. 6B This figure represents another embodiment of the transmission signal generating means 70 of the code type transmitting device 1 shown in FIG. 1 and has the data-mapped code pulse sequence generating means of the FIG. 3 for the modulation using the binary pulse sequences.

FIG. 7A This figure represents an embodiment of the transmission signal generating means 70 of the FIG. 1 using the orthogonal modulation.

FIG. 7B This figure represents an embodiment of the transmission signal generating means 70 of the FIG. 1 for the orthogonal modulation using binary pulse sequences.

FIG. 8A This figure represents an embodiment of the transmission signal generating means 70 of the FIG. 1 for the OFDM systems using the stream modulation.

FIG. 8B This figure represents another embodiment of the transmission signal generating means 70 of the FIG. 1 for the OFDM systems using the stream modulation of the binary pulses.

FIG. 9A This figure represents an embodiment of the transmission signal generating means 70 of the FIG. 1 for the OFDM systems using the parallel modulation.

FIG. 9B This figure represents an embodiment of the transmission signal generating means 70 of the FIG. 1 for the OFDM systems using parallel modulation by binary pulses.

FIG. 10A This figure represents an embodiment of the transmission signal generating means 70 of the FIG. 1 for the δ-r multiple addition.

FIG. 10B This figure represents another embodiment of the transmission signal generating means 70 of the FIG. 1 for UWB using the binary pulse modulation.

FIG. 11A This figure represents an embodiment of the transmission signal generating means 70 of the FIG. 1 for UWB using the frequency division with the stream modulation of binary pulses.

FIG. 11B This figure represents another embodiment of the transmission signal generating means 70 of the FIG. 1 for UWB using the OFDM with the stream modulation by δ-r multiple signals.

FIG. 11C This figure represents another embodiment of the transmission signal generating means of the FIG. 1 for UWB using the OFDM with the parallel modulation by δ-r multiple signals.

FIG. 12 (a) This figure represents an embodiment of the transmission signal generating means 70 of the FIG. 1 for the code type transmitting devices using the frequency hopping signals, and (b) represents an embodiment of the circuit used between the signal controlling circuit and the sub-carrier modulating circuit to generate the DPSK signals.

FIG. 13 This figure represents an embodiment of the code type receiving device 200 of the present invention that is used to communicate with the code type transmitting device 1 shown in FIG. 1.

FIG. 14A This figure represents an embodiment of the detecting means 210 and communication means 230 of the code type receiving device 200 shown in FIG. 13.

FIG. 14B This figure represents an embodiment of the detecting means 210 shown in FIG. 13.

FIG. 14C This figure represents an embodiment of the detecting means 210 shown in FIG. 13.

FIG. 14D This figure represents an embodiment of the detecting means 210 and communication means 230 shown in FIG. 13.

FIG. 14E (a) represents an embodiment of the detecting means 210 of the FIG. 13 for the frequency hopping signals, (b) represents an embodiment of the delay detecting circuit of the detecting means 210 and (c) represents an embodiment of the detecting means 210 of the FIG. 13 for the frequency hopping systems using a synthesizer.

FIG. 15 This figure represents an embodiment of the localizable signal detecting means 240 of the FIG. 13 for the orthogonal modulation system.

FIG. 16 This figure represents an embodiment of the localizable signal detecting means 240 of FIG. 13 for OFDM system using the stream modulation.

FIG. 17 This figure represents an embodiment of the localizable signal detecting means 240 of FIG. 13 for OFDM system using the parallel modulation.

FIG. 18A This figure represents an embodiment of the localizable signal detecting means 240 of the FIG. 13 for the modulation system of the single carrier.

FIG. 18B This figure represents an embodiment of the localizable signal detecting means 240 of FIG. 13 communicable with the code type transmitting devices 1 for orthogonal modulation.

FIG. 19 This figure represents an embodiment of the localizable signal detecting means 240 of the code type receiving device 200 of the FIG. 13 comprising a cross-correlation type canceller.

FIG. 20 This figure represents an embodiment of the code type receiving device 200 of the FIG. 13 that has the localizable signal detecting means 240 comprising the block demodulator and the localized pulse detecting means 250 comprising a canceller.

FIG. 21 This figure represents an embodiment of the localizable signal detecting means 240 of the code type receiving device 200 of the FIG. 13 communicable with code type transmitting device 1 for UWB systems.

FIG. 22 This figure represents an embodiment of the localizable signal detecting means 240 of the code type receiving device 200 shown in FIG. 13 communicable with code type transmitting device 1 for UWB.

FIG. 23A This figure represents an embodiment of the localizable signal detecting means 240 of the code type receiving device 200 shown in FIG. 13 communicable with code type transmitting device 1 for UWB system employing the frequency division.

FIG. 23B This figure represents an embodiment of the localizable signal detecting means 240 of the code type receiving device of the FIG. 13 communicable with code type transmitting device 1 for UWB system employing the OFDM with the stream modulation.

FIG. 23C This figure represents an embodiment of the localizable signal detecting means 240 of the code type receiving device 200 of the FIG. 13 communicable with code type transmitting device 1 for UWB system employing OFDM with parallel modulation.

FIG. 24A This figure represents an embodiment of the localized pulse detecting means 250 of the code type receiving device 200 shown in FIG. 13 communicable with code type transmitting device 1 for transmission of impulses, pulses or single carrier modulated signals.

FIG. 24B This figure represents an embodiment of the localized pulse detecting means 250 of the code type receiving device 200 of the FIG. 13 communicable with code type transmitting device 1 using orthogonal modulation.

FIG. 25 This figure represents an embodiment of the localized pulse detecting means 250 of the code type receiving device 200 of the FIG. 13 communicable with code type transmitting device 1 using the OFDM system.

FIG. 26A This figure represents an embodiment of the data calculating means 260 of the code type receiving device 200 of the FIG. 13 communicable with code type transmitting device 1 for the transmission of impulses, pulses or single carrier modulated signals.

FIG. 26B This figure represents an embodiment of the data calculating means 260 of the code type receiving device 200 shown in FIG. 13 communicable with code type transmitting device 1 for orthogonal modulation system, OFDM parallel modulation system or the parallel UWB system.

FIG. 27 This figure represents an embodiment of the data calculating means 260 of the code type receiving device 200 of the FIG. 13 communicable with code type transmitting device 1 for stream modulation OFDM system.

FIG. 28A This figure represents an embodiment of the RFIC tag 300 of the present invention.

FIG. 28B This figure represents another embodiment of the RFIC tag 300 of the present invention.

FIG. 29 This figure represents an embodiment of the RF reader/writer 400 for RFIC tags of the present invention.

FIG. 30 The waveforms from (a) through (e) represent examples of the waveforms of the code type transmitting device 1 shown in FIG. 1 while (f) and (g) are examples of those of the code type receiving device 200 of FIG. 13.

FIG. 31 (a) represents examples of the output signals of the I channel and the Q channel of the multiple addition logic circuit of the code type transmitting device 1 of the FIG. 1. (b) represents examples of the output waveforms of each narrow band from FFT according to I channel and Q.

FIG. 32A This figure represents examples of the input waveforms to S/P converting block shown in FIG. 9A.

FIG. 32B This figure represents examples of the parallel input waveforms to the IDFT block of the FIG. 9A.

FIG. 33A Each figure from (a) to (d) represents examples of the signal waveforms for UWB system using δ-r multiple addition for the code type transmitting device 1 of the FIG. 1. Figures from (e) to (h) shows waveforms of the code type receiving device 200 of FIG. 13 communicable with the code type transmitting device 1.

FIG. 33B Figures from (a) to (c) represent examples of the signal waveforms up to generation of the multiply added signals for the UWB systems of the code type transmitting device 1 in FIG. 1 using binary pulse transmission.

FIG. 33C This figure represents examples of the binary pulses converted from the waveform (e) of the FIG. 33A by binary conversion block of the code type transmitting device 1 shown in FIG. 1.

FIG. 33D This figure represents examples of the signal waveforms consisting of impulses generated in synchronization with the transit edges of the waveform shown in FIG. 33C.

FIG. 34A This figure represents an example of the waveforms of the r-multiple addition block of the code type transmitting device 1 shown in FIG. 11B.

FIG. 34B This figure represents an example of the waveforms of the δ-pulse generating block of the code type transmitting device 1 shown in FIG. 11B.

FIG. 34C This figure represents an example of the input waveforms to the IDFT block of the transmitting signal generating means 70 of the code type transmitting device 1 shown in the FIG. 11B.

FIG. 34D This figure represents an example of the output waveforms from the FFT block of the code type receiving device 1 shown in FIG. 23.

(FIG. 35A This figure represents an example of the output waveforms from the r-multiple adding block of the code type transmitting device 1 shown in FIG. 11C.

FIG. 35B This figure represents an example of the output waveforms from the δ-pulse generating block of code type transmitting device 1 shown in FIG. 11C.

FIG. 35C This figure represents an example of the input waveforms to the IDFT block of the code type transmitting device 1 shown in the FIG. 11C.

FIG. 35D This figure represents an example of the output waveforms from the FFT block of the code type receiving device 200 shown in the FIG. 23C.

FIG. 36A This figure represents an example of the multiply added basic pulse sequences of the binary conversion block for the code type transmitting device 1, the RF IC tag, the RF reader/writer and the memory media reader/writer device of the present inventions.

FIG. 36B This figure represents an example of the data format of the binary conversion block.

FIG. 36C This figure represents an example of the bit stream obtained by the binary conversion block.

FIG. 37 This figure represents an example of the memory media reader/writer device of the present inventions.

FIG. 38 (a) represents an example of the transmission process flow of the code type transmitting device 1 of the FIG. 1. (b) represents an example of the process flow of the base station. (c) represents an example of the reception process flow of the code type receiving device 200 of the FIG. 13.

FIG. 39A This is the explanatory figure for the step 01007 of the FIG. 38.

FIG. 39B This is the explanatory figure for the step 03008 of the FIG. 38.

### THE PREFERRED FORM OF THE INVENTION

The present invention is related with the transmitting device and the receiving device. The transmitting device generates the data-mapped code pulse sequences by setting their shift times in accordance with the ordering sequence and the data, then generates the transmission signals based on the transmission signal generating pulse sequences that contain the data-mapped code pulse sequences. On the other hands, the receiving device receives the transmission signals, detects the data-mapped code pulse sequences, then calculates the data from their shift times.

The transmission signals comprise, but not limited to, impulses, pulses or the modulated signals by the impulses/pulses representing the multiply added basic pulse sequences or their binary pulses and so forth. The modulated signals may be the single carrier modulated signals or the sub-carrier modulated signals. The single carrier modulated signals are, but not limited to, those that modulated by the data-mapped code pulse sequences or by the basic pulse sequences. As is well known to those skilled in the art, in the case that the band width of the rectangular pulses representing chips are limited, it is preferable to make the filter ISI (Inter Signal Interference) free by setting the sampling point at the center of the pulse representing its amplitude while the height of the pulse at other sampling points is zero. In addition, it is preferable that modulated signal be generated by making use of ISI free signal. The filter satisfying the ISI free condition is formed by, but not limited to, the root-roll off filters one of which is contained in the transmitting device and the counter part is included in the receiving device (Please refer to the non-patent literature 6, page 131-137).

The single carrier modulated signal by the basic pulse sequences may be generated in the way that the single carrier is modulated by the basic pulse sequences or the carrier is modulated by the data-mapped code pulse sequence first, then the modulated signal is spread by the ordering pulse sequence. It is preferable that modulated signals be used because of the increase of diversification of the data transmission systems and wider applications.

For the transmission of the modulated synchronous signals and data signals, the receiving device detects the signals for acquisition and/or tracking directly or by converting the modulated single carrier and/or modulated sub-carrier/sub-carriers to the intermediate frequencies.

The modulation systems include, but not limited to, the amplitude modulation, orthogonal modulation and so forth. Since the signals are generated through modulation by the chips or by the signals based on the chips, it is preferable that the localized pulses be judged by making use of the chips contained in a period or periods of the code pulse sequence instead of detection and judgment on an individual pulse basis.

The data is calculated from the shift times of the localized pulses each of which is detected through despread of the basic pulse sequences and localization in accordance with the ordering sequence.

Both the transmitting device and the receiving device may employ analog processing, analog and digital processing or digital processing by converting the received analog signals into digital signals.

In addition, for both non-modulated signals and modulated signals, the processes up to generation of transmission signals and those up to detection of the localized pulses from the transmission signal generating pulse sequences in the transmitting device are repeated as many times as the number of multiple addition in accordance with the ordering sequences, or the whole process or some parts of the process may be done by using the parallel processing for fast processing some of embodiments of the code type transmitting devices 1 and the code type receiving device 200 related to the present inventions are represented by, but not limited to, the following:

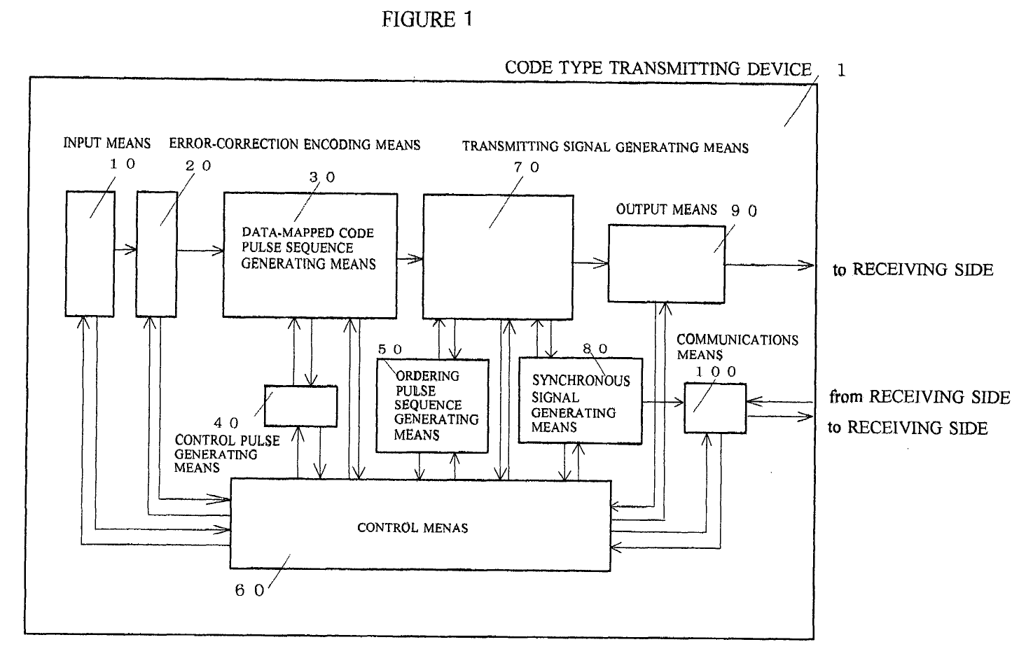

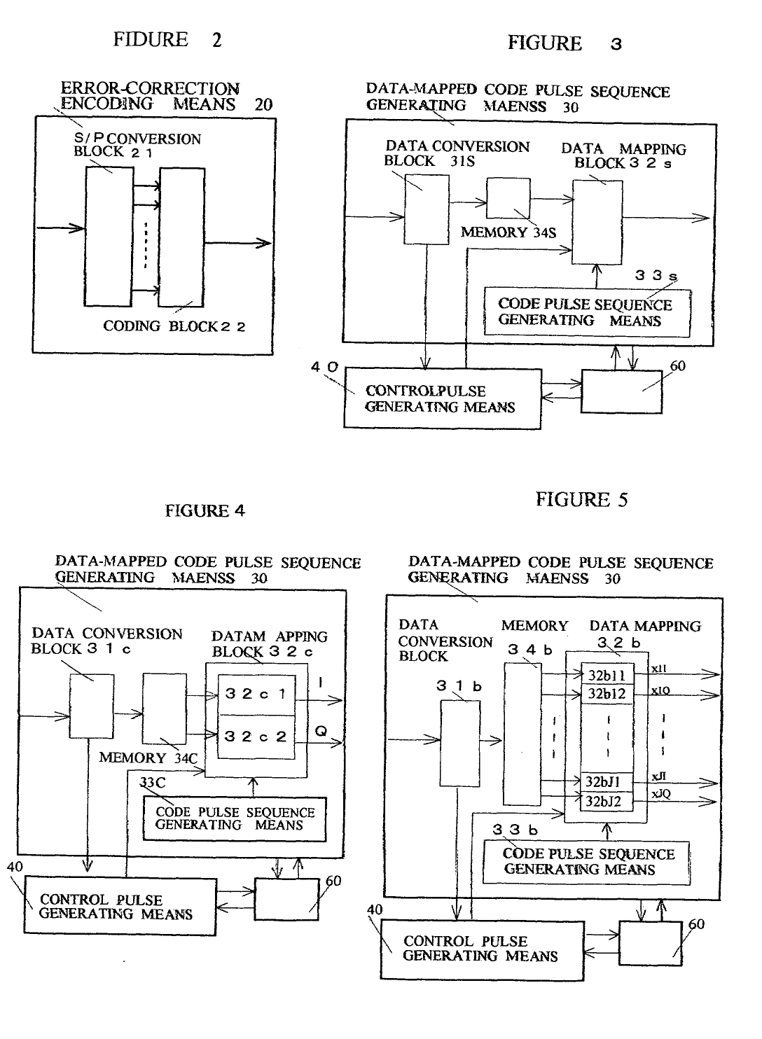

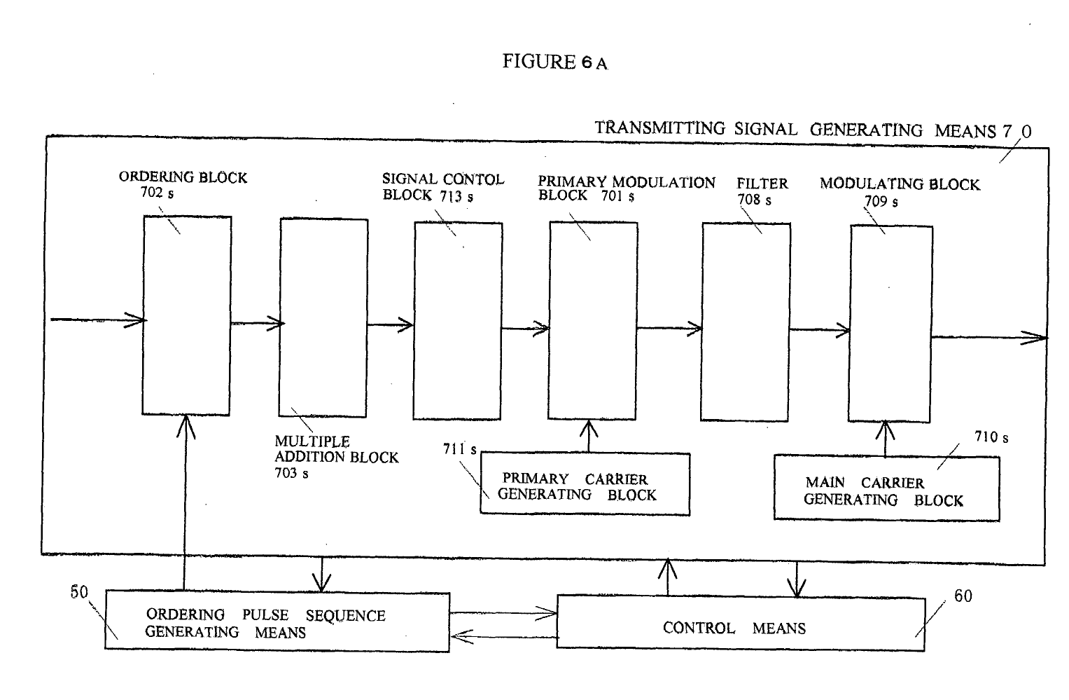

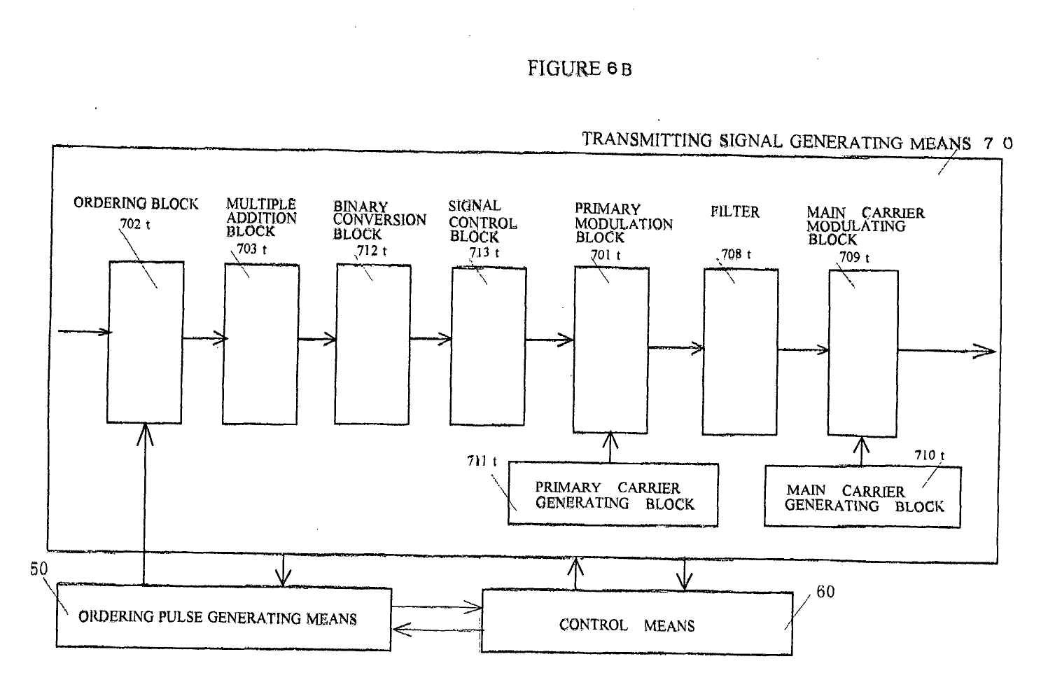

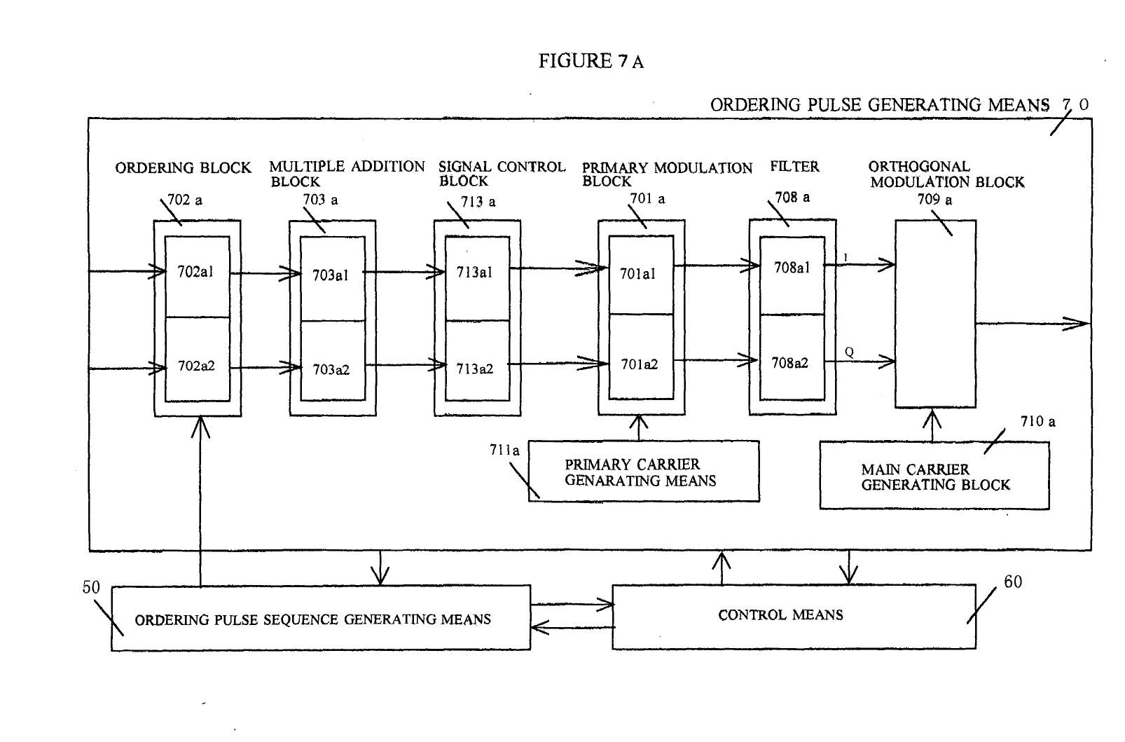

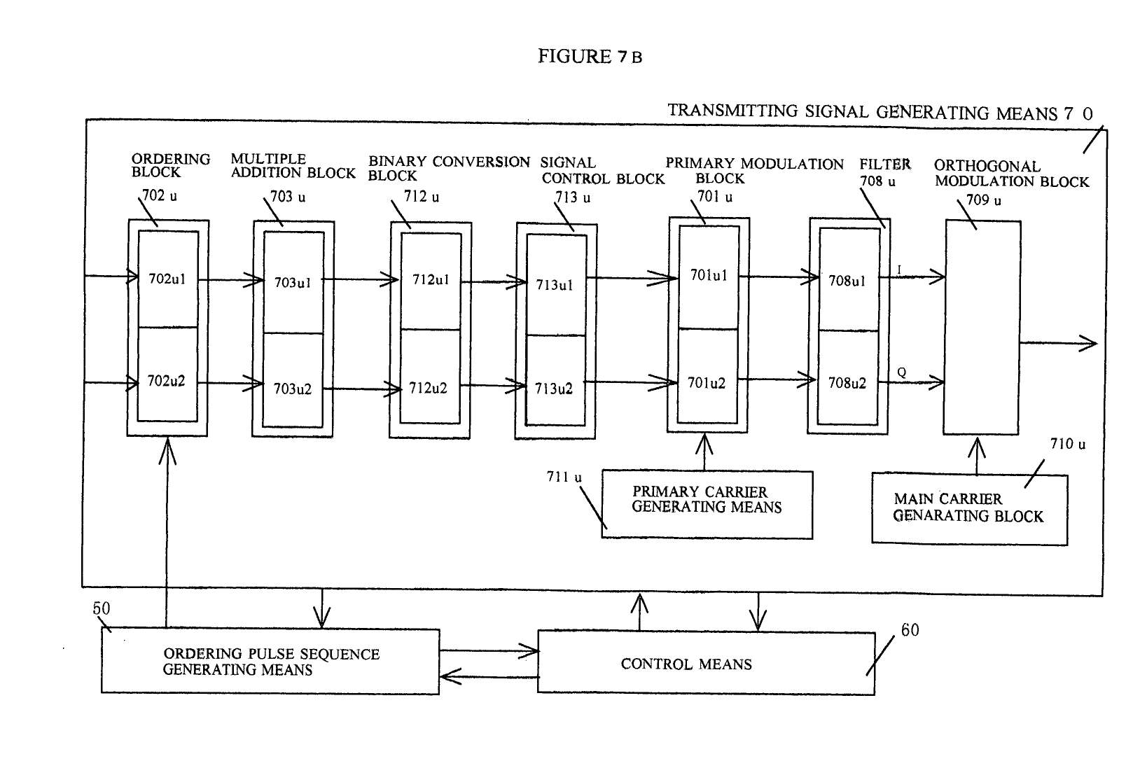

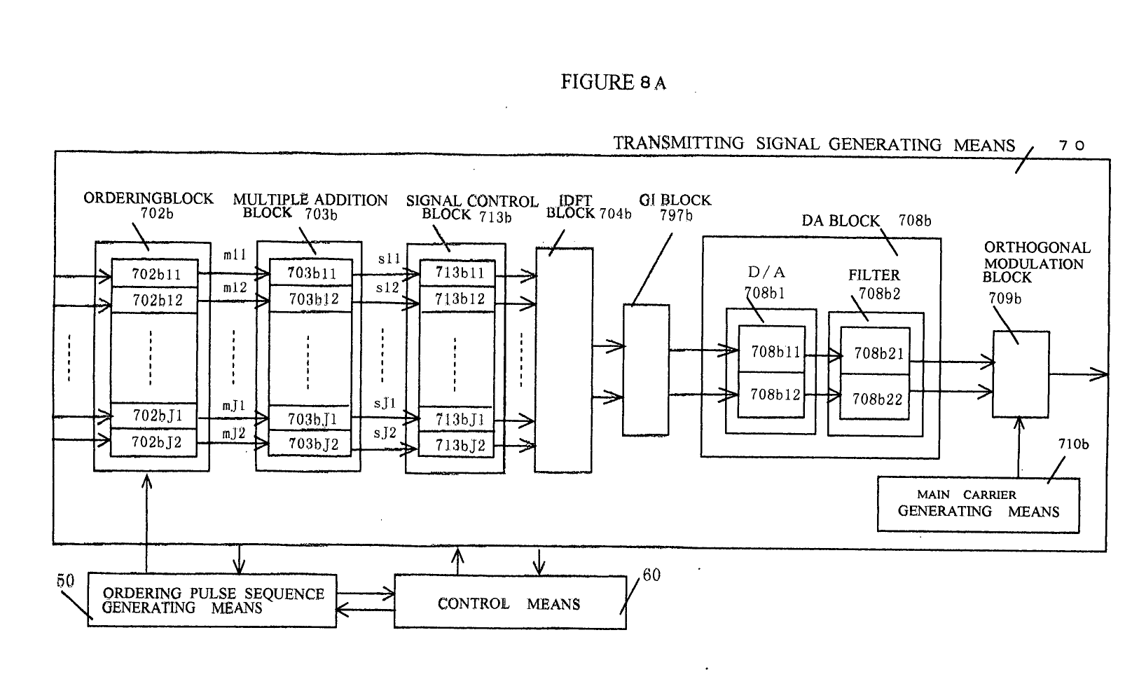

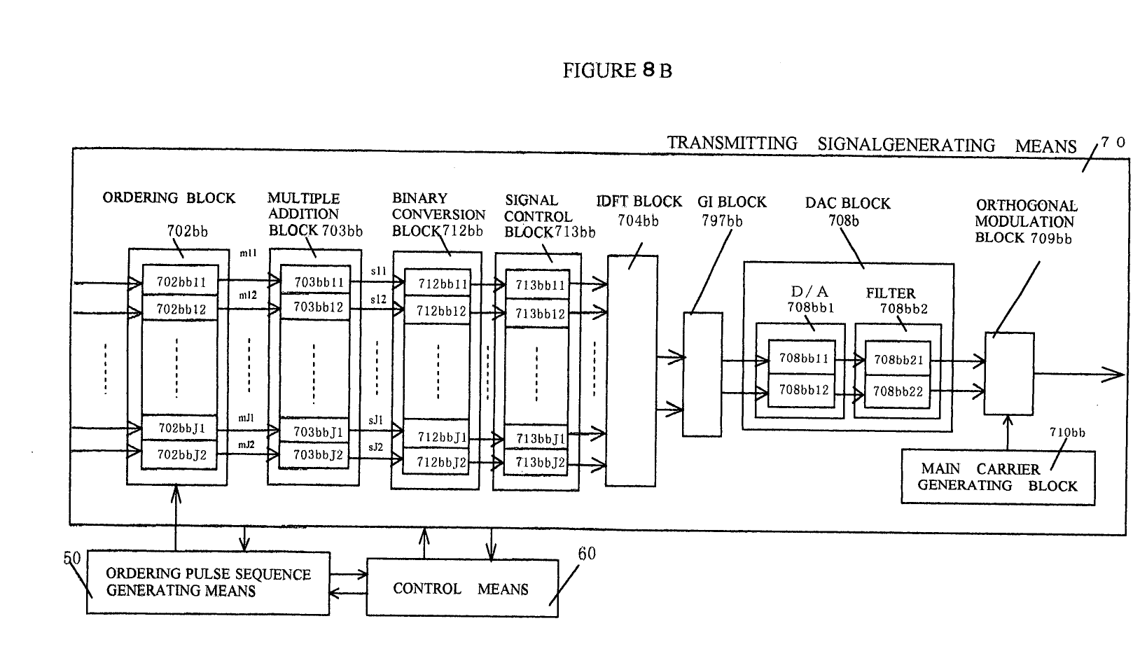

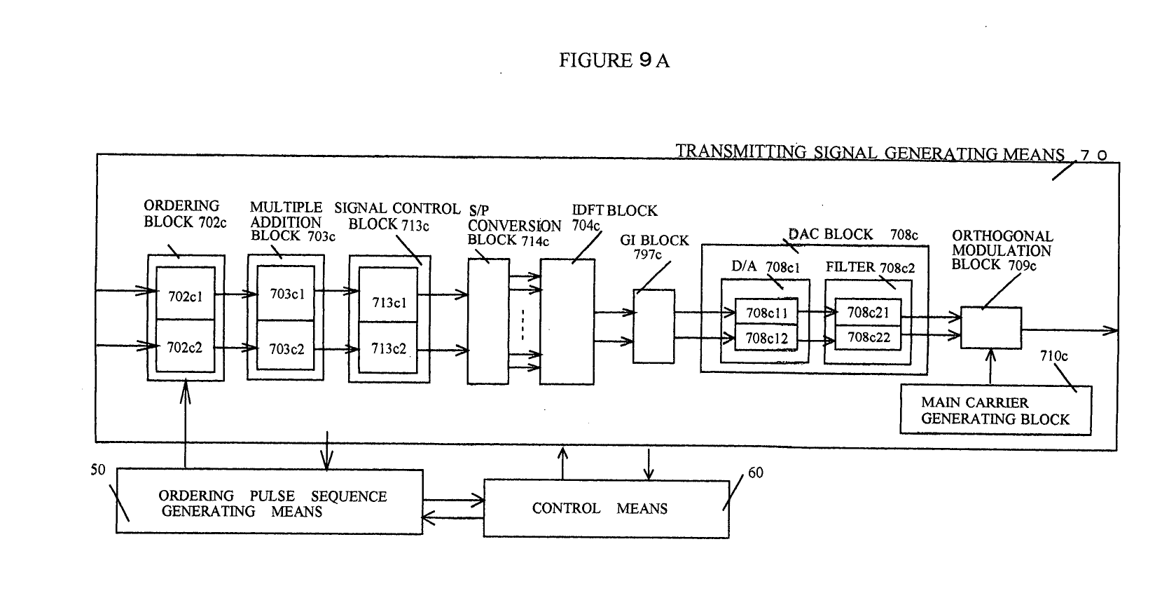

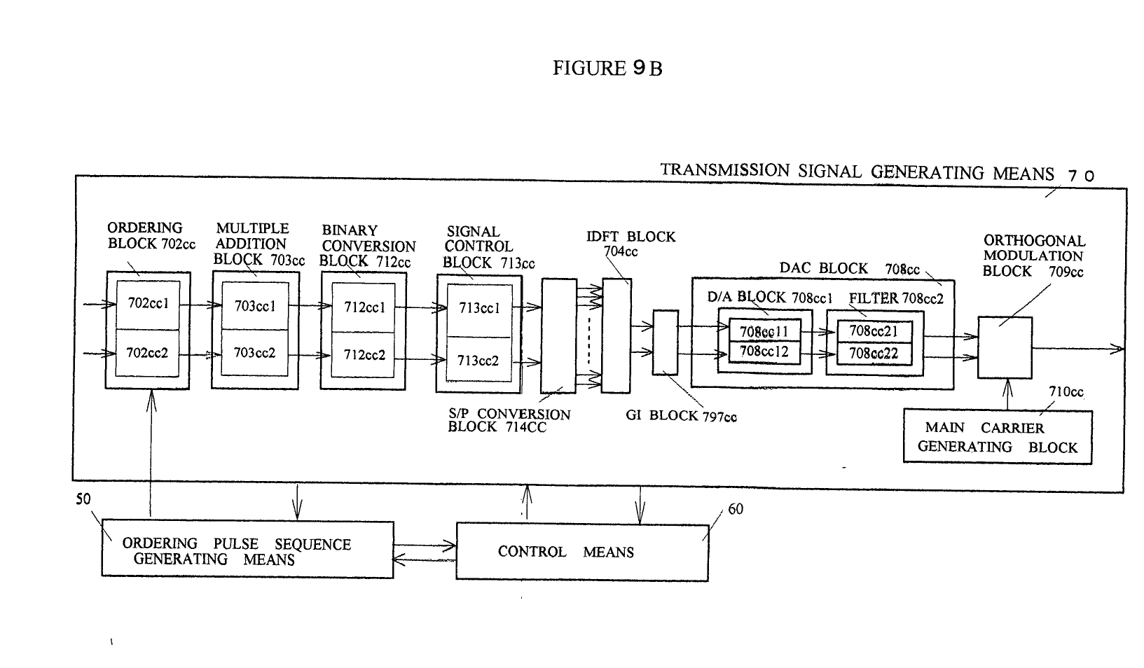

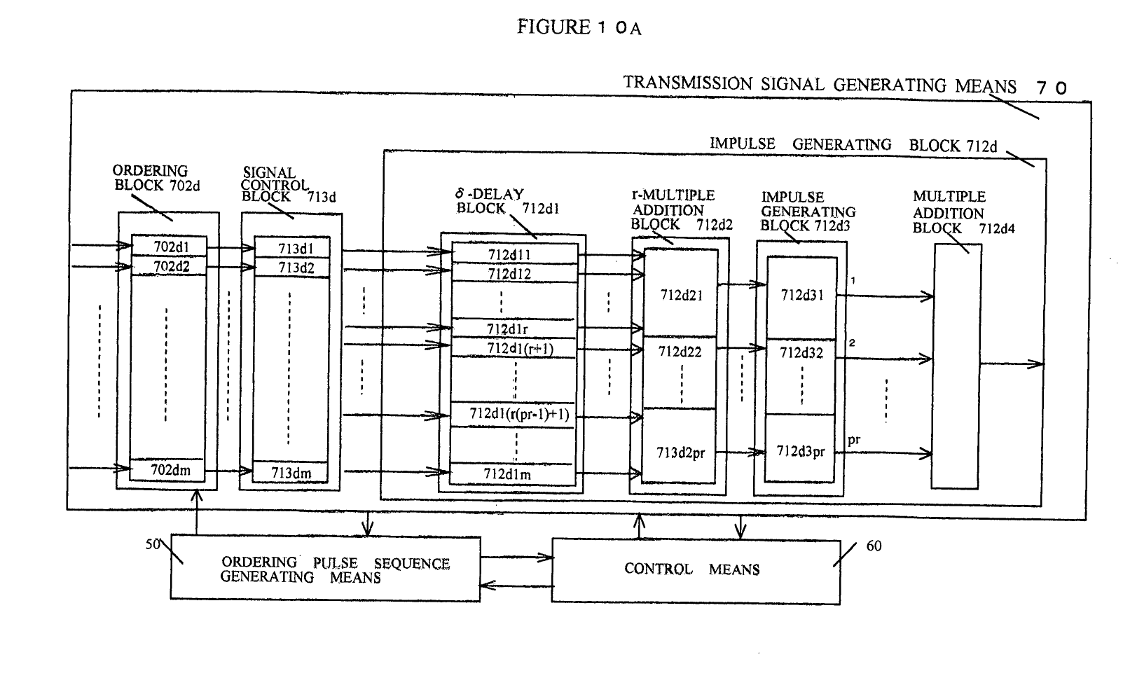

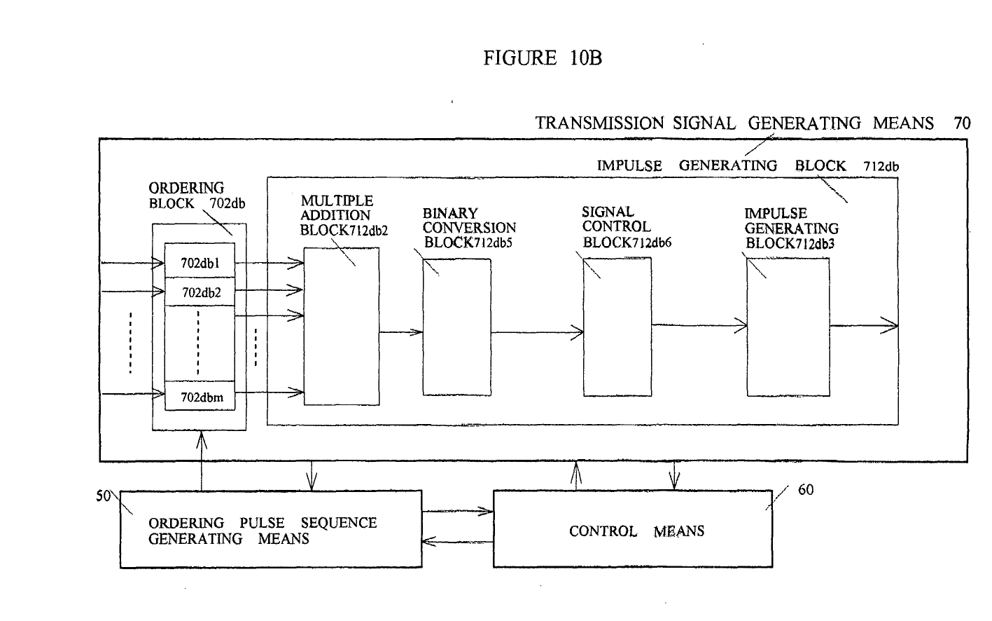

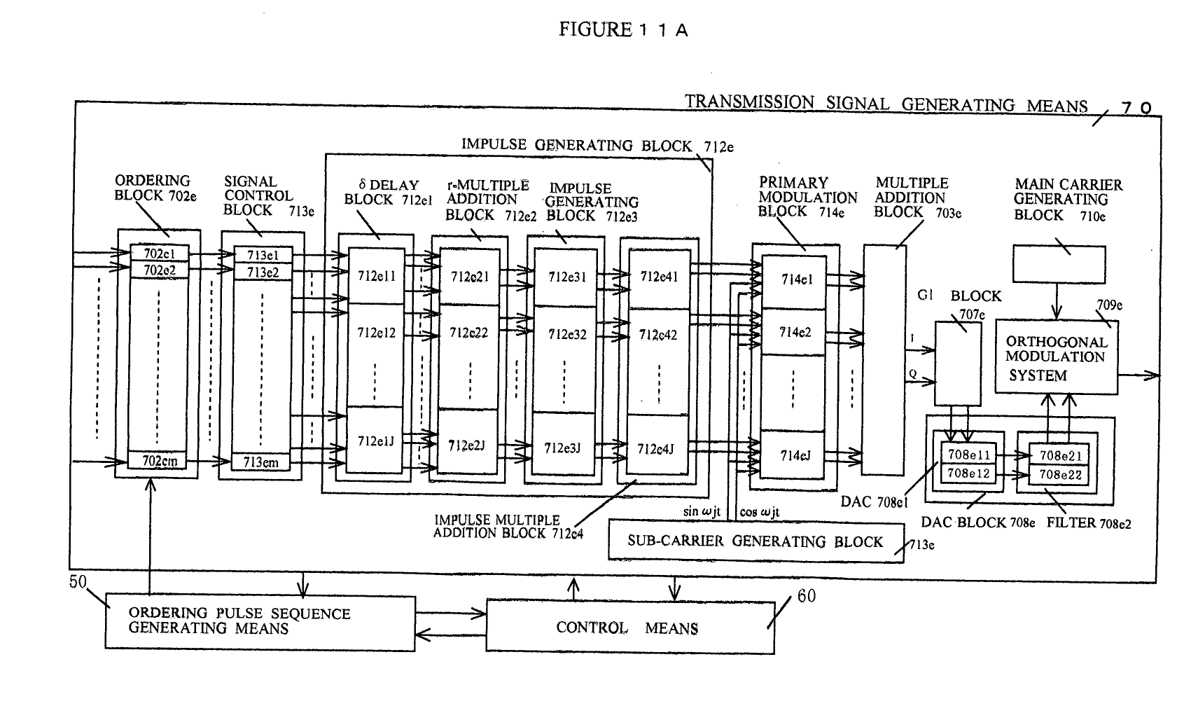

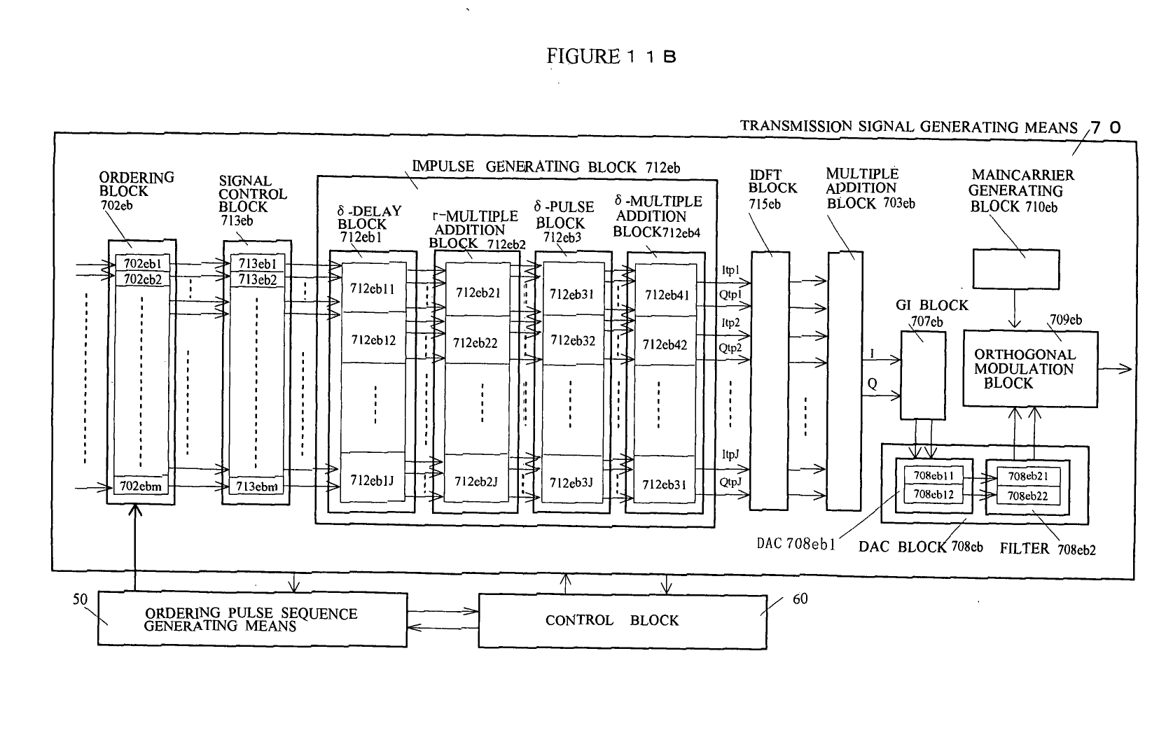

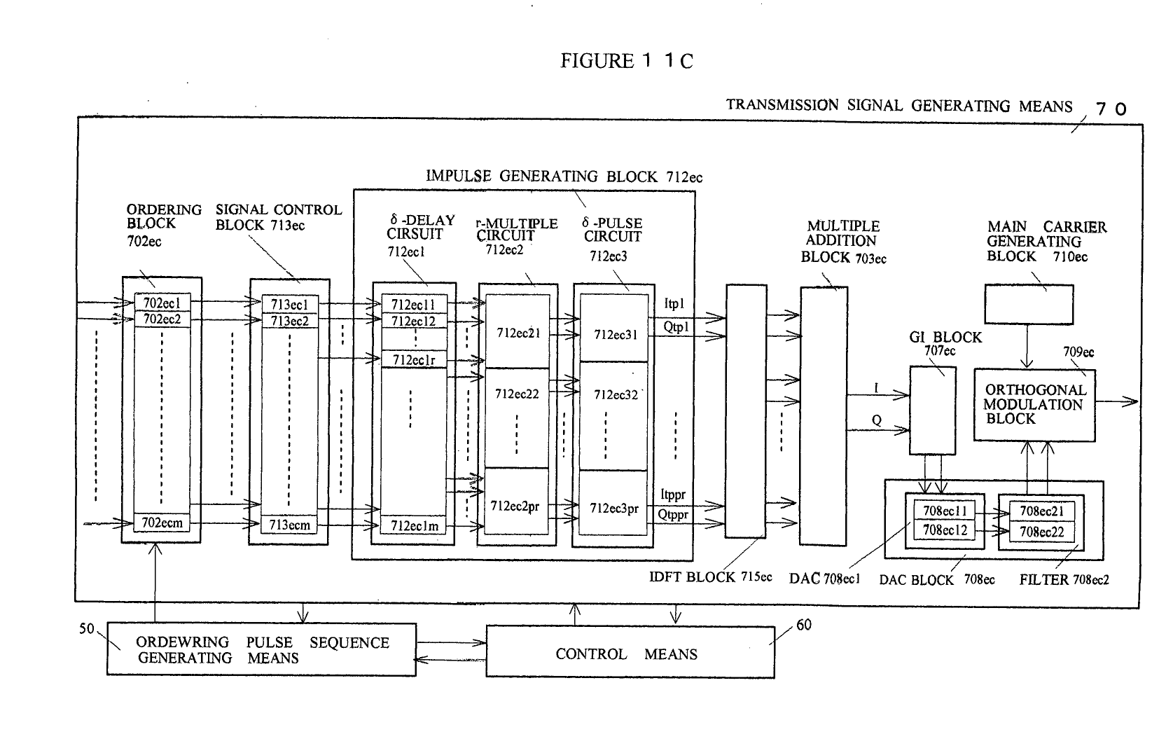

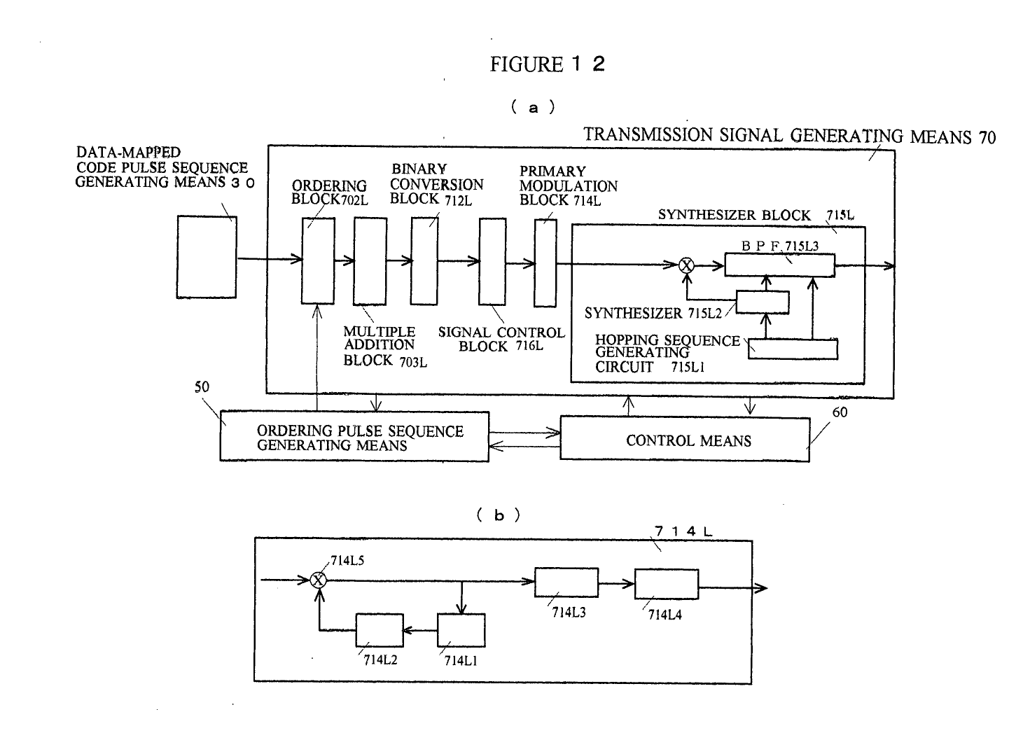

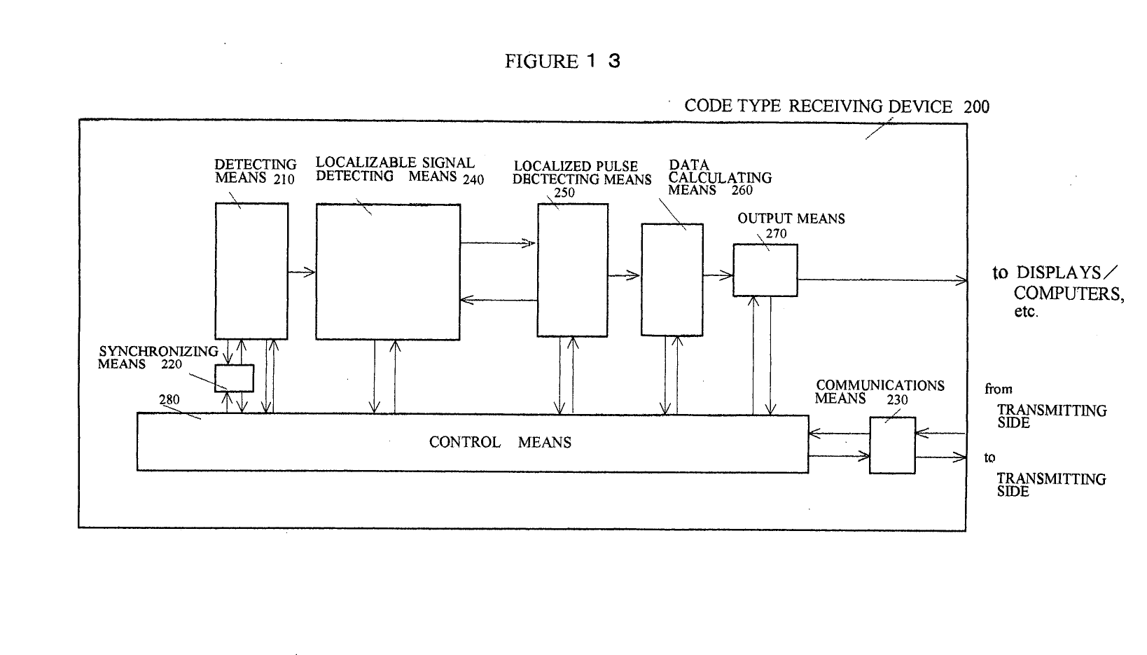

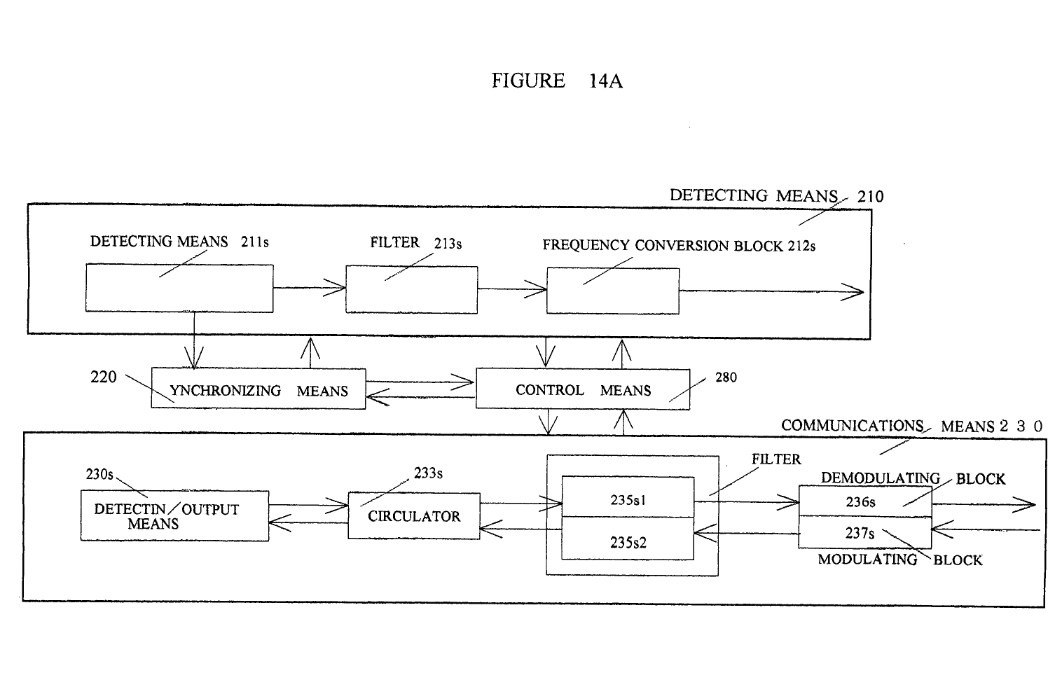

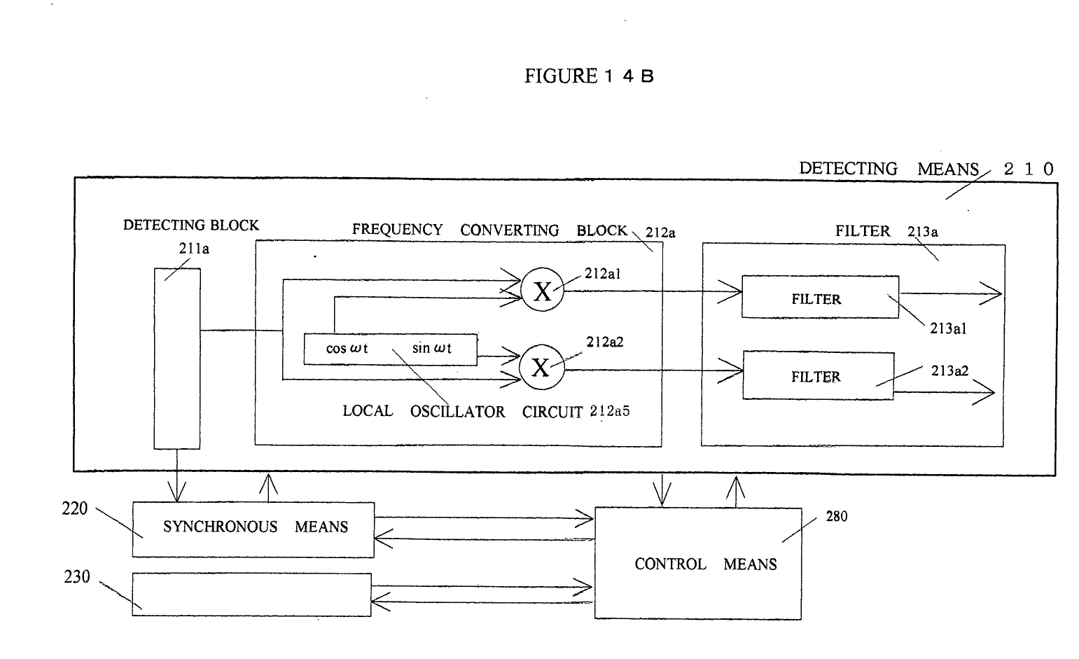

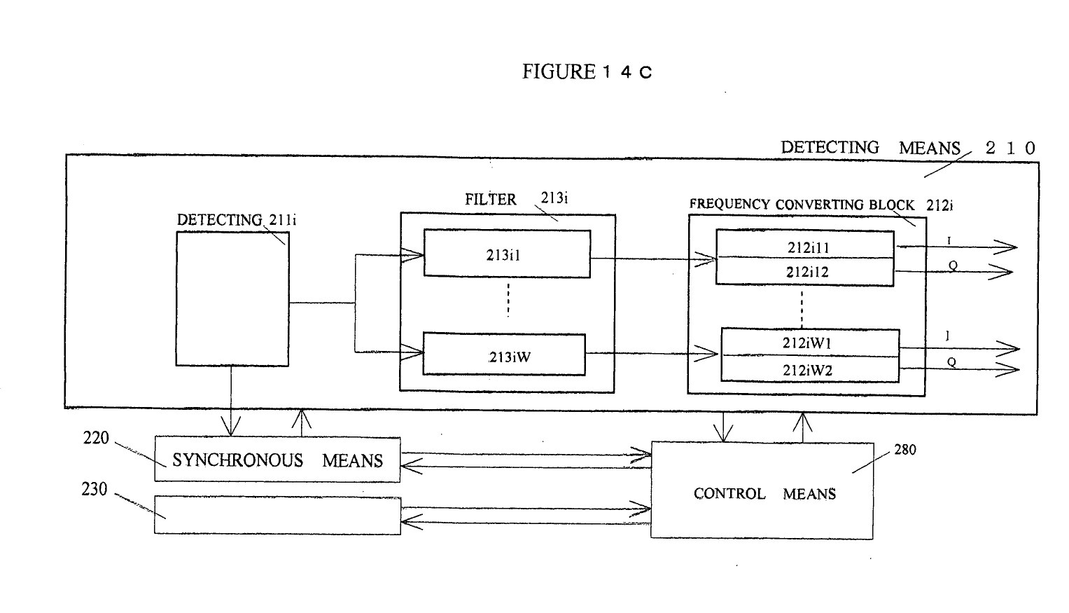

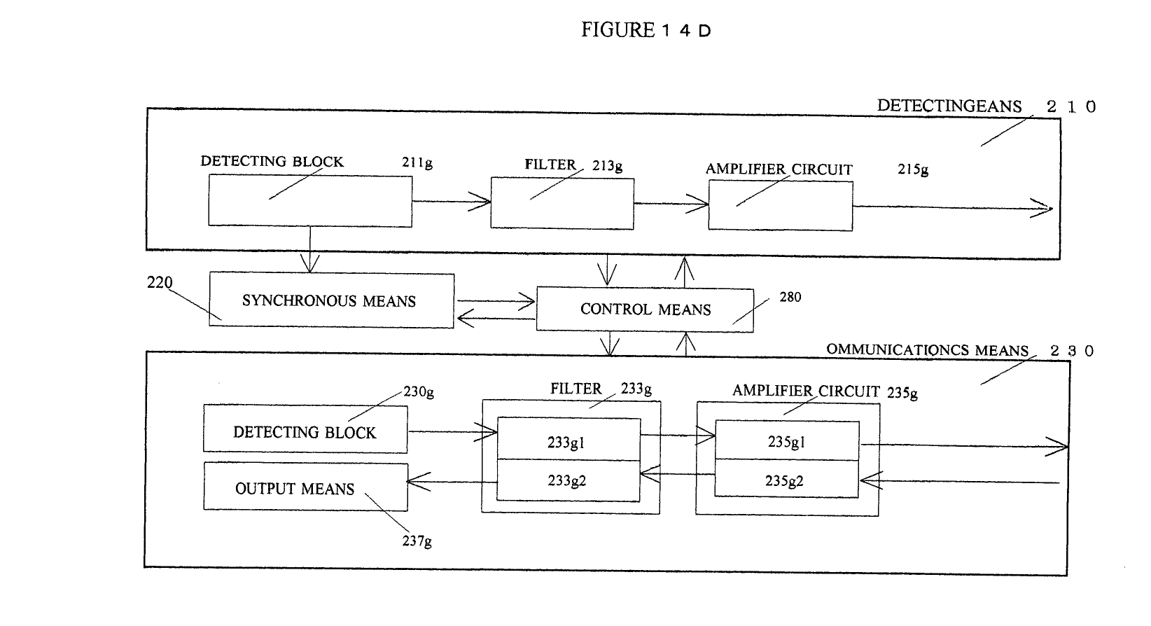

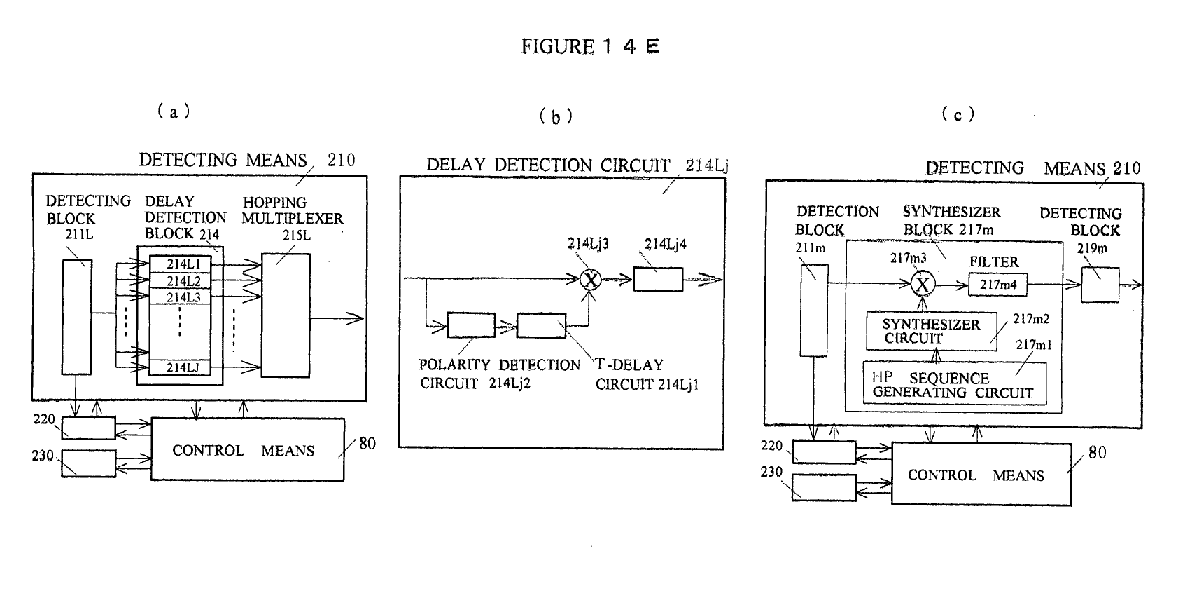

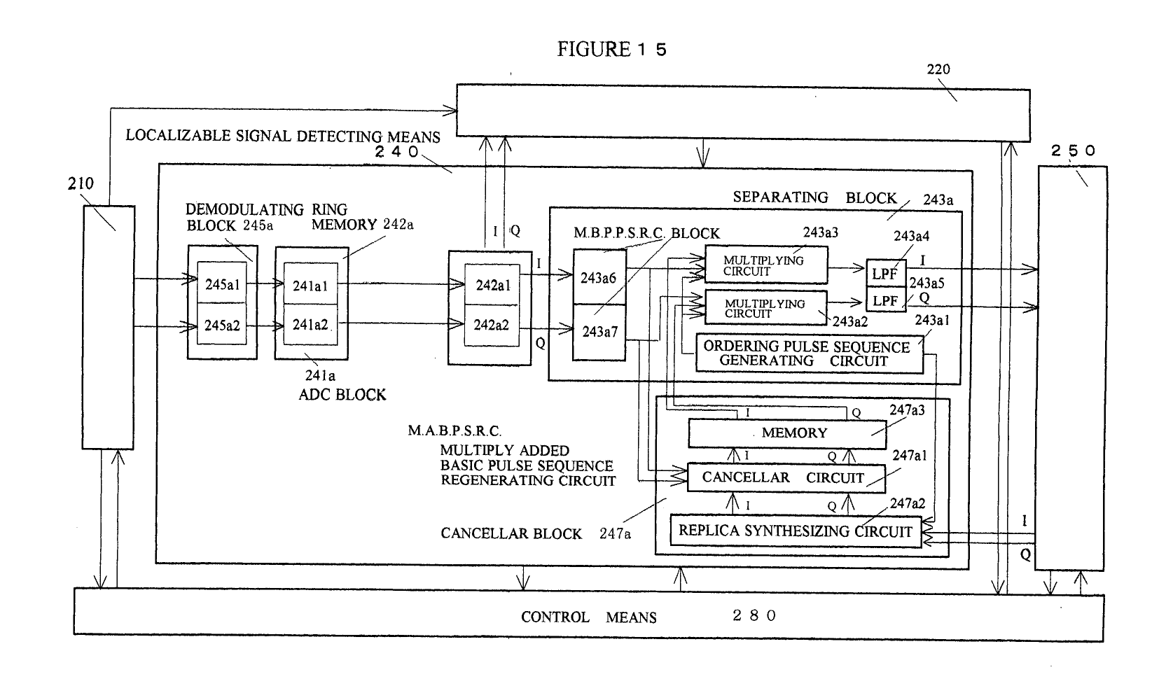

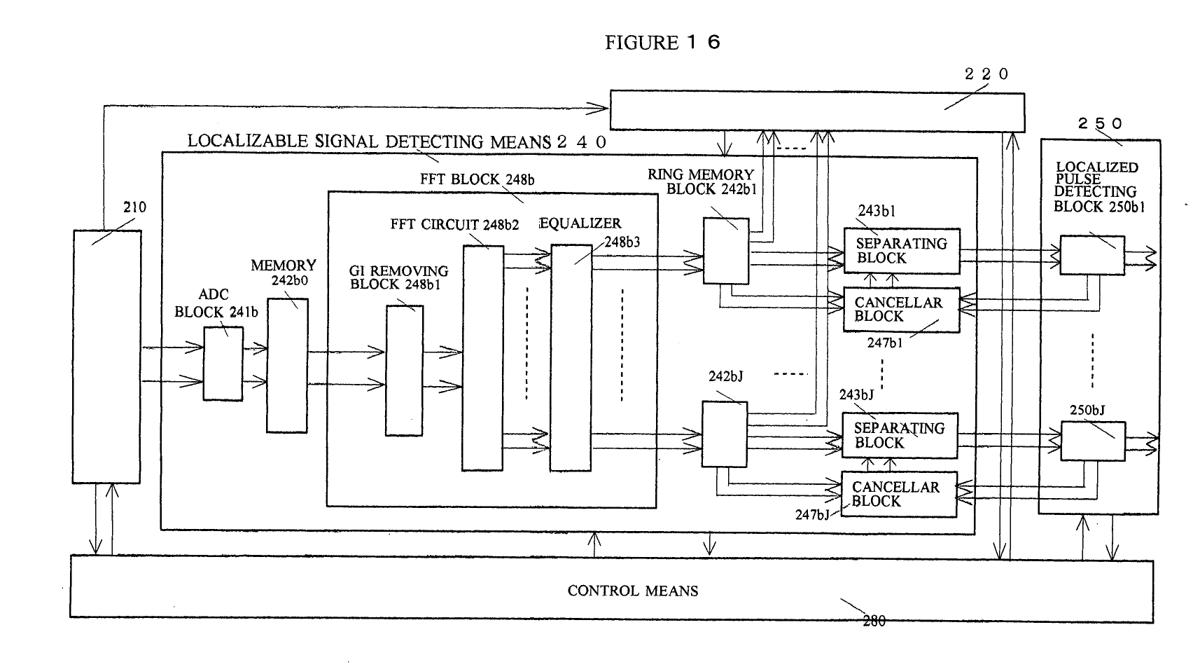

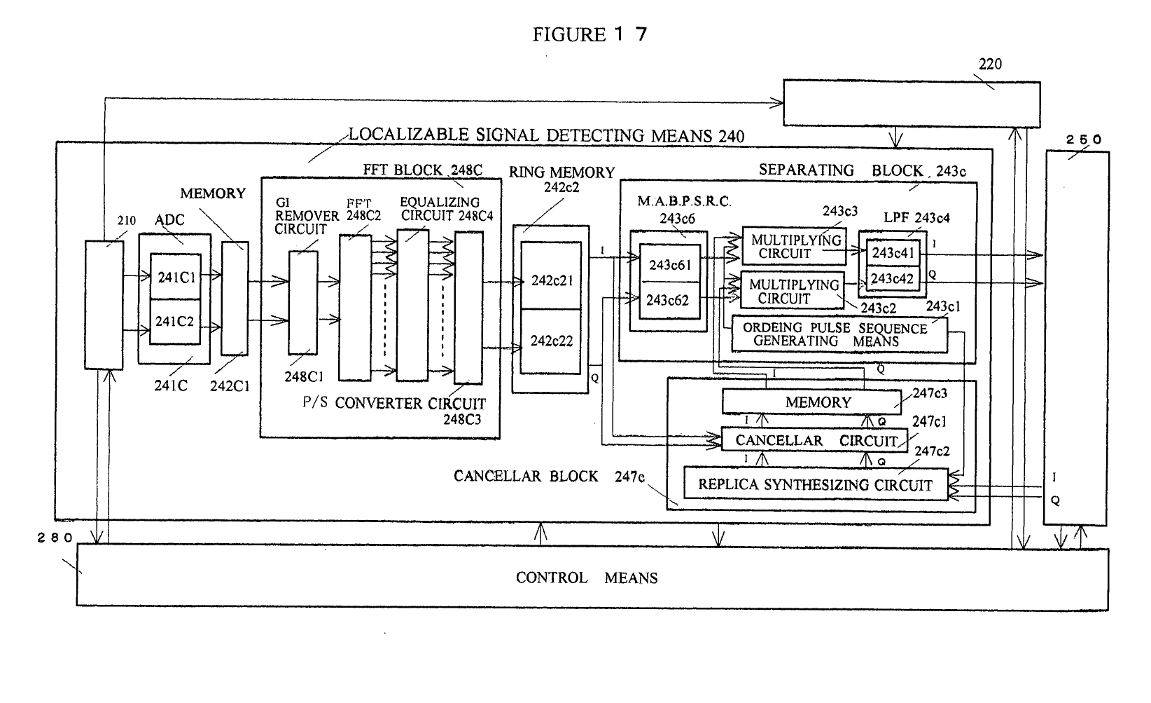

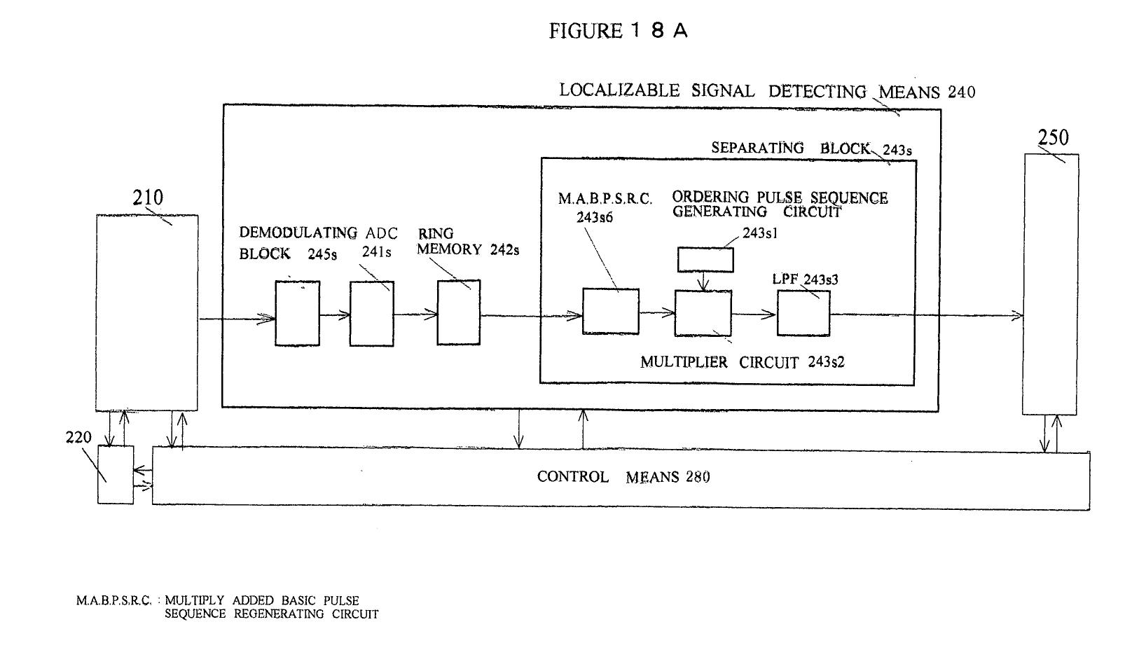

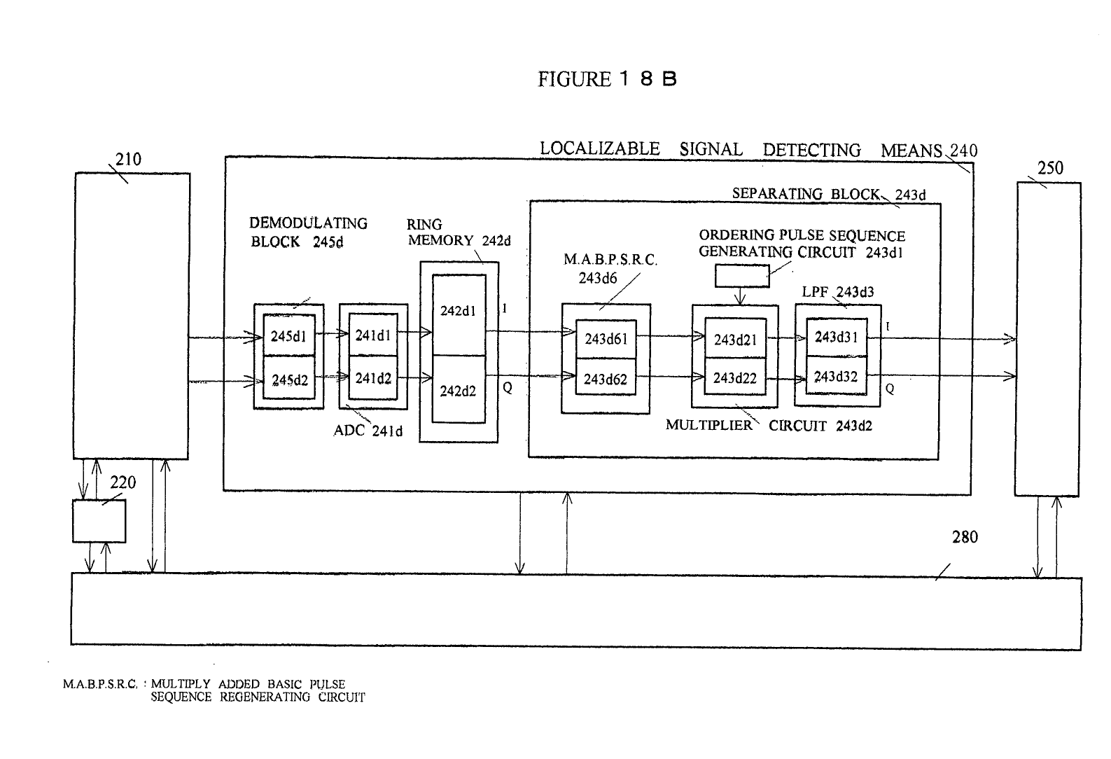

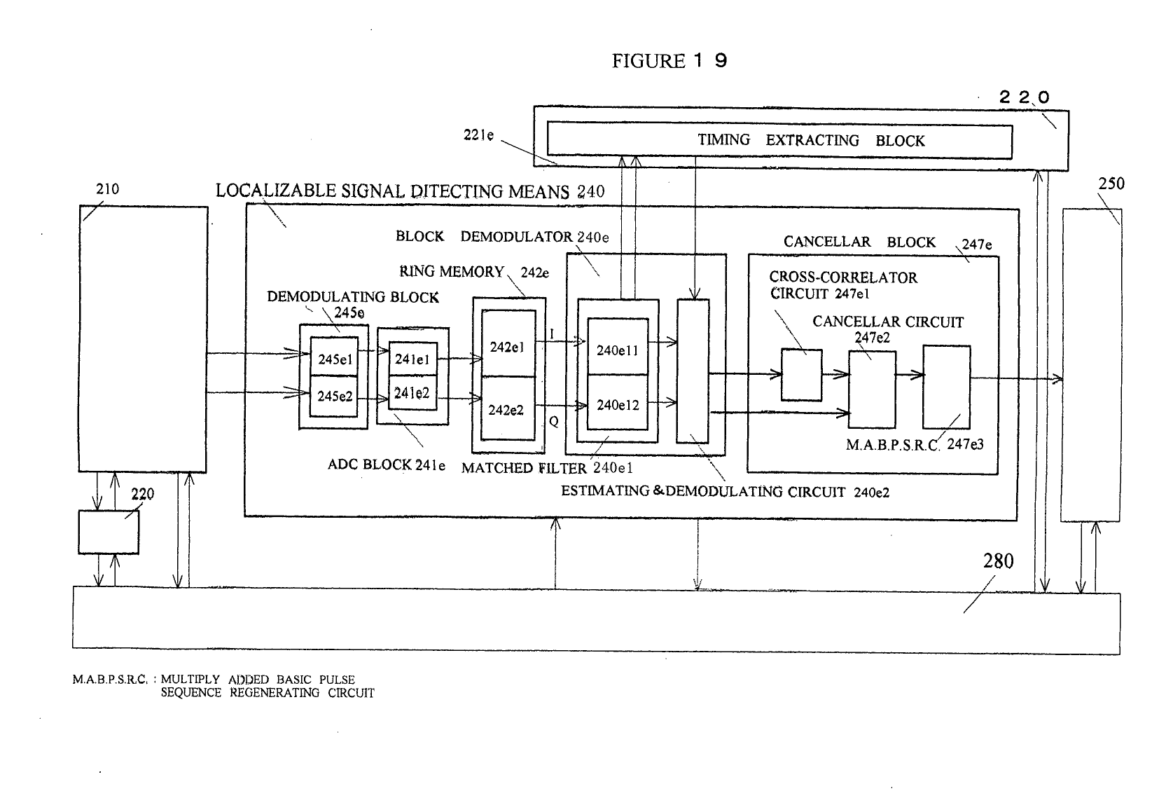

FIG. 1 shows an embodiment of the code type transmitting device 1 of the present invention. The code type transmitting device 1 converts the data into the shift times of the code pulse sequences to make the data-mapped code pulse sequences in accordance with the ordering sequence, then multiply adds the data-mapped code pulse sequences to generate the transmission signal generating pulse sequences based on which the transmission signal is generated. This code type transmitting device comprises the input means 10, the error-correction encoding means 20, the data-mapped code pulse sequence generating means 30, the control pulse generating means 40, the ordering pulse sequence generating means 50, the control means 60 that works in accordance with clock pulses to control the timing and the action of other means, the transmission signal generating means 70, the synchronous signal generating means 80, the output means 90 and the communicating means 100. Hardware of each means may be replaced by an equivalent software and vice versa and both hardware and software may be modulated and/or composed arbitrarily without departing from the scope of the invention.

Each means of the code type transmitting device 1 is controlled by the control means 60. In addition, the control means 60 adjusts the relationship among the code lengths, the chip rate, the degree of multiple addition, the sampling rate and so forth based on the request signals from the receiving device, for example, in order to achieve the required transmission speed, and controls the output power to improve the SNR for receiving device. Sending and receiving the information for control are executed through the communication means 100.

The relationship among the code length, the chip rate, the degree of multiple addition, the sampling rate and so forth is adjusted within permissible limits of bit error rate by using criteria of, but not limited to, the SNR of bit energy S0 versus noise power spectral density N0 or the peak energy of the localized pulse versus localized pulse variance which represents square of the variance of the localized signal.

For ease of explanation, an example to use the fixed number of the samples will be detailed hereafter. In this case, the transmission rate is determined by setting any one of or a combination of the parameters including the number of samples, the code length, the chip rate and the degree of the multiple addition using an evaluation criteria. For example, the code length and the degree of the multiple addition are set to determine the chip rate, or the code length and the chip rate are set to determine the degree of multiple addition, or the code length is set to determine the chip rate and the degree of the multiple addition and so forth. It is also allowed to set one of or some of the parameters to be constant to obtain the required transmission rate. Moreover, additional parameter or parameters may be used together with these parameters to determine the transmission rate, for example.

Average information contained per chip of the modulating system, in which the in-phase sub-carrier and the quadrature phase sub-carrier are modulated by the amplitude of the time varying data signal made of multiply added basic pulse sequences with the degree of multiple addition mI and mQ respectively, is denoted as ((mI+MQ))/N) log₂N (bits/chip)((mI+MQ) divided by N is multiplied by log₂N), and the transmission rate is represented by ((mI+mQ) log₂N)/(KNTc) (bits/sec). As the result, the transmission rate (bits/sec) is calculated by making use of the formula having the parameter of the frequency bandwidth represented by 1/Tc.

For the transmission paths that have non-uniform transmission characteristics, it is necessary to use equalizing techniques to compensate the amplitudes and the phases to perform the acceptable transmission quality.

In the OFDM systems that have the receiving devices using FFT techniques, it is possible to employ equalizing technique by making use of the synchronous signals or transmitted signals for equalization. Generally speaking, both the base stations and the mobile stations of the transmission systems may employ equalizing means to control the transmission signals.

In a FDM (Frequency Division Multiplexing) system, since it is possible to determine the transmission rate by setting up the degree of multiple addition, the period of the data-mapped code pulse sequences and the chip rate, the transmission rate of the system is calculated by making use of the rate of each sub band. Especially, for a system in which each sub-band has the unified period and chip rate, the transmitting device 1 may execute to control the transmission rate through adjustment of the parameters based on the results of the measurement of the transmission conditions including the path characteristics and the transmission environments using signals for measurement by the receiving devices.

Since the chip rate can be controlled on a sub-band basis as stated above, for the transmission via the path having non-uniform transmission characteristics, it is preferable that the output power (energy per bit or bit energy) be controlled on a sub-band basis to achieve the high quality.

For example, these parameters are fixed by evaluating BER (Bit Error Ratio) for S0/N0 where S0 represents the bit energy and N0 is the power density of noise, or, instead of S0/N0, for the ratio representing peak energy of the localized pulse versus variance of the localized signal. For more discussion, it is described that the required transmission rate is performed by setting up one or some of the code length, the chip rate and the degree of the multiple addition. Some of the examples are the chip rate being determined by setting up the code length and the degree of the multiple addition, the degree being determined by setting up both the code length and chip-rate, and the chip rate and the degree being determined by setting up the code length. If there are additional factors to limit and/or determine the parameters, they are also used together with these parameters.

Moreover, the control means 60 is configured to control the transmission signals in accordance with the control signals from the receiving device. The code type transmitting device 1 generates the synchronous signals at the synchronous signal generating means 80 to transmit via the output means 90.

The synchronous signals for short-range transmission used in devices, systems, ICs and so forth are composed of the timing impulse sequences or timing pulse sequences parallel to or in anticipation of the data signals, or modulated signals modulated by one of these sequences. The signals may directly be input to the receiving devices or circuits through cables, electromagnetic waveform, light and so forth and the receiving device or circuits and so on detect the synchronous signals for acquisition and tracking.

On the other hands, the synchronous signals for remote wired and wireless transmission may be composed based on the code pulse sequences parallel to or in anticipation of the data signals. The synchronous signals composed based on the code pulse sequences may be single code pulse sequences, the multiply added basic pulse sequences or the multiply added code pulse sequences, or the modulated signals by the signals based on one of these sequences. If multiply added synchronous signal made of secondary product code pulse sequences is used, it is preferable that the signal be composed by multiplying time varying code pulse sequences that have the shift time increasing or decreasing at a constant rate by time-invariant code pulse sequences first, then those product sequences are added multiply, making detection of the signal along the stream simple.

In addition, the FDM system and the OFDM system of the present inventions may transmit the synchronous information by making use of the scattered pilot channels or the specific channels for common synchronization, or by sending the synchronous signal based on the code pulse sequences parallel to or in anticipation of the data signals (Please refer to non-patent literature 6, page 154 for scattered pilot channels).

It is preferable for smooth acquisition and/or tracking that the localized pulses of the modulated and unmodulated synchronous signals be so composed that the pulses are generated on an integral multiplication basis against the periods of the data-mapped code pulse sequences in order to be detected in the pulse streams.

The UWB systems may be configured to transmit, as synchronous signals, timing impulse sequences or timing pulse sequences in series with or parallel to the data signals. Similarly, UWB systems employing OFDM may be so configured that each sub band transmits the timing information in series with or parallel to the data signal, or through the scattered pilot channels for its own or common timing.

Especially for the transmission of the synchronous information from the transmitting device to the receiving device by making use of the code pulse sequences, the synchronous signal may be transmitted in series with or parallel to the basic pulse sequence(s) or the multiply added basic pulse sequence(s), or in series with and parallel to the data signal or signals. The transmission signal for synchronization may be composed of a code pulse sequence, multiply added code pulse sequences, modulated signals or the high frequency modulated signal that includes the primary and secondary modulation.

The synchronous signal is composed of, but not limited to, one of the binary or multiple level code sequences that generate the localized pulses include Maximal length sequences, Gold code sequences and KAZAMI code sequences. In addition, the parallel and serial synchronous signals may be composed of a single code pulse sequence, multiply added code pulse sequence that is composed of multiply added product sequences made through multiplicaton of time varying pulse sequences with increasing or decreasing shift time at a constant rate by time-invariant pulse sequences having variables representing the shift time, or modulated signals modulated by one of these sequences.

The multiply added synchronous pulse sequence may be made of different time varying code pulse sequences from the time-invariant code pulse sequences multiplied. Higher dimensional multiply added synchronous pulse sequences having more sequences multiplied may be configured, similarly.

Tracking can be done by so controlling the local pulse generator for synchronization that its frequency and phase follow the synchronous signal.

Acquisition from analog single code pulse sequence for synchronization may be executed by detecting the localized pulse sequences by using transversal matched filter or filters made of CCD (Charge Coupled Device) or by applying a digital matched filter to digital signals obtained through A/D conversion. On the other hands, the localized pulses are detected from the modulated synchronous signal or the signals having intermediate frequency by making use of a SAW (Surface Acoustic Waveform) matched filter, by applying a CCD matched filter to the demodulated signal, or by applying a digital matched filter to the digital signal.

On the other hands, for simple processing, it is preferable that the multiply added synchronous pulse sequence be composed of a time varying code pulse sequence having code length with integral multiplication of, or the same as, that of the time-invariant pulse sequence multiplied.

Since the detected localized pulses are so composed that they are determined by the time-invariant pulse sequences and the set of their localized pulses can form a code pulse sequence defined by the time-invariant sequences, the tracking is done by making use of the CCD matched filter or the digital matched filter while detecting the localized pulses generated from the set. The modulated synchronous signal by the multiply added synchronous pulse sequences are localized by a SAW matched filter or filters on a analog basis or by digital matched filter or filters on a digital basis for acquisition.

It is preferable that Tk be integral multiplication of the chip width Ts of the synchronous signal and Tc be integral multiplication of Tsn for simplification of the processing and reduction of the cost, where Tsn represents the chip width of the time varying synchronous pulse sequence, Tk is the chip width of the deta mapped code pulse sequence having the code length N and Tc represents the chip width of the ordering pulse sequence.

In addition, it is also preferable to make the sampling rate of the CCD and the A/D converter to be integral multiplication, but more than 2 times, of 1/Tsn for simplification of tracking. As is well known to those skilled in the art, integral multiplication includes 1 time. Moreover, multiply added synchronous pulse sequence may be composed by multiply added product sequences generated by multiplying 3 or more sequences.

It is also preferable that, but not limited to, the integer relation of the code lengths as well as the chip rates be established among the synchronous signal, the data-mapped code pulse sequences and the ordering pulse sequences although non-integer relationship among them may be used.

The code sequences used for data-mapped code pulse sequences included in the pulse sequence signals, the modulated signals, the hopping signals and so forth are those that generate the localized pulses and some of them are the Maximal length sequences, the Gold code sequences and the KAZAMI sequences. It is preferable that the number of the localized pulses per period be, but not limited to 1. Moreover, the code sequences used for ordering are, but not limited to, linear feedback shift register sequences (LFSR sequences) such as the Maximal length sequences, the Gold code sequences and the KAZAMI code sequences, the GMW sequences, the Bent sequences, nonlinear sequences, multiple value pulse sequences and so forth. (Please refer to non-patent literature 1, page 52 to 93.)

Since between the maximal length sequences expressed by the primitive polynomials on the Galois field modulo 2, there exist a relationship that one primitive polynomial having the degree of the polynomial of integral multiplication of that of the other one has the code length of integral multiplication of that of the other one and its auto-correlation function has only one localized pulse per period making the detection of the pulse simple, it is preferable that those Maximal length sequences be used for simple processing.

The Gold code sequences and KAZAMI code sequences having the same relationship may be used for synchronous codes, ordering codes and data-mapped codes.

The multiply added product basic pulse sequences may contain the basic pulse sequences made by making use of the sequences that have the relationship described hereinabove the pulse sequences with longer code length of which are used for ordering while the shorter code pulse sequences are used for data-mapping. The use of the basic pulse sequences composed by using the maximal length sequences, the Gold code sequences, the KAZAMI code sequences and so forth having the relationship stated above increases the diversification of the assortment of the sequences.

To equip the sequences with large ordering capabilities for a large degree of multiple addition and capabilities for the large scale multiple access communications, it is effective that the pulse sequences representing the maximal length sequences with short code lengths are used for data-mapping and the ordering pulse sequences are to represent the other codes listed above in order to detect the localized pulses shortly. It is also possible that the period of the ordering pulse sequence is selected to be pKN where p is, but not limited to, integers in order to generate long period basic pulse sequences containing the data-mapped codes aligned in the time axis so that multiply added basic pulse sequences with the long periods be established. To generate a multiply added basic pulse sequence with larger degree of the multiplication, more than one code pulse sequences are used for ordering. It is preferable that a frame containing a header and control codes attached to the multiply added basic pulse sequence be used for high transmission rate and the high-capacity transmission. Moreover, for the packet transmission, the multiply added basic pulse sequences generated in the way as stated above are to be converted into binary pulses for the data slots to form the frame together with the header and the control codes, although the frame may have other configuration.

The tracking and the acquisition for multiple access are executed by making use of a common timing signal transmitted or a signal asynchronous among transmitting and/or receiving devices. It is preferable that the synchronous signal by making use of the code pulse sequence or sequences be made by using code pulse sequence/sequences or multiply added code pulse sequence/sequences having adequate code length/lengths for identification and ordering of the devices. The synchronous signal made of a set of single pulse sequences is so configured that the adequate number of those pulses are used for acquisition and tracking through a detection of the localized pulses, or that the identification of the devices be executed independently from the acquisition and the tracking by using common or their own code sequences and so forth.

The synchronous signal made of multiply added pulse sequences is composed of code sequences the number of which covers at least identification of devices and ordering of the multiply added pulse sequences, or of code sequences which have necessary length for setup of the ordering and the number for identification of the devices.

Or, the synchronous signal may be made of a multiply added pulse sequence composed by multiplying time-varying pulse sequences that have shift times and a common delay time starting from 0 by time-invariant pulse sequences with a common variable representing the shift times of the time-varying pulses and cancelled delay time, and are made of other code sequences than the time-varying pulse sequences in order that the time-variable sequences and/or the time-invariant sequences are used for identification of the devices.

The time-varying code pulse sequences are to be designed to have longer code lengths than those of the time-invariant pulse sequences. The multiply added pulse sequence designed as stated above enables acquisition by using the localized pulses in a short period of time.

The tracking may be performed through controlling the phase of the local oscillator, for example, digitally or by analog processing. The present invention includes both the multiply added synchronous pulse sequences that are composed of the time-varying pulse sequences that have shift times varying at a constant rate and are multiplied by the time-invariant pulse sequences having a variable made of those shift times and the modulated multiply added synchronous signals modulated by the multiply added synchronous pulse sequences. The secondary modulated signals that have the primary modulated signals modulated by the single synchronous pulse sequence or the multiply added synchronous pulse sequence can have carriers made of high frequency wave or high chip rate code pulse sequence or sequences. The acquisition and the tracking by using the primary demodulated signals are similar in procedure to those of the single modulated signals by synchronous pulse sequence and the multiply added synchronous pulse sequences.

The transmitting device using FDM system transmits the modulated synchronous signals in series with, parallel to, or in series with and parallel to the data signals. One of the synchronous signals transmitted in series with the data signal is that sent by the pilot channel.

The present invention enables the OFDM system and the DMT system to perform acquisition and tracking as seen in other systems although it requires that a period of signals carrying synchronous information as well as data information are sent for them.

Therefore, it is convenient to generate the transmission signals with the timing information by applying the IDFT (inverse digital Fourier transform) technique to the chips per period of the synchronous pulse sequences allocated to the sub-bands through S/P conversion, and that the acquisition and the tracking are performed by making use of the information obtained from the localized pulses of the signal reconstructed from the chips detected by making use of FFT technique. The signal can be the multiply added signal that includes the synchronous pulse sequence or sequences.

Or, the synchronous information can be sent by the signal made of the multiply added modulated sub-carriers by the chips of a period of the code pulse sequences allocated to the sub bands. In this case, the sequences of the sub-band are sent in parallel and synchronously. It is preferable that the synchronous information be obtained from the localized pulses of the reconstructed signal made of the chips that are detected by making use of FFT technique. Because of the chips of all sub-band being synchronizing,

FFT technique is applicable to detection of the modulated chips. A chip per sub-band is detected at one time, so that the FFT step is repeated N times until all the chips for a period are detected where N represents the code length. Then, a full period of sequence is reconstructed in parallel from the chips and acquisition and the tracking are done in the manner similar to that of non-modulated signals.

For simplicity and cost reduction, it is preferable that the FFT technique be applied to the signal divided into a number of sub-bands enabling the use of the small scale A/D converter.

It is also preferable that a multiply added signal for synchronous information be composed of pulse sequences of more than one period for data and a pulse sequence for synchronous information with a longer code length allocated to an exclusive sub channel in parallel with the data pulse sequences and the sub-carriers be modulated by those sequences to be transmitted. It is also possible that each sub-band has modulated signals for synchronous information and data information.

The transmission signals for orthogonal modulation are generated by using modulated orthogonal sub-carriers with synchronizing complex chips of the signals allocated to each sub-channel by making use of IDFT. The original data and the synchronous information are obtained from the reconstructed sequences by using the chips detected through FFT process for the full period. In case of the encoded pulses for error correction being used, the original data are calculated from the decoded and/or reconstructed signals or so forth.

The modulated signals in OFDM systems can be detected directly or by converting the frequencies by making use of SAW matched filter, by converting the demodulated signals to digital signals or by demodulating the A/D converted data.

The tracking is executed in the same way as that of the single synchronous pulse sequence or the multiply added synchronous signals.

The OFDM signals are to be designed to have the guard intervals in order to reduce the distortion when they are detected.

It is possible that the acquisition and the tracking of the FDM transmitting systems is executed by detecting the synchronous information from the transmission signal modulated by the synchronous signal in each sub-band, by detecting the information with a constant period in each sub-band or in the specific sub-band representing the other sub-band. Especially for the OFDM systems using the pilot channel or channels, it is preferable for effective transmission that the acquisition and the tracking be executed by obtaining the information from the pilot sub-channels through a detection of the localized pulses for the sub-channel or for the sub-channels including itself. The pilot signal circulates with a constant period among all the channels designed for data transmission and equalizing the transmission path characteristics. The scattered pilot channels can also be used for equalizing the path characteristics.

Or, it is possible to send the signals transformed into the transmitting impulse or pulse signals generated based on the transmission signal generating pulse sequences, or the signals linearly modulated or nonlinearly modulated to have constant amplitudes by those impulses or pulses. The transmission signal generating pulse sequences further include synchronous pulse sequences.

The modulated transmission signals modulated by the data-mapped ordering basic pulse sequences or the signals made by multiply adding those basic sequences are localized after being demodulated, are localized directly or by converting the frequencies to intermediate frequencies through the SAW matched filters, localized after detecting the pulse sequences by multiplying the signals by their carriers, or localized after converting the frequencies to the intermediate ones and then multiplying them by the intermediate frequencies.

On the other hands, the signals modulated by the transmission signal generating pulse sequences made of the product basic pulse sequences or of the multiply added ones are localized to be detected through demodulation of the detected signals, multiplication of the demodulated signals by the ordering pulse sequences to separate the data-mapped code pulse sequences, then detection of the filtered ones. Or, the localized pulses may be generated from the signals of intermediate frequencies through the same process, or from the signals that have control pulses attached and that are detected through being multiplied by the ordering sequences and the carriers or the intermediate frequency carriers. The procedures listed above may be executed by employing the analog, digital or analog and digital processing.

If the transmission signal generating pulse sequences that are the binary pulses converted from the chips consisting of the multiply added code pulse sequences are detected, the chips are used for the reconstruction of the multiply added basic pulse sequences which are to be multiplied by the ordering pulse sequence, consecutively.

The modulated synchronous signals are the modulated timing impulse signals modulated by the timing impulses, by the code pulse sequences or by the impulses based on the code pulse sequences. The localized pulses detected from the modulated timing impulse signals are used for the acquisition and the tracking for the receiving devices. The signals modulated by the code pulse sequences or by the impulses based on the code pulse sequences for acquisition and the tracking are demodulated, and then localized to be used. The transmission signals listed above may be either the primary modulated signals or the secondary modulated signals.

The transmission signals including the primary modulated signals modulated by the synchronous signals or by the data signals are processed in the way that the demodulated primary signal detected is demodulated first then localized through the matched filter or cross-correlation circuit, the primary signal is A/D converted first then localized digitally, or is localized through the SAW filter. The tracking for the signal is executed through the tracking circuit by making use of the demodulated primary signal.

Since transmission of any primary synchronous signal requires a period or periods of the pulse sequences representing code length(s), an integral multiplication of the period of the sequence(s) for localizing, acquisition and tracking.

The present invention allows the primary modulation to be done first, then the secondary modulation to be executed, or vice versa.

The present invention accepts the transmission of the data and the synchronous information via the hopping frequency for frequency hopping transmission systems. The hopping of the invention may be done by modulating the hopping carrier by the chips of the synchronous code pulse sequences, the basic pulse sequences or the multiply added pulse code sequences. As is well known to those skilled in the art, the hopping systems are divided into the low speed hopping system representing that for which the hopping occurs once per more than one chip, the equal hopping system representing that for which the hopping occurs once per chip and high speed hopping representing that for which hopping occurs more than one time per chip.

The high speed hopping system may be so configured that more than one chip of the hopping pulse sequence having the chip width TH is included per Tk of the data-mapped code pulse sequence, so that the number of the detection for N Chips totals NTk/TH.

The transmitting device generates the transmission signals of the modulated hopping carrier, that hops from one sub-band to another, by modulating the carriers by making use of the chip amplitude of the transmission signal generating pulse sequences synchronizing with the hopping sequence. In addition, the spectrum of the modulated carrier made of the modulated primary signal for transmission of the synchronous information and the data information spreads into the frequency band widely while the signal is hopping among the sub-bands according to the hopping sequence.

The modulation of the hopping system is executed by using one of the linear modulation techniques including APSK technique or the constant amplitude non-linear modulation techniques as seen in the constant frequency carrier systems.

In stead of the linear modulation by the amplitudes of the transmission signal generating pulse sequences, the modulated hopping carrier may also be modulated by the primary modulated signal that is generated by using the binary pulses converted from the chip amplitude of the sequences for the modulation.

Since, within the limit of the chip speeds of the data signals, the frequencies of the carriers and hopping speeds of the hopping signals are stable, the transmitting devices may send a synchronous pulse sequence or a set of synchronous pulses preluded to the data signal made of one or more than one period of the data-mapped code pulse sequences and the receiving devices detect the localized pulses of the preluded synchronous signals from the detected signals, then the localized pulses of the data-mapped code pulse sequences are detected to calculate the shift times based on the localized pulses of the synchronous signals. The data are calculated from the shift times thus detected.

The acquisition of synchronization for the frequency hopping systems are executed in the following way: the transmitting device sends the modulated hopping signals modulated by the synchronous code pulse sequences while spreading the spectrum into the band according to the prefixed hopping sequence. On the other hands, the receiving device detects the signal according to the hopping sequence, then the synchronous signal is rebuilt from the detected signal obtained through demodulation, and next the localized synchronous pulse is detected from the rebuilt signal by the matched filter for acquisition. Or, the transmitting device generates and sends the modulated signal with a hopping carrier or carriers modulated by the primary modulated signal or signals that are generated through a modulation of sub-carrier by using the code pulse sequence or sequences for synchronous information, and the receiving device rebuilds the primary signal from the signal that is detected according to the sequence representing the hopping pattern, then acquires a synchronization by detecting its localized pulse-through a SAW matched filter.

The tracking for the frequency hopping system is executed in such a way, but not limited to, that the transmitting device sends at every hopping period or at every more than one hopping period, the hopping synchronous pulse sequence signal while scattering it into the whole band, and the receiving device rebuilds the synchronous signal from the detected signal in accordance with the hopping sequence defined by the hopping pattern and controls the phase of the local oscillator to execute the tracking, or the transmitting device sends the modulated primary hopping signal modulated by the synchronous signal and the receiving device rebuilds the primary modulated signal that is used for the tracking through a control of the phase of the local oscillator, or the transmitting device transmits the synchronous signal that is included in the length of the hopping symbol in parallel with the data signal and the receiving device execute the tracking processing at every hopping chip.

The receiving device may be so configured that it has an envelope detection circuit, a hopping synthesizer circuit and a holding circuit including a VCO (voltage controlled oscillator) and that the tracking is executed by controlling the VCO with the output signal from the envelope detection circuit in accordance with the sequence representing the hopping pattern.

The input means 10 acquires the original data from various sources including the acoustic data such as those of voices, the images and/or other physical data digitally and outputs the signal containing the data information to the error-correction encoding means 20. The input means 10 may be comprised of a sensor or sensors such as the acoustic sensor including the microphone, the photo sensor including CCD, the infrared sensor such as a photo diode, the far infrared sensor such as a photo sensor, the radiation detector, the magnetic sensor, the electromagnetic sensor or the composite sensor comprising some of these sensors, allowing to form the first dimensional sensor, the second dimensional sensor or the higher dimensional sensor. The input means 10 acquires the data under a control by the control means 60 in synchronization with the synchronous signal and outputs to the error-correction encoding means 20. Or, the input means 10 may also be configured to receive digital data according to the control signal by the control means 60 and to output to the error-correction encoding means 20, or to read the digital data from the memory and to output to the error-correction encoding means 20.

The error correction-encoding means 20 generates encoded data for error correction according to the control means 60 in the way that it converts the bit stream of the data taken from the output by the input means 10 into parallel pulses and encode them for error correction and send the output signal to the data-mapped code pulse sequence generating means 30. The applicable error correcting code systems include, but not limited to, the system of turbo code, BHC code, convolution code, Reed-Solomon code and so forth with or without interleave technique, and each of these systems is used either alone or with some of other systems.

The error correction encoding means 20 may be so configured that the chip set of the basic pulse sequence or the multiply added basic pulse sequence is encoded for error correction instead of encoding of the data. Or, the means 20 may have the first means to encode the data set for error correction and the second means to encode the chip sets of the basic pulse sequences or/and the multiply added basic pulse sequences.

The basic code pulse sequence with the encoded chip set for error correction will be detailed: it is assumed that a([t/Tc]) represents a single-valued function for the error correcting code and Xr(a([t/Tc])Tc−sTc) is the ordering pulse sequence representing s-th order and that the transmission signal is described by using the multiply added code pulse sequences using these formula where a([t/Tc]) represents the error correcting pulse sequence at t and [ ] represents Gaussian symbol representing the integer that is equal to or the maximum number not exceeds the number inside the symbol.

Then, the data-mapped code pulse sequence is obtained from the detected signal multiplied by the pulse sequence written by Xr(a([t/Tc])*Tc−s*Tc). In above, for example, the value of a([t/Tc]) is limited according to the inequality: 0≦a([t/Tc])≦KN, while varying at random.

Therefore, the s-th product basic pulse sequence Bas(t), for example, is expressed as follows:

Bas(t)=d(s*Tc)Xk(t−ζs)Xr(a([t/Tc])*Tc−s*Tc) (1)

In other words, this product basic pulse sequence is a time-varying function made of the control pulse d(s*Tc), the data mapped code pulse sequence Xk(t−ζs) and the ordering sequence Xr(a([t/Tc])*Tc−s*Tc).

If it is assumed that the s-th ordering pulse sequence has the constant shift time b(s) that varies according to the pre-determined sequence, the shift time is b(s)*Tc instead of s*Tc and the ordering sequence is denoted as Xr(a([t/Tc])*Tc−b(s)*Tc). Consequently, the s-th basic pulse sequence Babs(t) that has the shift time varying at random is expressed as follows where s*Tc is included in b(s)*Tc:

Babs(t)=d(b(s)*Tc)Xk(t−ζs)Xr(a([t/Tc])*Tc−s*Tc) (2)

Since the error correction is executed through a detection of the localized pulses of the data-mapped code pulse sequence for the a([t/Tc]) that represents an pseudo-random code pulse sequence, so that a([t/Tc]) in formula 1 and formula 2 covers the code pulse sequences. Especially, in case a([t/Tc]) represents [t/Tc], there exists the following relation:

Xr(a([t/Tc])*Tc−b(s)*Tc)=Xr([t/Tc]*Tc−b(s)*Tc)=Xr(t−b(s)*Tc) (3)

In addition, in formula (1) and formula (2), it is also possible to use a randomized single-valued shift time z(s) instead of ζs in order to randomize data.

As described hereinabove, the present invention covers the multiply added basic pulse sequences comprising the product basic pulse sequences the order of which is expressed by the shift time which is determined according to the code sequence that can be encoded for error correction.

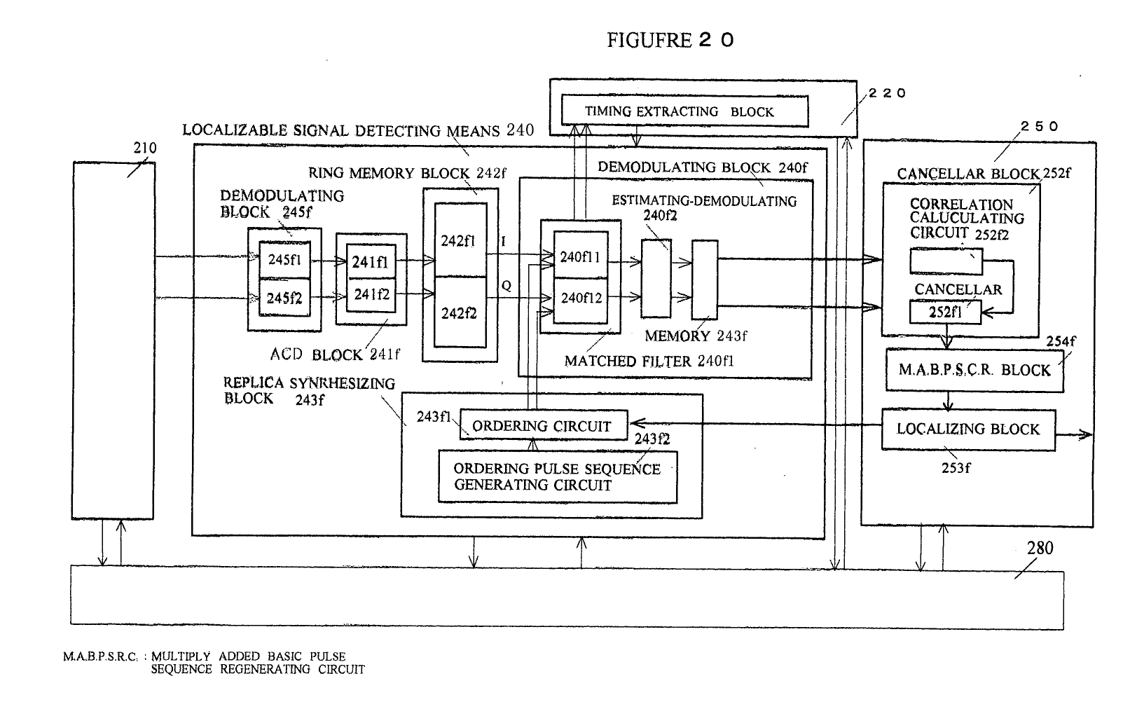

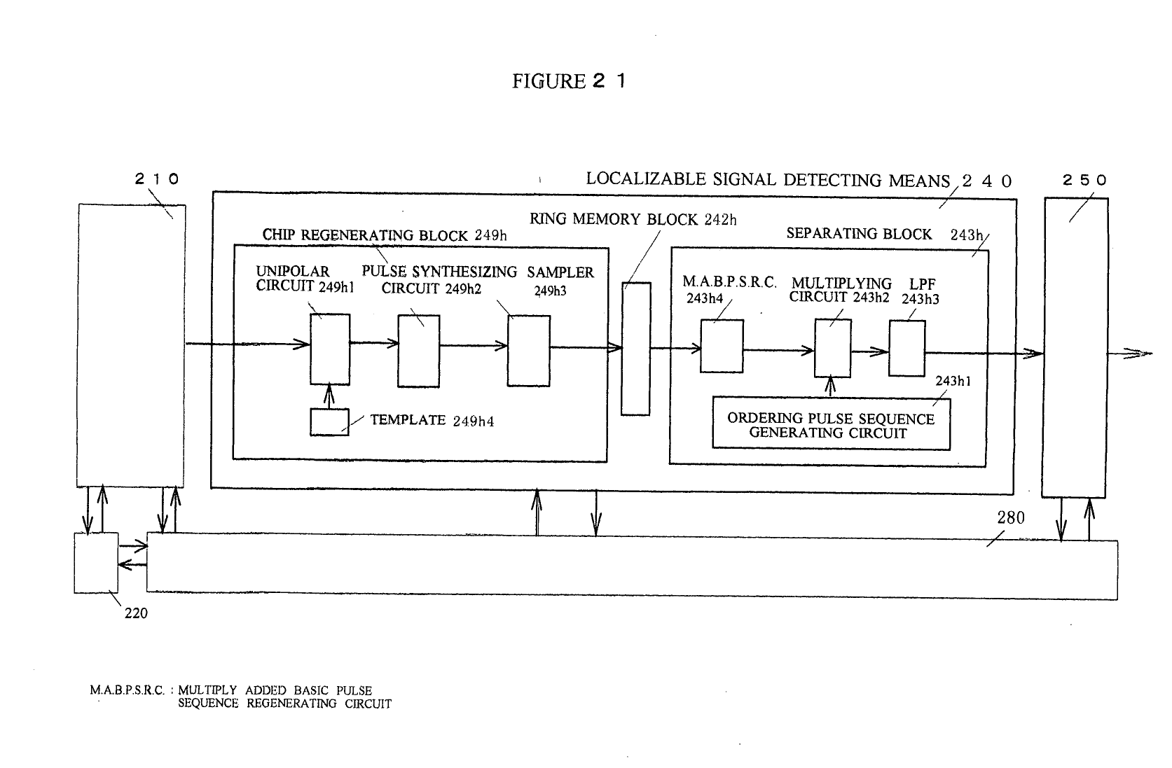

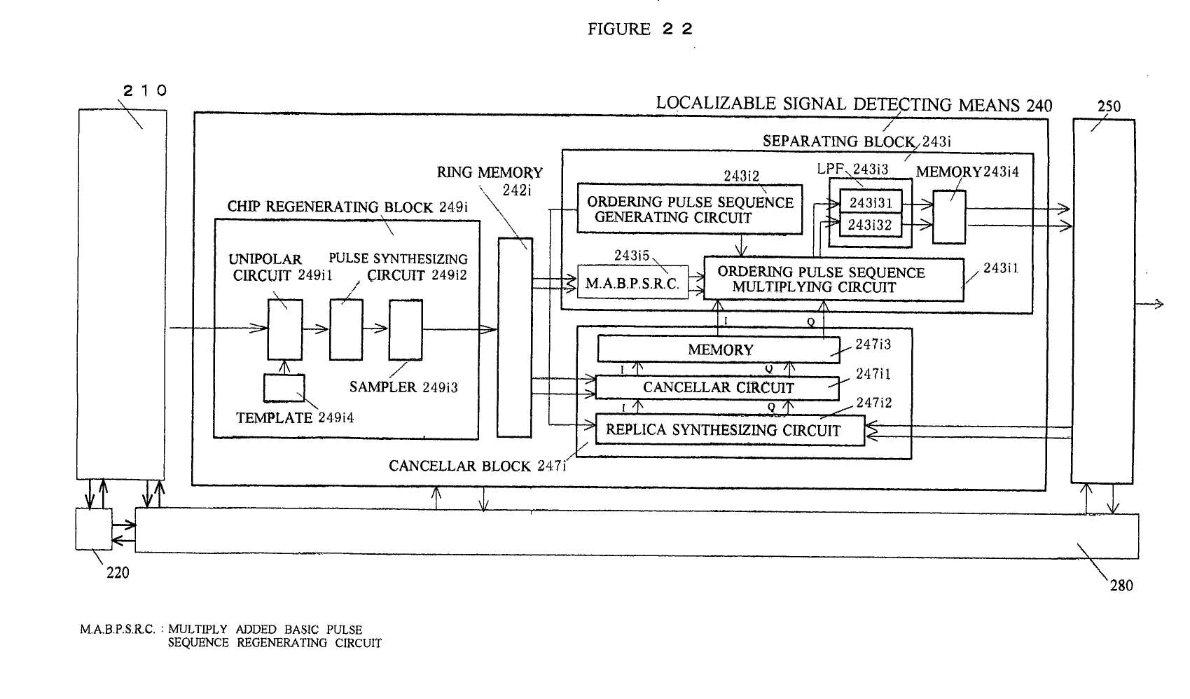

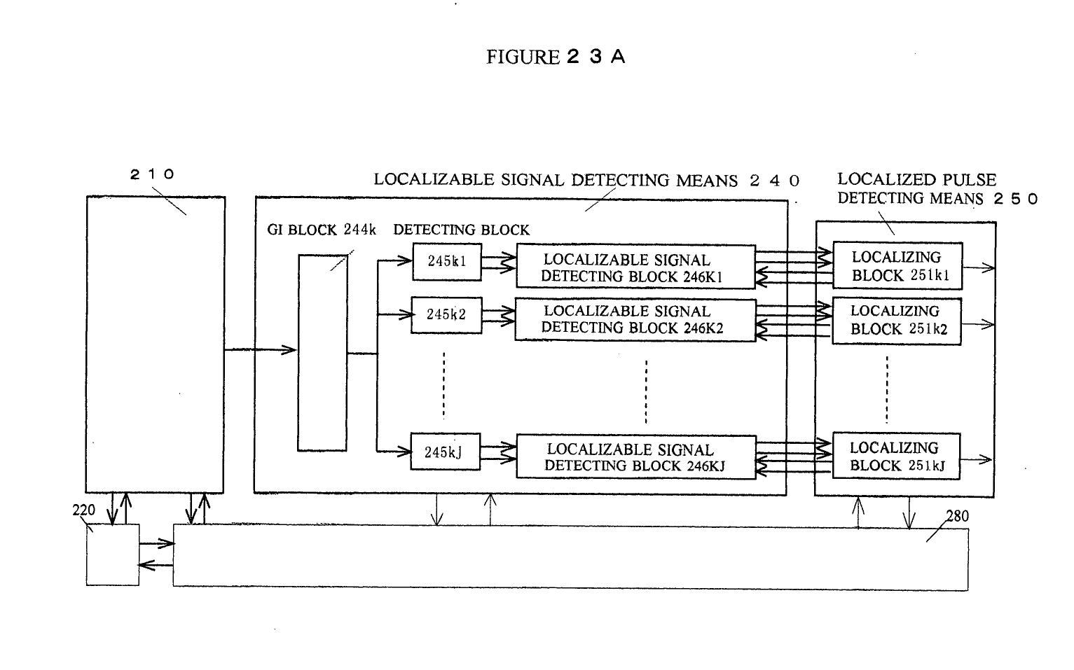

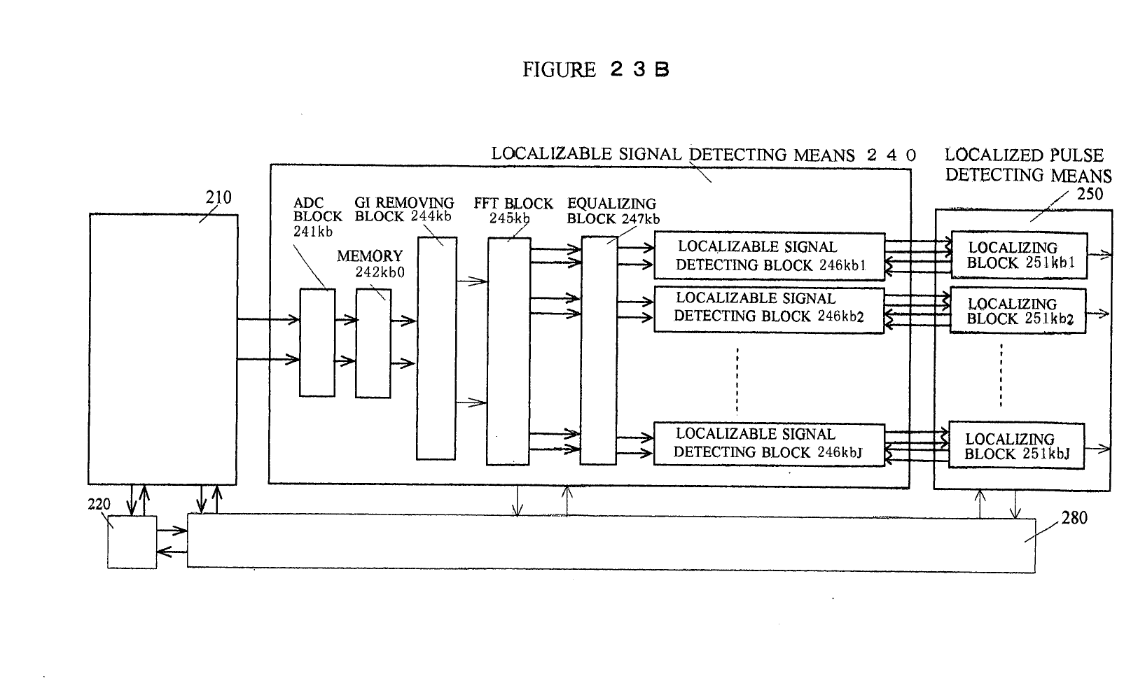

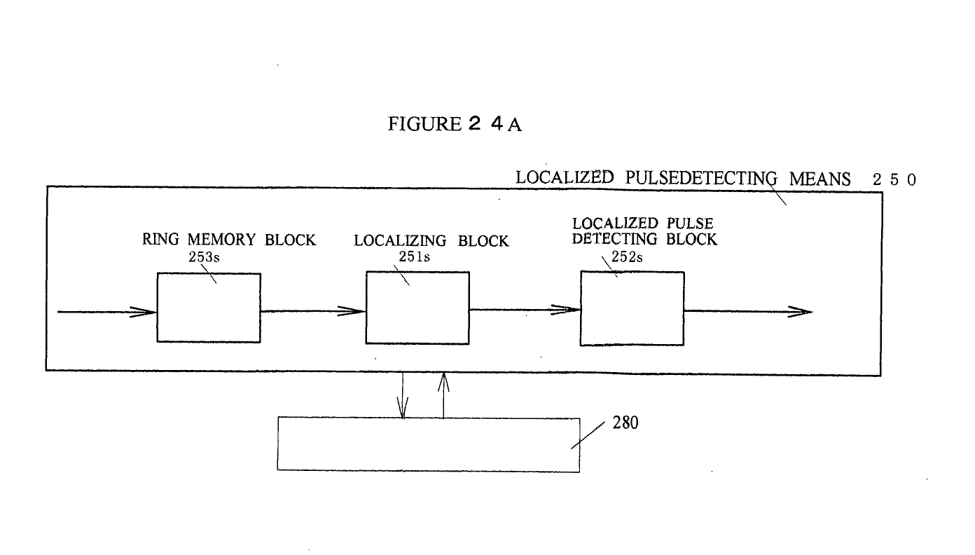

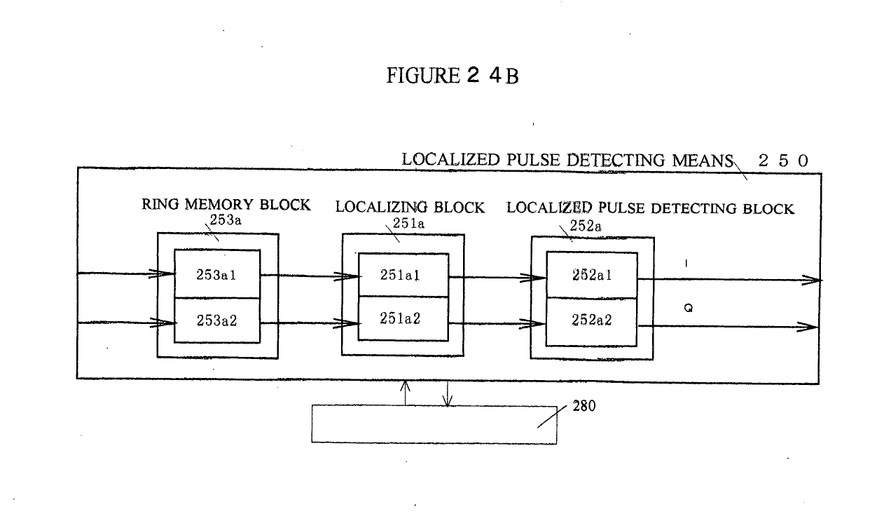

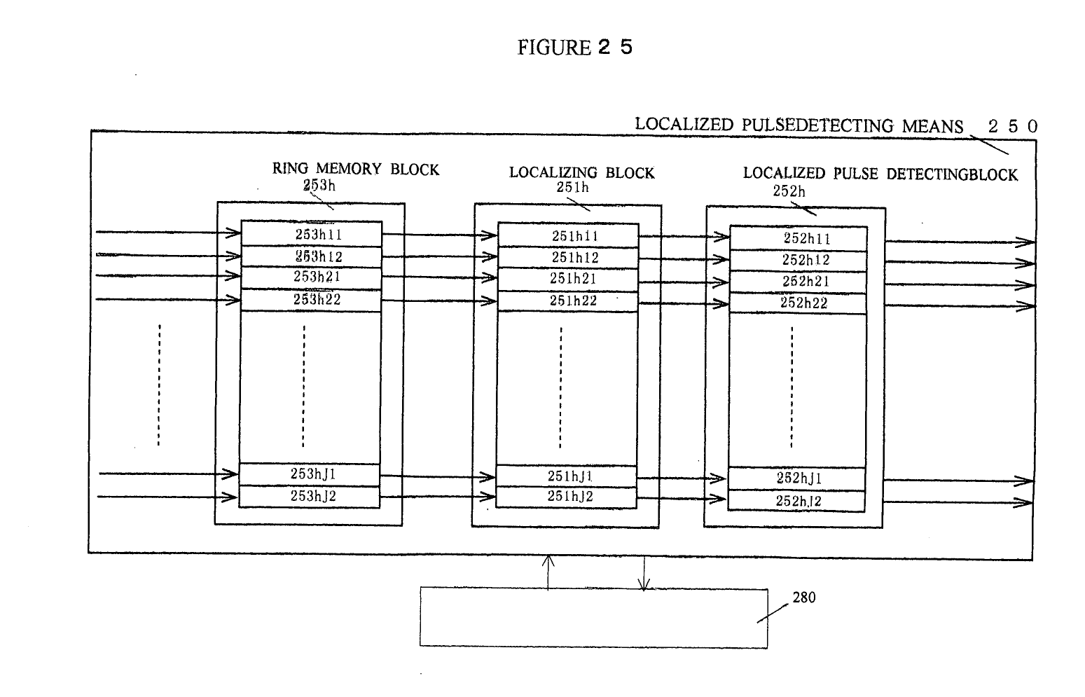

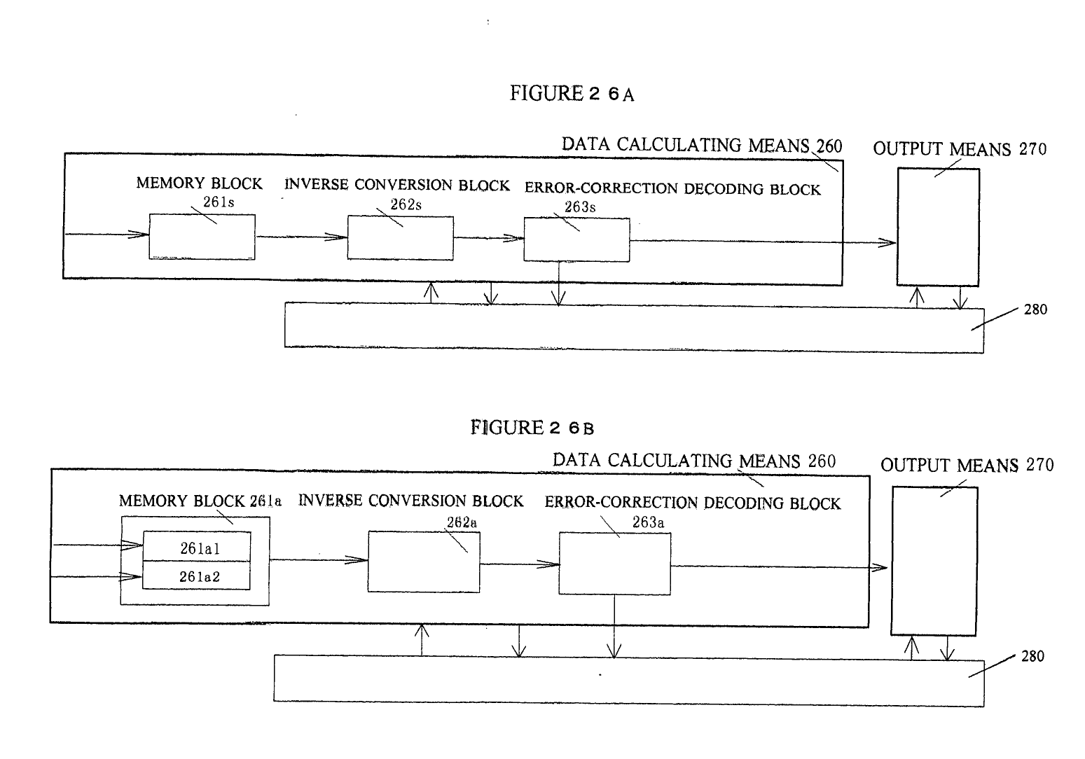

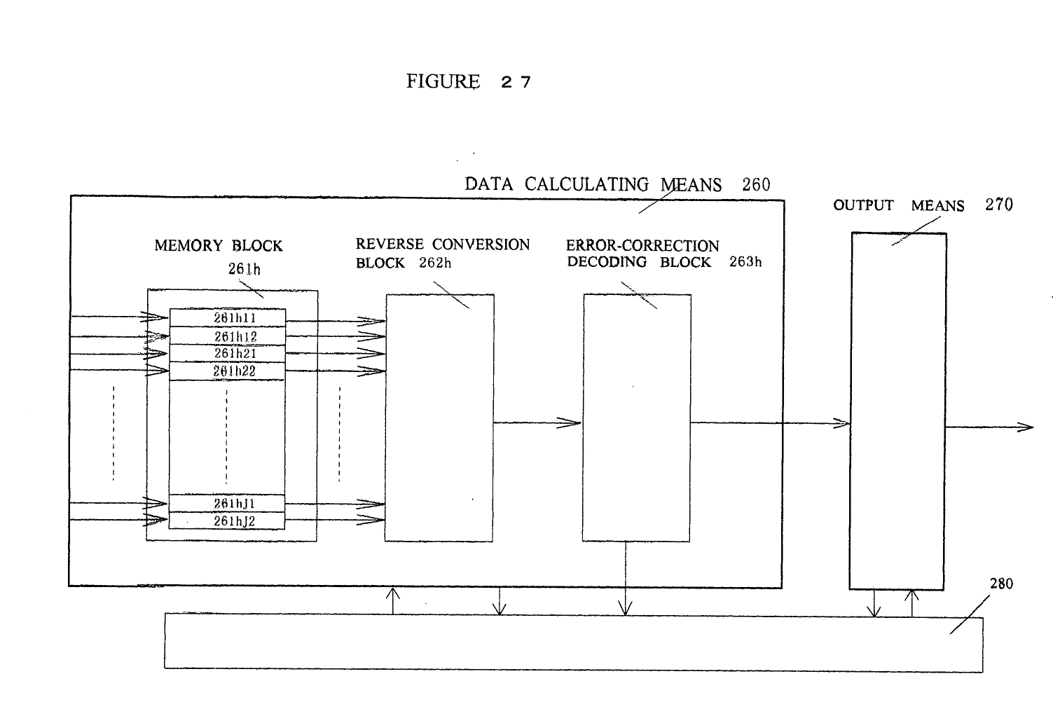

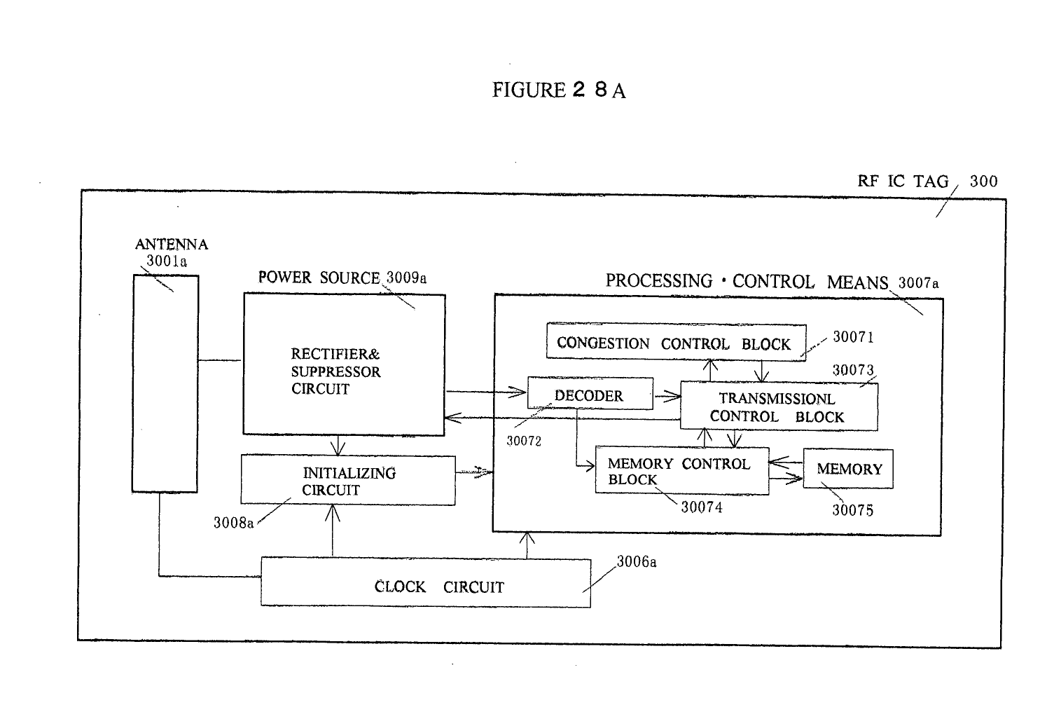

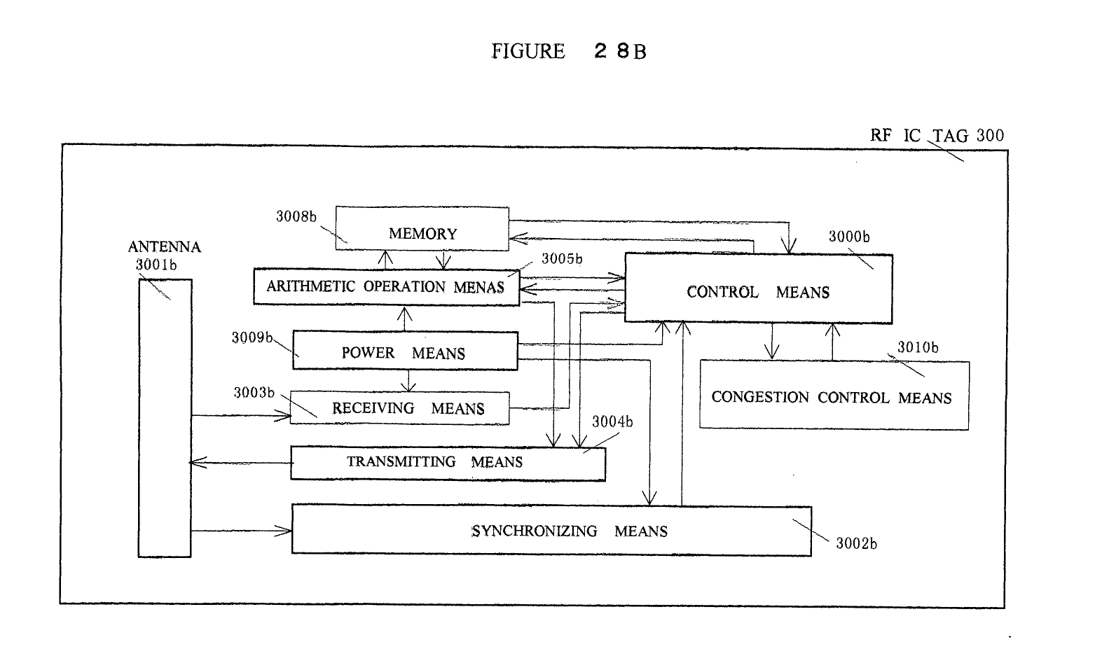

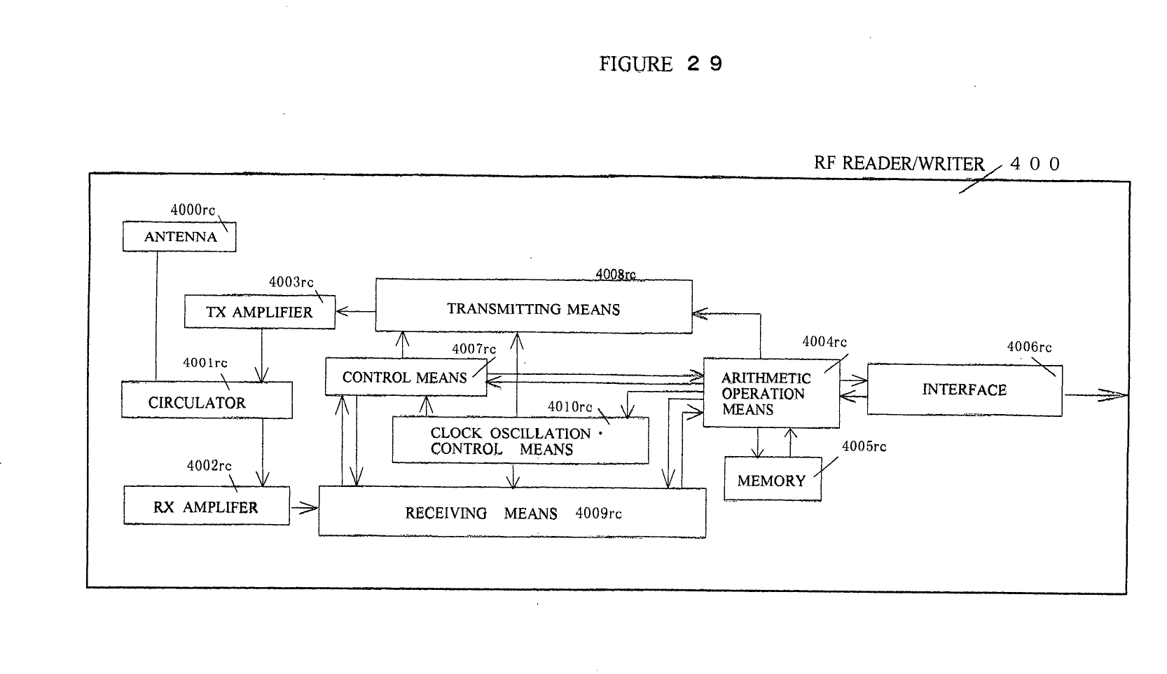

FIG. 2 shows an embodiment of the error correction encoding means 20 for orthogonal modulation system. The serial data sequence acquired by the input means 10 is converted to parallel data pulses by the S/P converting block 21, and those pulses are encoded for error correction by encoding block 22 through which I-channel data signal and Q-channel data signal are generated.

By the way, a single channel coded signal is generated for the pulse transmission system and the single carrier transmission system.

The orthogonal modulation systems using orthogonal carriers or orthogonal sub-carriers, the FDM systems and the frequency hopping systems can generate an I-channel data signal and an Q-channel data signal by using the encoded data for error correction in each of their sub-band, or those systems may generate encoded data for error correction for the whole band but each of their sub-bands generates its own I-channel data signal and Q-channel data signal by making use of the common encoded data.

The data-mapped code pulse sequence generating means 30 generates the data-mapped code pulse sequences that have the shift times onto which the original data or the encoded data for error correction are mapped in accordance with the ordering sequence and have code length N. These pulse sequences are the ordering pulse sequences that have the shift times representing the data, or are different kinds of pulse sequences from the ordering pulse sequences and have shift times representing the data arranged in accordance with the ordering sequence.

It is preferable because of a high efficient data mapping that the data be converted into the number of notation system of base-N, then set the shift times of the code pulse sequences by allocating the figures of the number to the shift times of the code pulse sequence on a one to one basis. Or, the encoding for error correction may be applied to the data expressed by the notation system of base-N, then the data-mapped code pulse sequences are generated by making use of the data. The data-mapped code pulse sequences may be composed of either time-varying pulse sequences or time-invariant pulse sequences that vary according to the shift times of the ordering pulse sequences.

Hereafter, a detailed description will be described for the secondary product basic pulse sequences the orders of which are assumed to increase in ascending order for simplicity.

Assume that the secondary product basic pulse sequence be Bs(t), so that the Bs(t) is expressed by formula (4) by using an ordering pulse sequence, a data-mapped code pulse sequence and a control pulse:

Bs(t)=d(s*Tc)*Xk(t−ζs)*Xr(t−s*Tc) (4)

In formula (4), Xr(t−s*Tc) represents the time-varying ordering pulse sequence the order of which is indicated by the shift time s*Tc. On the other hands, Xk(t−ζs) represents the s-th data-mapped code pulse sequence the data of which is expressed by ζs ranging from 0 to N−1 where the suffix s shows its order. Similarly, d(s*Tc) represents the s-th control pulse at s*Tc.

In general, the product basic pulse sequence may comprise more than one pulse and more than one pulse sequence multiplied. It is possible that the high dimensional basic pulse sequence comprises a data-mapped code pulse sequence multiplied by other data-mapped code pulse sequence or sequences, more than one ordering pulse sequence and more than one control pulse.

The multiply added basic pulse sequence y(t:m) having the degree of multiple addition m is made by adding the basic pulse sequences expressed by the formula (4), and shown by formula (5):

$$\begin{matrix}Y ( t \text{:} m ) = {\sum }_{s = 0}^{m - 1} Bs ( t ) \\ = {\sum }_{s = 0}^{m - 1} d ( s * Tc ) * Xk ( t - ζ s ) * Xr ( t - s * Tc )\end{matrix} \qquad ( 5 )$$

The formula (5) expresses the multiply added basic pulse sequence that has the degree of multiple addition m, the chip number as many as that of the ordering pulse sequence Xr(t−s*Tc) for a period of the sequence of Xk(t−ζs) and the time-varying chip amplitude changes according to the formula (5). In the formula (5), m=1 means single basic pulse sequence with the degree of multiple addition 1.

Since the shift time of the data-mapped code pulse sequence is coincident with one of the N points between 0 to (n−1)*Tk where N represents the code length and Tk is the chip width, the number from 0 to N−1 can be represented by one periodic time of the data-mapped code pulse sequence. Resultantly, it is possible that the data signal comprising multiply added m data-mapped basic pulse sequences with the code length N multiplied by the ordering sequences can be so organized that they represent the m-figure number of the notation system of base N and are written as N̂m(m-th power of N). In addition, the data-mapped code pulse sequence with sequential order v will be configured to represent the v-th figure with its shift time.

Information amount per chip is obtained through a division of the base 2 logarithm of the number by N and is written as (m/N)/log₂N (bits/chip), which leads to the transmission rate expressed by m/(Tc*K*N)*log₂N (bits/sec/Hz) where the chip rate of the ordering sequence is 1/Tc. In other words, the transmission rate is determined by dividing m*log₂N by Tc*K*N, so that it is expressed by m*log₂N/(Tc*K*N) as well. Since the chip rate is proportional to the band width, the expressed transmission rate is also proportional to the band width.

Since the transmission rate increases monotonically in accordance with a growth of m and exceeds 1/(Tc)*log₂m, the transmission rate of the conventional pulse transmission system with amplitude levels m, the transmission rate of the present invention described hereinabove will be higher than that of the conventional pulse transmission system over that point. In addition, since the SNR improvement ratio for the narrow band noise is proportional to the chip rate ratio K through despreading and for the narrow and the wide band noise through localization is proportional to the code length N and so forth, it is possible that the present invention enables a higher improvement ratio of SNR. Consequently, a high speed transmission rate and a large transmission capacity can be achieved by the invention.

In addition, it is possible that the multiply added code pulse sequence is divide into a number of sets of sequences in order that the figures of the number are represented by the kinds of code sequences and the figure of each digit is represented by the shift time of each code pulse sequence. For example, the transmission band is divided into more than one sub-band and the I-component (real part) and Q-component (imaginary part) of the complex modulated signal of each sub-band are generated through a modulation by the allocated multiply added code pulse sequences. Assume that the degree of the multiplication for I-channel and Q-channel in the n-th sub-band are SnI and SnQ respectively, then the transmitted information amount per chip of the data-mapped code pulse sequence is given by the expression ((SnI+SnQ)/N)*log₂N (bits/chip), which means that the chip rate determines the transmission rate. The expression is equals to ((SnI+SnQ)* log₂N)/N. In addition, the sum of the information amount transmitted by all the sub-bands totals the information amount carried by the whole band and the total transmission rate is also the sum of the rate of each sub-band.

The data-mapped code pulse sequence generating means 30 comprises a data conversion block, a memory and a data-mapping block, and maps the data onto the shift times of the code pulse sequences in the way that the encoded data for error correction are converted into the number of the notation system of base N with m figures which are allocated to code pulse sequences and determine their shift times.

The data-mapped code pulse sequences are so generated that the same number of the sequences as the number of the digits have respective shift times onto which data are mapped, or that a pulse code sequence has the shift time onto which data are mapped in accordance with the sequential order. The data-mapped code pulse sequence generated by making use of single pulse sequence is multiplied for ordering by the ordering pulse sequence the shift time of which changes in accordance with the pre-determined sequence.

It is detailed as follows: for the pulse transmission systems and the modulated single carrier systems, data are mapped onto the shift times by making use of a set of shift registers consisting of N-stages repeatedly as many times as the degree of the multiplication m, or by making use of sets of N-stage shift registers as many as the degree of multiple addition in parallel for high speed processing.

On the other hands, in order to perform a simple but high speed processing for the orthogonal modulation system, two sets of shift registers for I-channel and Q-channel can be employed. For higher processing, a number of shift register sets as many as the degree of multiple addition are to be used in parallel. Moreover, for FDM systems including OFDM one, shift registers equipped with in each sub-band may be controlled in accordance with the transmission rate.

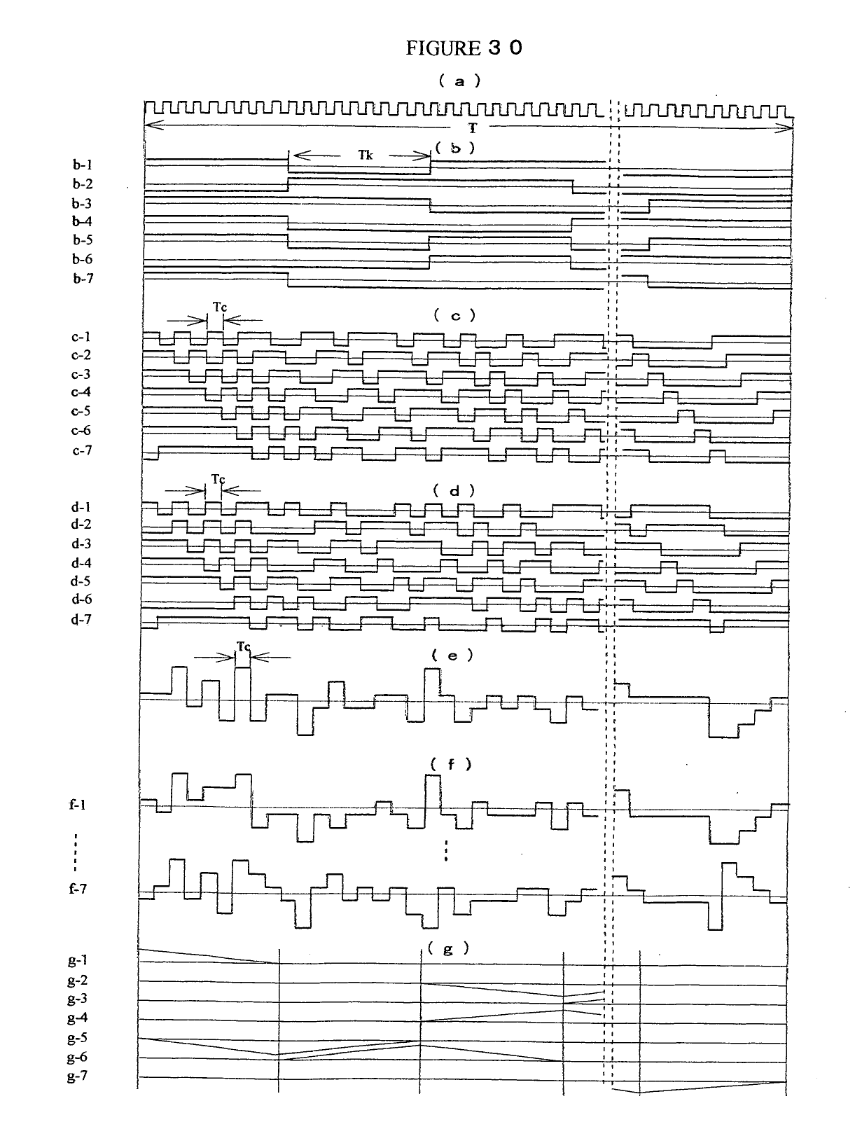

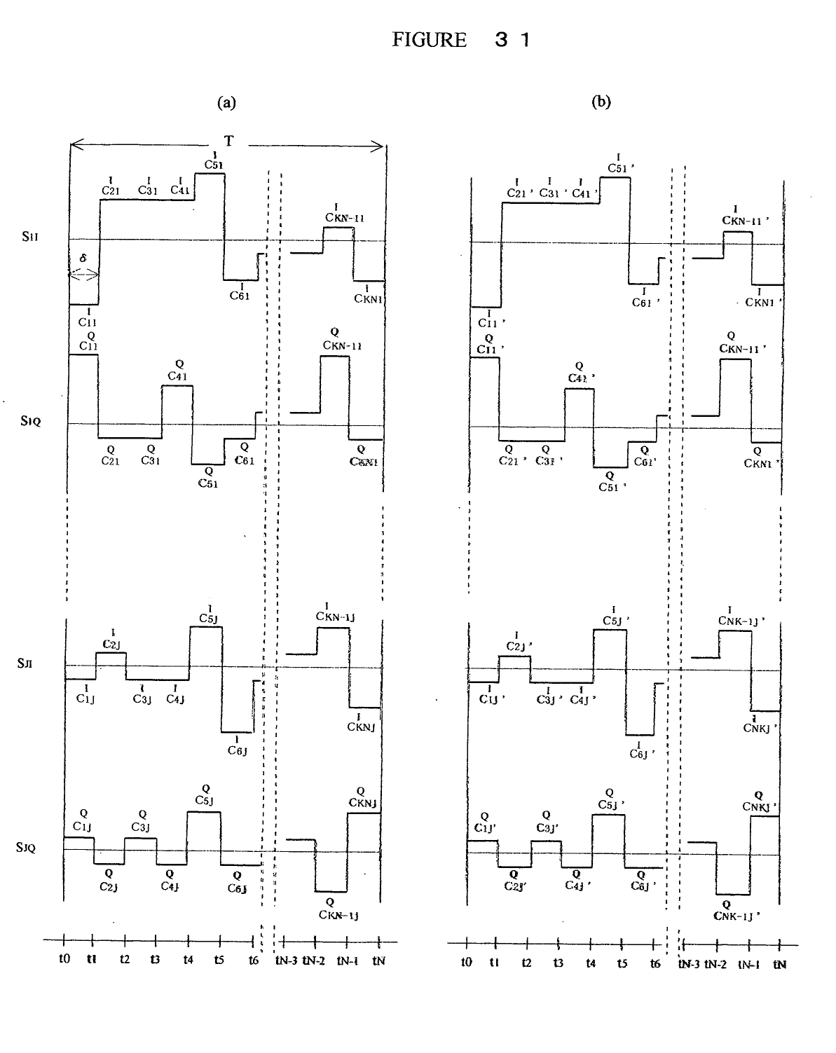

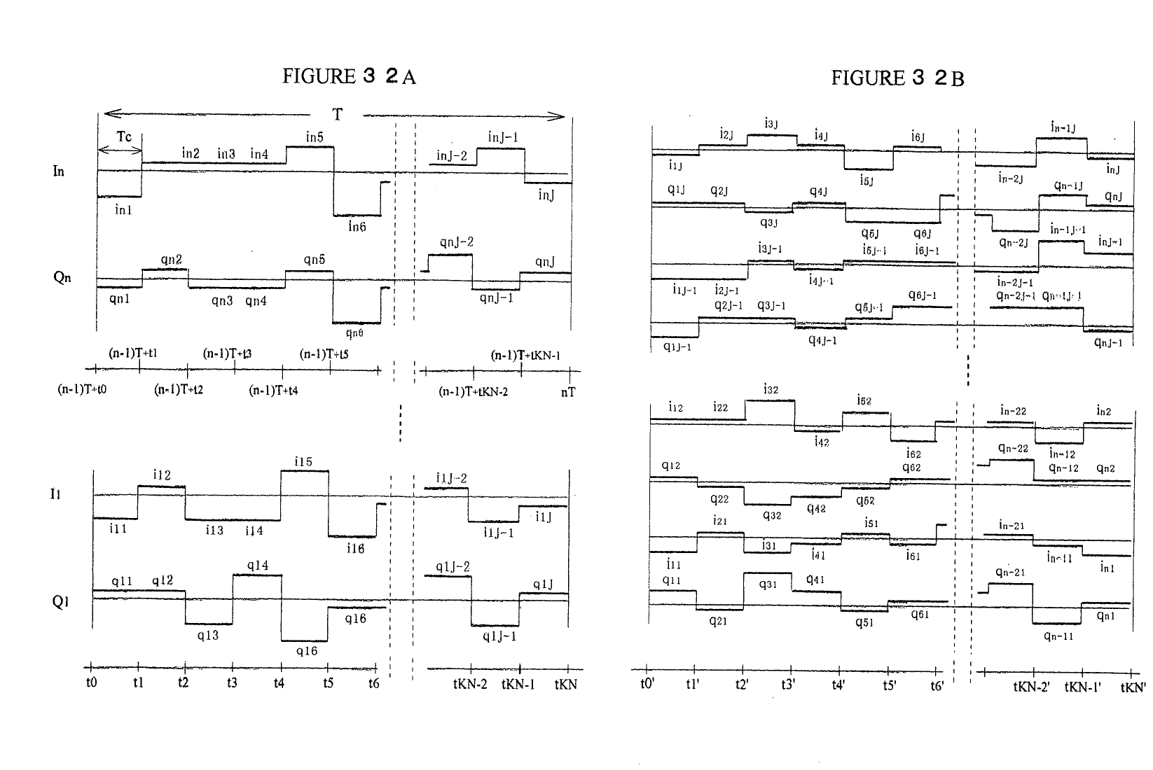

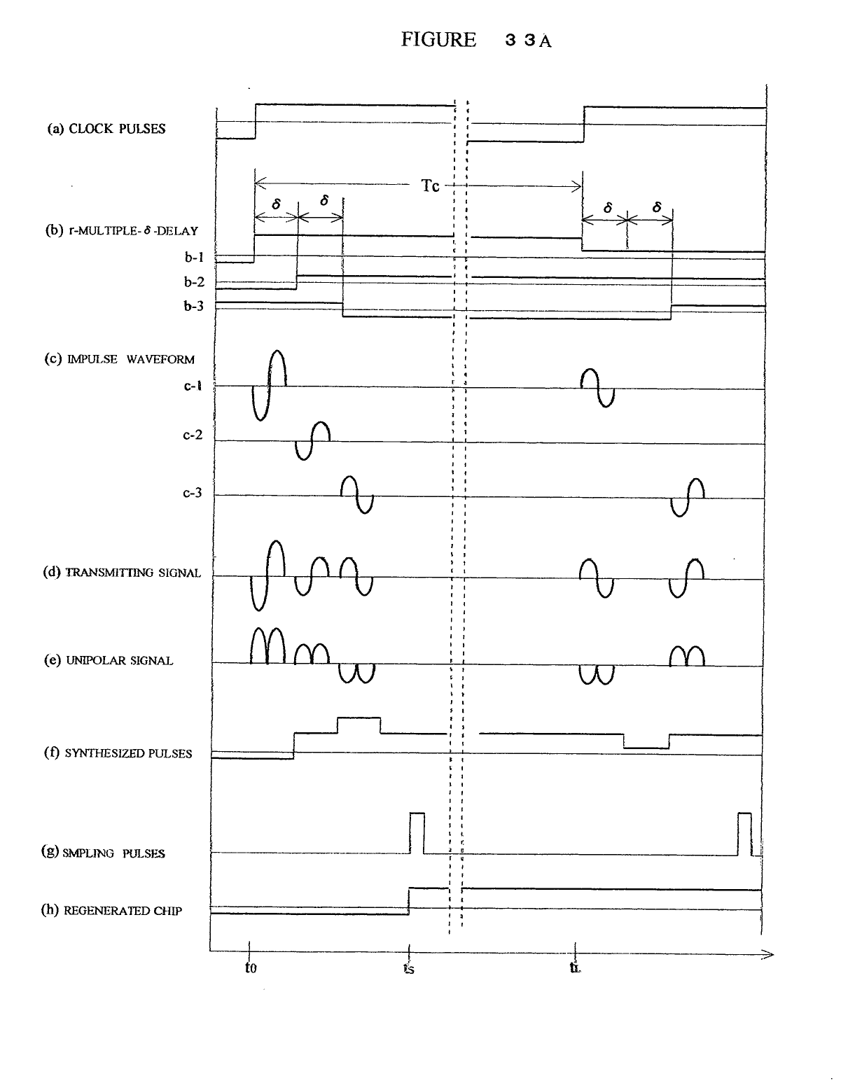

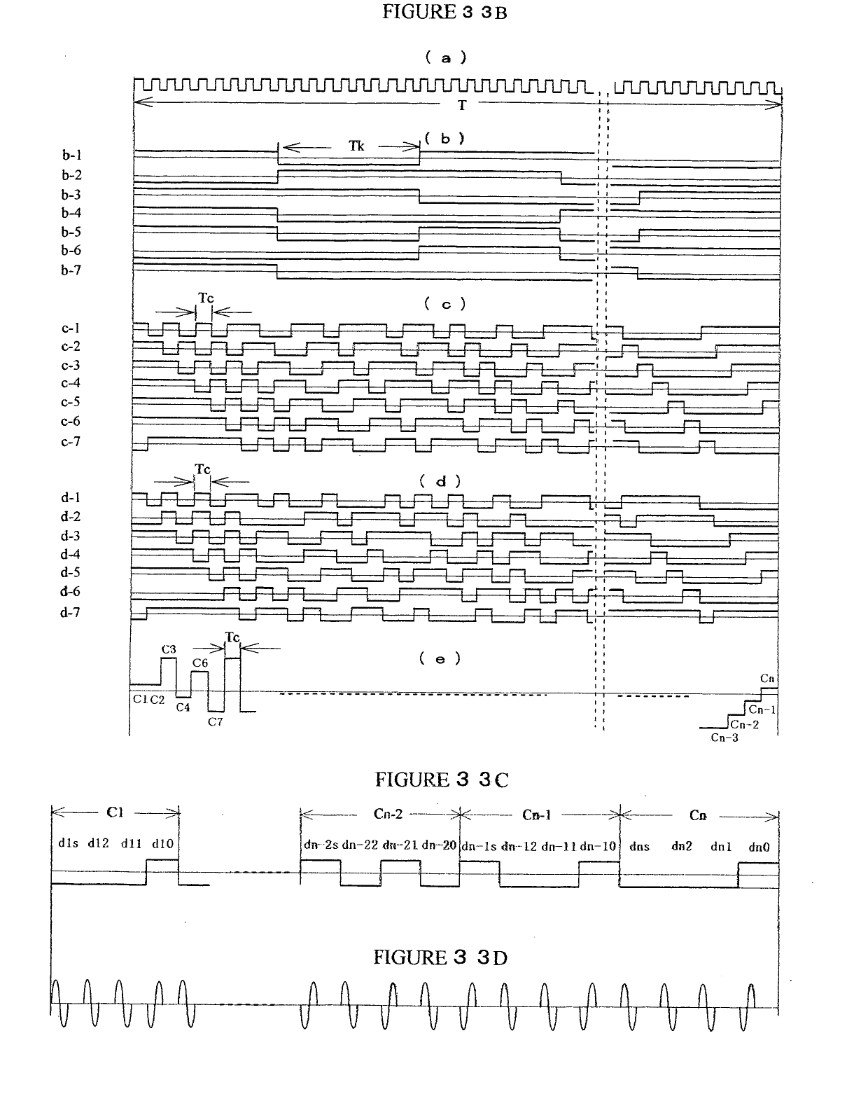

FIG. 3 shows an embodiment of the data-mapped code pulse sequence generating means 30 comprising data converting block 31s, memory 31s, data mapping block 32s and code pulse generating means 33s. It is preferable that the means 30 be used for, but not limited to, a generation of data-mapped code pulse sequences for impulses, pulses, modulated single carrier signals and frequency hopping signals. The encoded data for error correction are converted into the number that is expressed by the notation system of base-N with m figures by the data converting block 31s, then stored in memory 34s. The stored data of the memory 34s are read and transferred to the data-mapping block 32s so that the shift times of the code pulse sequences in the initial state generated by the code pulse sequence generating block 33s are determined to generate I-channel data-mapped code pulse sequences.

FIG. 4 shows an embodiment of the data-mapped code pulse sequence generating means 30 used for the orthogonal modulation systems as well for the parallel OFDM pulse transmission systems, the parallel impulse OFDM transmission systems, the frequency hopping transmission systems, and so forth.

The encoded data for error correction are converted into the number that has the notation system of base-N with m figures by data converting block 31c and stored in the memory 34c, where N represents the length of the code pulse sequence maintaining the relations N=2̂n−1.

The data stored in the memory 34c for I-channel are read on a digit basis in ascending order or descending order to be sent to the data mapping block 32c1 for I-channel according to the control signals, then set up shift times of the initialized code pulse sequences for data mapping output from the code pulse sequence generating block 33c to generate the data-mapped code pulse sequences. Similarly, the data-mapped code pulse sequences for Q-channel are generated by data mapping block 32c by using the stored Q-channel data.

The data-mapped code pulse sequences for I-channel and for Q-channel are multiplied through data-mapping block 32c1 and 32c2 respectively by the control pulses that are generated by control pulse generating means 40 according to the output data signal from data converting block 31c for corresponding channels in each order to generate the basic pulse sequences.

The control pulse generating means 40 calculates the polarities of data-mapped code pulse sequences based on the m-figure data converted by the data converting block 31c for the corresponding figures and switches those polarities in order that inner interference from other basic pulse sequences are reduced when detected. It is preferable that the algorithm for the switching be configured to minimize the interference noise. The switching may be done by transmission signal generating means 70 in stead of data-mapped code pulse sequence generating means 30.

The code type transmitting device 1 employing OFDM system is divided into the stream modulating device and the parallel modulating device according to the modulating systems. The stream modulating system allocates the multiply added basic pulse sequences with the degree of multiple addition m to sub-bands as many as J forming complex data, then modulates the orthogonal sub-carriers for the I-channel and the Q-channel by the allocated sequences, respectively. The pulse streams of the complex data-mapped code pulse sequences are synchronizing among J sub-bands and sub-carriers are modulated by their corresponding chips synchronously (Please refer to FIG. 31).

On the other hands, the parallel modulating system uses two sets of multiply added code pulse sequences for complex data and allocates their chips in a period to I-channels and Q-channels of sub-bands in parallel. The sub-carriers are modulated by those chips, synchronously (Please refer to FIGS. 32A and 32B).

FIG. 5 shows an embodiment of the data-mapped code pulse sequence generating means 30 for OFDM systems with sub-bands as many as J employing the stream modulation. This stream modulating system modulates the carrier(s) or sub-carrier(s) by pulses or impulses of the stream. In the present invention, the carriers are modulated sequentially by the chips of the multiply added code pulse sequence.

It is preferable that this data-mapped code pulse sequence generating means 30 be used for the high speed data mapping block in the parallel modulating OFDM system, UWB transmission system and so forth.

The input data are converted by the data converting block 31b into the number that has the notation system of base-N with m-figures and stored in memory 34b. Simultaneously, the converted data are used for generation of the control pulses by control pulse generating block 40.

The data stored in memory 34b are read and allocated to the shift registers from 32b11 to 32bJ2 of the data-mapping block 32b so that the shift times of the code pulse sequences generated by the code pulse generating block 33b for data-mapping codes are set up by the data of the corresponding shift registers. Resultantly, the I-channel data-mapped code pulse sequence and the Q-channel data-mapped code pulse sequence for each sub-channel are output in parallel and sent to the transmission signal generating means 70. Wide sub-bands are required for the UWB transmitting system.

In FIG. 5, each sub-channel has an I-channel shift register and a Q-channel shift register and both registers of the j-th sub-channel repeat processing of the data mapping mj times where mj represents the degree of multiple addition allocated to the sub-channel. Other configurations such as parallel mj shift registers for parallel processing, single shift register per sub-channel and single shift register per the channel will be applicable if required speed is performed

In FIG. 5, the notation system of the data is converted to that of base N with m figures in data converting block 31b, then they are stored in memory 34b. Simultaneously, the data are sent to control pulse generating means 40 where control pulses are generated from the data to determine polarity of the code pulse sequences generated from the code pulse sequence generating means 33b. The stored data are read as sets of complex data and sent to the corresponding shift registers of the data mapping block 32b, respectively, in order to set the polarities of the data mapped code pulse sequences generated from code pulse sequence generating block 33b, then the sequences are sent to transmission signal generating means 70. The data mapping block 32b may be configured by using so many shift registers as the degree of multiple addition.

The ordering provides orders to necessary number of code pulse sequences. The data mapped code pulse sequence represents either the data mapped ordering pulse sequence or the product data mapped code pulse sequence. The data mapped ordering pulse sequence is the ordering pulse sequence that has the shift time representing a figure of the data.

The product data mapped code pulse sequence is produced in the way that the data mapped code pulse sequence is multiplied by a code pulse sequence having enough code length to provide order to necessary number of data mapped code pulse sequences by making use of the shift time set in accordance with predetermined order. The ordering pulse sequence may be encoded regarding its chip set as far as the data mapped code pulse sequence is separable from the multiply added basic pulse sequence. It is preferable that ordering pulse sequences be made by making use of code pulse sequences having small partial cross-correlations and cross-correlations to reduce inter- and intra-device interference.

Especially, it is preferable that the ordering pulse sequence have the chip rate and the periodic time in, but not limited to, an integral multiplication of those of the data-mapped code pulse sequences in order that the code pulse sequences with pre-determined small cross-correlation values but not undetermined partial cross-correlation values can be used for a separation of the data-mapped code pulse sequences for the receiving device. From another point of view, it is preferable that the chip rate of the ordering pulse sequence be higher than that of the data-mapped code pulse sequence and the ratio K=Tk/Tc be a large integer in order that narrow-band noise including internal interference from other basic pulse sequences be reduced to detect the sequence easily in the receiving device, where Tc and Tk represent the chip width of the ordering pulse sequence and the data-mapped code pulse sequence, respectively.

Since the despreading spreads the narrow in-band noise into the whole band, the SNR is improved in proportion to K.

Especially for the exclusive transmission lines, it is possible that the code length of the ordering pulse sequence is in, but not limited to, an integral multiplication of that of the data-mapped code pulse sequence and the minimal integer to cover the sum of the degree of the multiplication for the whole band or its K-integral multiplication. Due to this configuration, large scale ordering pulse sequences the periodic time of each of which is in an integral multiplication of those of the data-mapped code pulse sequences are composed. As a result, the basic pulse sequence is composed of the data-mapped code pulse sequence spread by the ordering pulse sequence and has a power spectrum consisting of a spectrum of the data-mapped code pulse sequence spread around discrete spectrum of the ordering pulse sequence.

On the other hands, for use in multiple access conditions, the ordering pulse sequences are used for internal ordering of the data-mapped code pulse sequences and inter-device identification. To satisfy this requirement, the ordering is done by allocating to each device a set of exclusive data mapped ordering pulse sequences the types of which represent orders, a set of exclusive ordering pulse sequences to be multiplied to provide all the data mapped code pulse sequences in its or a set of common ordering pulse sequences to be multiplied to provide orders to all the sequences of all the devices.

FIG. 6A is an embodiment of the transmission signal generating means 70 for the single carrier modulated signal. This means generates an demodulated signal by the multiply added code pulse sequences and comprises ordering block 702s, multiple addition block 703s, signal control block 713s, primary modulating block 701s, filter 708s, modulating block 709s, primary carrier generating block 711s and main carrier generating block 710s.

The data-mapped code pulse sequences generated by the data-mapped code pulse sequence generating means 30 in FIG. 3 give orders respectively in the ordering block 702s through a multiplication by the ordering pulse sequences generated by the ordering pulse sequence generating means 50, then are multiply added by the multiple addition block 703s and the generated signal is sent to the control block 713s. The signal control block 713s controls a generation of modulation by the preamble, the control codes and pulses, the data and so forth. The output signal from the signal control block 710s modulates the primary carrier generated by the primary carrier generating block 711s and is sent through filter 708s to the modulating block 709s in which the main carrier generated by the main carrier generating block 710 is modulated by the primary modulated signal to generate transmission signal.

FIG. 6B expresses an embodiment of the transmission signal generating means 70 by which the primary modulation is done by the bit stream obtained by converting the amplitudes of the chips of the multiply added basic pulse sequences to the digital pulses. This means comprises an ordering block 702t, a multiple addition block 703t, a binary conversion block 712t, a signal controlling block 713t, a primary modulating block 701t, a primary carrier generating block 711t, a filter 708t, a main carrier modulating block 709t and a main carrier generating block 710t. The chips of the multiply added basic pulse sequences generated by the multiple addition block 703t are converted into binary pulse sequences by binary conversion block 712t to generate a bit stream of the binary pulses. The pulse signal is controlled by the signal control block 713t, then generates primary modulated signal through a modulation of the primary carrier generated by the primary carrier generating block 711t by making use of the pulses, and next generates transmission signal in the main carrier modulating block 709t by modulating, by the filtered signal from the filter 708t, the main carrier generated by the main carrier generating block 710t.

FIG. 7A represents an embodiment of the transmission signal generating means 70 for the code type transmitting devices using orthogonal modulation method. This means comprises an ordering block having an ordering circuit 702a1 for I-channel and a circuit 702a2 for Q-channel both of which generate cross products of the ordering pulse sequences generated by ordering pulse sequence generating means 50 and the data-mapped code pulse sequences, respectively, multiple addition block 703a that includes a multiple addition circuit 703a1 for I-channel and a circuit 703a2 for Q-channel both of which add multiply the data-mapped code pulse sequences with orders, respectively, signal control blocks 713a that includes a signal control circuit 713a1 for I-channel and a circuit 713a2 for Q-channel, respectively, primary modulating block 701a that has a modulating circuit for I-channel that modulate the carrier for I-channel (cos ωt component) generated by the primary carrier generating block 711a by I-channel multiply added basic pulse sequences and a circuit 701a2 that modulates the Q-channel carrier (sin ωt component) from the block 711a by the corresponding sequences, filter 708a including a filter 708a1 for I-channel and a filter for Q-channel and an orthogonal modulation block 709a that generates an orthogonal modulated signal by modulating the carrier generated by the main carrier generating block 710a by the output signals from the filter 708a. The means works in synchronization with clock pulses generated by the control means 60.

The linear modulating method that generates a modulated signal having an amplitude in proportion to the pulse height is used for the primary modulation by the multiple level pulse sequences such as the multiply added basic pulse sequences. Since these data-mapped code pulse sequences are detected through an orthogonal detection, the I-channel signal and the Q-channel signal can have either the same order or the independent order from each other.

The data-mapped code pulse sequences are input to the ordering circuit 702a1 and 702a2 in which those sequences are multiplied by the ordering sequences generated by the ordering pulse sequence generating circuit of the ordering pulse sequence generating means 50 to form basic pulse sequences with order. This process is repeated as many times as the degree of the multiplication, then multiply added basic pulse sequences for I-channel are generated from those sequences by multiple addition circuit 703a1. Similarly, multiply added basic pulse sequences for Q-channel are generated from the output signal from ordering circuit 702a2 by multiple addition circuit 703a2.

The multiply added basic pulse sequences for I-channel and Q-channel are input to signal control circuit 713a1 and 713a2 of the signal control block 713a respectively and control signals and so forth are added to them to set up a pulse flow.
I channel component is input to a primary modulating circuit 701a1 and modulates the carrier for I-channel generated by the primary carrier generating block 711a.
Similarly, Q-channel component is input to modulating circuit 701a2 to generate
modulated primary signal for Q-channel. These modulated signals are filtered by the
filter 708a1 and 708a2 respectively and modulates the main carriers from main carrier
generating block 710a to generate a transmission signal made of orthogonal modulated
signals in orthogonal modulation block 709a.

It is also possible that, instead of modulating the main carrier by the primary modulated signal, a set of orthogonal main carriers generated by the carrier generating block 710a are modulated directly at the primary modulating block 701a, filters by filter 708a to generate output signal for transmitting device 70.

FIG. 7B represents an embodiment of transmission signal generating means 70. The means comprises an ordering block 702u, a multiple addition block 703u, a binary conversion block 712u, a signal controlling block 713u, a primary modulating block 701u, a primary carrier generating block 711u, filter 708u, an orthogonal modulation block 709u and a main carrier generating block 710u. The ordering block 702u and the multiple addition block 703u work in the same way as 702a and 703a, respectively. The binary conversion block 712u converts the multiply added basic pulse sequences into binary pulses according to the channels, then the binary pulses are built in a sequence combined together with control signals and so forth in the control block 713u. The primary modulating block 701u generates primary modulated signals for I-channel and Q-channel through a modulation of the primary carrier generated in the primary carrier generating block 711u by these pulses, respectively. The modulated signals are filtered by filter 708u1 and 708u2 respectively, then the orthogonal modulation block 709u modulates the orthogonal main carriers generated by the main carrier generating block 710u and adds them together.

FIG. 8A represents an embodiment of the transmission signal generating means 70 for the OFDM method using the stream modulation. Multiply added basic pulse sequences allocated to sub-bands are sent one by one in parallel on a chip basis synchronizing with the sequences of all other sub-bands (Please refer to FIG. 31).

In the stream modulation method for pulse sequences, single or more synchronizing basic pulse sequences are allocated to each sub-band, then symbols corresponding to the chips of the sequence or sequences to modify the I-channel sub-carrier and the Q-channel sub-carrier are generated in order that a multiply added modulated signal is made by making use of them. In the modulation, the sub-carriers of each sub-band are modulated by symbols having amplitude information on the corresponding chips of the allocated sequences synchronously with all other sub-carriers. It is preferable that the I-component and Q-component generated by making use of the multiply added modulated signals for the transmission signal be generated through IDFT because of a simplification of the structure that can reduce costs.

This transmission signal generating means 70 comprises an ordering block 702b that includes ordering circuits 702b11 to 70bJ1 for I-channel and 702b21 to 702bJ2 for Q-channel that generate basic pulse sequences through a multiplication of input signals from the data-mapping block from 32b11 to 32bJ1 for I-channels and 32b12 to 32bJ2 for Q-channel by corresponding ordering pulse sequences generated from the ordering pulse sequence generating means 50, a multiple addition block 703b comprising multiple addition circuits 703b11 to 703bJ1 each of which generates a multiply added basic pulse sequences for I-channel and 703b12 to 703bJ2 for Q-channel in the sub-band, a signal controlling block 713b including signal controlling circuits 713b11 to 713bJ2 for generation of sequences, an IDFT block 704b that analysis J-set of input signals by making use of an IDFT for I-channel and Q-channel, a GI block 707b to add GI to the input signals from the IDFT block 704b, a DAC block 708b including DAC circuits 708b11 and 708b12 that convert the GI added signals to analog signals and a filter having filter circuits 708b21 and 708b22, and an orthogonal modulation block 709b that modulates orthogonally the main carrier from main carrier generating block 710b by the I-channel signal and the Q-channel signal input from the DAC block 708b.

A set of the complex pulses of the j-th output circuit of the data-mapped code pulse sequence generating means 30 are output to corresponding ordering circuit 702bj1 for I-channel and 702bj2 for Q-channel of the transmission signal generating means 70, respectively, and are multiplied by the ordering pulse sequences generated from the ordering pulse generating means 50 to generate basic pulse sequences. The ordering for the I-channel and the Q-channel of the j-th sub-channel are repeated by m j1 times that represent the degree of the multiplication of the band, then each of the basic pulse sequences are sent to the multiple addition circuit 703bj1 to generate a multiply added basic pulse sequence. A multiply added basic pulse sequences with the degree of multiple addition mj2 are generated for Q-channel, similarly. The multiply added basic pulse sequences for I-channel and for Q-channel of the j-th sub-band are sent to the signal control block 713b to be built in to form a set of complex sequences and output to IDFT 704b in parallel and synchronously. The set of chips to form a period of complex sequences are analyzed by IDFT in IDFT 704b and I-channel components and Q-channel components are generated. GIs are added to these signals by GI block 707b, then the signals are converted into analog signals by DAC block 708b. The analog signals modulate the main carrier generated by the main carrier generating block 710b in the orthogonal modulation block 709b. Then the multiply added signals generated by making use of the I-channel signal and the Q-channel signal are output.

The processes from IDFT analysis by IDFT 704b to orthogonal modulation by orthogonal modulation block 709b are done repeatedly so many times as the number of the chips per period of the ordering pulse sequence. However it is possible that the GI adding process is passed over where multi-paths affect the detection of the signal slightly. VDSL systems and ADSL systems using wired lines, systems using coaxial lines or optical fiber lines and so forth are configured to meet the requirement.

FIG. 8B shows an embodiment of the transmission signal generating means 70 that has a binary conversion block 712bb in addition to the configuration shown in FIG. 8A. It is used for modification by IDFT by making use of binary pulses converted from the amplitude of the chip of the multiply added basic pulse sequence. The means 70 comprises an ordering block 702bb, a multiple addition block 703bb, a binary conversion block 712bb, a signal control block 713bb, an IDFT block 704bb, a GI block 797bb, a DAC block 708bb, orthogonal modulation block 709bb and a main carrier generating block 710bb. The multiply added basic pulse sequences for I-channel and Q-channel of the j-th sub-band generated by multiple addition block 703bb are converted into binary pulses by binary conversion circuits 712bbj1 and 712bbj2 to form bit streams, then the output signals from the circuits are sent to signal control circuits 713bbj1 and 713bbj2, respectively. Then, the sequence signals controlled by the signal control circuits 713bbj1 and 713bbj2 forming a set of complex pulse sequences are modulated by IDFT block 704bb. The processes after GI block are the same as those of the transmission signal generating means 70 shown in FIG. 8A, and an orthogonal modulated signal is generated.

FIG. 9A shows an embodiment of the transmission signal generating means 70 for OFDM system employing parallel modulation method. The parallel modulation method divides the band into sub-bands as many as the number of the chips of the ordering pulse sequences included in a periodic time of the data-mapped code pulse sequence or its integral multiplication. On the other hands, because of high efficiency, it is preferable that the multi-level chips of the ordering pulse sequences contained in a transmission signal generating sequence comprising a basic pulse sequence or multiply added basic pulse sequences for a period be converted through an S/P conversion processing to a set of chips arranged in parallel, then, these parallel chips are allocated to the transmitting symbols of all the sub-bands for modulation. All the modulated signals are added multiply to form a transmission signal. It is also possible to allocate synchronous signal, control signal and so forth to some of the sub-bands.

For example, those sub-bands are used to transmit synchronous code pulse sequences and/or control signal in serial while forming bit streams.

On the other hands, the receiving devices detect the symbols for the chips of the sub-bands and arrange them through a P/S conversion to rebuild a period of the data signal from which data-mapped code pulse sequences are separated, then their shift times are detected from the localized pulses to calculate original data or encoded data for error correction. It is preferable that the transmitting device be configured to generate the transmission signal by making use of IDFT circuit and the receiving device be set up to detect the signal by making use of an orthogonal phase sensitive detector and to rebuild the data signal by making use of an FFT circuit and a P/S converter because of simplification of the device construction which enables a reduction of the cost.

This transmission signal generating device 70 comprises an ordering block 702c including a ordering circuits 702c1 and 702c2, a multiplying block 703c including multiplying circuits 703c1 and 703c2, a signal control block 713c including signal control circuits 713c1 and 713c2, an S/P conversion block 714c, an IDFT block 704c, a GI block 707c, a DAC block including D/A circuits 708c11 and 708c12 and a filter block

Including filters 708c21 and 708c22, an orthogonal modulation block 709c and main carrier generating block 710c.

The I-channel signal and Q-channel signal generated by data-mapped code pulse sequence generating means 30 are output to the ordering blocks 702c1 and 702c2 of the transmission signal generating means 70, respectively, then, are multiplied by ordering pulse sequences generated by the ordering pulse generating means 50, so that the ordered pulse sequences are out put to the multiplying circuits 703c1 and 703c2 of multiplying block 703c, respectively. These circuits generate multiply added basic pulse sequences having the degrees of multiplication mi1 and mi2, respectively, where mi1 and mi2 represent the degree of multiple addition of the I-channel and the Q-channel transmitted at i-th turn, respectively.

The complex multiply added basic pulse sequences are built into a sequence by signal control block 713c, then, a set of complex chips for a period T are output to S/P conversion block 714c for modification through inverse Fourier transform by IDFT 704c. GIs are added to the output signals from the IDFT block 704c in GI block 707c. These I-channel signal and Q-channel signal are converted into analog signals by DAC circuits 708c1 and 708c2, respectively, then modify a carrier generated by main carrier generating block 710c in the orthogonal modulation block 709c. The modulated signals are added multiply. The processes up to transmission signal generating are repeated until all m basic pulse sequences are transmitted sequentially.

Since the parallel method allocates the chips of the data-mapped code pulse sequences for a period to sub-bands, it is possible that the code length is selected first, then the number of the sub-bands, the band widths of the sub-bands and the degrees of multiplication of the multiply added basic pulse sequences are set up according to the code lengths.

FIG. 9B represents an embodiment of the transmission signal generating means 70 that generates binary pulses from the multiply added basic pulse sequence and generates the modulated signal for the parallel modulation method shown in FIG. 9A. The means comprises an ordering block 702cc, a multiple addition block 703cc, a binary conversion block 712cc, a signal control block 713cc, a S/P conversion block 704cc, a GI block 797cc, a DAC block 798cc, an orthogonal modulation block 709cc and main carrier generating block 710cc. The basic pulse sequences from the ordering block 702cc are added in the multiple addition block 703cc to generate multiple basic pulse sequences for I-channel and Q-channel, then those sequences are converted into binary pulses in the binary conversion block 712cc, respectively. Next, those pulses are input to signal control block 713cc in which the pulses are built in a sequence together with control signals, and so forth. The sequence, then, is converted into complex parallel pulses by S/P conversion block 714cc to output to IDFT block 704cc and are modulated by the IDFT block. The output signals from the IDFT block 704cc are orthogonally modulated to form the transmission signal through the same process as that shown in FIG. 9A.

UWB systems employing impulses are divided into impulse radio system and OFDM system. In the impulse radio system, impulses for chips of the basic pulse sequence are generated in synchronization with the transit time of each chip and are added multiply, or impulses for multiply added basic pulse sequence are generated in synchronization with transit time of each chip to generate the transmission signal. Or, it is also possible for impulse radio systems that impulses are generated in the way that the leading edges of the chips of the ordering pulse sequence are delayed by a fixed rate of the chip widths determined in accordance with the order and the impulses are generated in synchronization with the transit times of the chips of the delayed basic pulse sequence, then they are multiply added, or that the impulses are generated in synchronization with the transit times of the delayed chips of the multiply added basic pulse sequence, then the transmission signal is generated by making use of the impulses. It is said that the signal that is generated by making use of the sequence having the delayed times of 0 is the multiply added basic pulse sequence. In addition, the multiply added basic pulse sequence having the degree of multiple addition 1 represents the basic pulse sequence itself. Moreover, the data-mapped ordering basic pulse sequence is the data-mapped ordering pulse sequence.

Impulses are also generated in the way that the chips of the multiply added pulse sequence are converted into binary pulses for the transmission signal generating pulse sequence and the impulses are generated in synchronization with the transit times of the binary pulses.

On the other hands, the UWB system using OFDM method are treated in the similar way to the usual OFDM method. In the UWB system, IDFT modulation is applied to the binary pulses or the multiple level pulses for the transmission signal while FFT analysis is executed for demodulation of the detected transmission signal. Moreover, it is possible that an IDFT circuit is used for primary modulation by the pulses having short widths generated in synchronization with the binary pulses or the multiple level pulses while demodulation of the detected signal in the receiving device is executed by using an FFT circuit.

For an example, in the impulse radio system linear with respect to the amplitude of the multiply added basic pulse sequence having an incremental ordering routine and a routine to delay starting time of the chips, the device is so configured that the chips of the multiply added basic pulse sequence delay by δ time in accordance with an increment of the order and impulses in proportion to the changes of the chip amplitudes are generated at the delayed leading edges. Similarly, impulses are generated at the delayed rear edges. The number of the impulses being linear with respect to amplitudes of the chips of the multiply added basic pulse sequence and generated with intervals of δ time is determined according to the degree of the multiplication of the transmission signal generating pulse sequence and r. (Please refer to the explanation of FIG. 33A(a) and (b)). Similarly, the number of the impulses for the rear edges are determined. It is also possible that, instead of delay time, impulses are placed prior to the edges of the chips.

In the UWB system using impulse modulation, the transmission signal generating means 70 generates the UWB transmission signals based on the UWB impulses described hereinabove or primary modulated signals by the impulses. The transmission signal generating means of the UWB systems using OFDM generates the transmission signals for divided bands by modulating the sub-carriers by the impulses generated according to the transmission signal generating pulse sequences allocated to the bands, then generates transmission signals made by multiply adding those modulated signals.

The OFDM systems are divided into the parallel modulation systems and the stream modulation systems. In the parallel modulation systems, impulses for a period of the data-mapped code pulse sequence are generated in synchronization with the transmission signal generating pulse sequence to be converted into parallel, or are generated in synchronization with the parallel chips converted from those of the transmission signal generating pulse sequence, then the transmission signal is generated through a modulation of the sub-carriers by those impulses.

FIG. 10A shows an embodiment of the transmission signal generating means 70 for UWB systems using impulse radio systems employing a δ-r classification where δ and r represent delay time described earlier and the degree of the multiply added basic pulse sequences allocated to the sub-band, respectively. In the systems, the impulses are generated based on the multiply added basic pulse sequence of δ-r classification. Through this method, the large energy of the impulses are obtained, which increases the SNR of the detected signal.

This transmitting means 70 comprises ordering block 702d including ordering circuits 702d1 to 702d2, signal control block 713d and impulse generating block 712d. The impulse generating block 712d comprises δ-delay circuits 712d11 to 712d1m each of which delays the allocated basic pulse sequences as many as r out of m basic pulse sequences in the way that the r basic pulse sequences have the same delay time of δ from the previous circuit, r-multiple addition circuits 712d21 to 712d2pr each of which adds the r basic pulse sequences of the same delay time to make a multiply added basic pulse sequence having the degree of multiple addition r and impulse generating circuits 712d31 to 712d3pr each of which generates impulses in synchronization with edges of the multiply added basic pulse sequence of δ-r classification, and multiple addition block 712d4.

The output signals from shift registers from 32d1 to 32dm of the data-mapping block 32d of the data-mapped code pulse sequence generating means 30 are multiplied by ordering pulse sequences generated by the ordering pulse sequence generating means 50 to generate m basic pulse sequences which are sent to signal control block 713d. In the signal control block 713d, a sequence comprising the multiply added basic pulse sequence or sequences, control signals and so forth are generated to output to impulse generating block 712d.

In the impulse generating block 712d, the delay times of the basic pulse sequences with the order from 1 to r are set 0 through delay circuits from 712d11 to 712d1r while the delay times of the basic pulse sequences for the order from r+1 to 2*r are set δ through delay circuits from 712d1r+1 to 712d12r. In general, delay times for the pulse sequences having the order (pr−1)*r+1 to prr are set (pr'11)*δ through delay circuits from 712d1((pr−1)*r+1) to 712d1pr, where pr represents [m/r].

For simple structure and processing, it is preferable that m, r and pr be selected to have the relation: m=r*pr, where pr is an integer. It is also preferable that for orthogonal modification system, m, r, and pr are selected to maintain the relation: m=2*r*pr, and I-channel and Q-channel have pr basic pulse sequences, respectively although there are other possible ways of division.

The output signals from the delay circuits from 712d1((u−1)*r+1) to 712d1ur are input to the corresponding r-multiple addition circuits 712d2u of the r-multiple addition block 712d2 to generate a multiply added basic pulse sequence with the degree of multiple addition r (named r-multiple addition basic pulse sequence) and the same delay time (u−1)*δ from the synchronous signal. Resultantly, the output signal from the r-multiple addition circuit 712d2u is the r-multiple addition basic pulse sequence that has delay time of (u−1)*δ. Each sequence is input to one of the corresponding impulse generating circuits from 712d31 to 712d3pr to generate impulses with an amplitude, the average of which is 0, representing amounts of changes of the edges of the chips. The impulses are defined to be the isolated signals with narrow widths, more than one peaks and the amplitude the average of which is 0 and cover modulated signals modulated by pulses having short widths. These impulse sequences are input to multiplication block 712d4 to produce an impulse sequence which is input to the output means 90. It is allowed that any two adjacent impulses are partially overlapped each other. In case of separators being used to separate chips, it is preferable that one or more impulses corresponding to the leading edges and rear edges be inserted between the impulses representing the rear edges of the chips of the multiply added basic pulse sequence and impulses representing the leading edges of the chips immediately after the leading edges. It is also possible that the separator is so composed to have at least a common edge with the chip for data transmission.

FIG. 10B represents an embodiment of transmission signal generating means 70 that generates impulses at the edges of the binary pulses converted from the multiply added basic pulse sequence. The means 70 comprises an ordering block 702db and an impulse generating block 712db including a multiple addition circuit 712db2, a binary converting circuit 712db5, a signal control circuit 712db6 and an impulse generating circuit 712db3. The basic pulse sequences generated by the ordering circuits 702db1 to 702dbm are multiply added by the multiple addition circuit 712db2 to generate a multiply added basic pulse sequence which is, then, converted into binary pulses by the binary converting circuit 712db5 forming a bit stream. The binary pulses are input to signal control circuit 712db6 to be built in a sequence made of binary pulses together with control signal and so forth. The binary pulses are input to the impulse generating circuit 712db3 in which a transmission signal consisting of impulses representing the edges of the pulses.

FIG. 11A represents an embodiment of transmission signal generating means 70 of UWB systems making use of OFDM method with the modulation by the pulse stream. The means 70 comprises an ordering block 702e, a signal control block 713e to produce a sequence of the signals, a impulse generating block 712e that generates impulses for the I-channel and for the Q-channel of the sub-band, a sub-carrier generating block 715e to generate sub-carriers for I-channel and Q-channel of each sub-band, a primary modulating block 714e including modulating circuits 714e1 to 714eJ each of which generates modulated signals for I-channel and Q-channel of the band, a multiple addition block 703e that generates multiply added signals for the I-channel and the Q-channel by making use of the primary modulated signals, a GI block 707e, an ADC block 708e for analog to digital conversion, an orthogonal modulation block 709e and a main carrier generating block 710e. GI block 707e is not always necessary as far as no disturbance of the signal occurs through multiple paths, for example.

The impulse generating block 712e generates impulses for I-channel and Q-channel of each sub-band. It is preferable that, in the UWB systems making use of carriers for both the stream modification and the parallel modification, the impulses be produced through, but not limited to, a modification of the sinusoidal waveforms by isolated pulses with short widths. The circuits 712e1j to 712e4j of the impulse generating block 712e of the j-th sub-band comprise a δ-delay block 712d1, a r-multiple addition block 712d2, an impulse generating block 712d3 and a multiplication block 712d4 each of which is defined in the FIG. 10A. Various changes to any block and any circuit described hereinabove may be made without departing from the scope of the invention.

The j-th sub-channel of the impulse generating block 712e is allocated basic pulse sequences for I-channel as many as mj1 and for Q-channel as many as mj2. These sequences are built in a sequence in the signal control block 713e and the sequence is sent to the impulse generating block. The basic pulse sequences for the I-channel as many as rj1 are delayed in accordance with the order by the delay circuit of the delay sub-block 712e1j for the I-channel, then those delayed sequences are multiply added to produce a multiply added basic pulse sequence with the degree of the multiplication rj1 by the r-multiple addition circuit 712e2j. The multiply added basic pulse sequence is input to the impulse generating circuit 712e3j so that impulses are generated at a leading edge of each chip. Then the impulses are input to the impulse multiple addition circuit 712e4j by which impulses as many as pr representing the leading edges respectively are set to form a line. The impulse sequence modulates, in the primary modulating block 714ej, the sub-carrier with frequency fj generated by sub-carrier generating block 714e for I-channel to generate the primary modulated signal for I-channel.

The primary modulated signals for I-channel generated in all the sub-channels are multiply added by the multiple addition circuit 703e, then the multiply added primary modulated signal is sent to GI block 707e in which GI is added to the signal, and next, the signal is converted to analog signal by DAC block 708e. Similarly, in parallel with I-channel, an analog signal for Q-channel is generated by making use of the impulses as many as pr representing leading edges of the Q-channel basic pulse sequences. The analog signals for both I-channel and Q-channel are input to the orthogonal modulation block 709e in which they modulate the main carrier generated by main carrier generating block 710e to generate the modulated signal which is sent to output means 90. Similarly, the primary modulated signal for the rear edges are generated.

The processes described hereinabove are executed for all the chips as many as NK per period.

FIG. 11B represents an embodiment of the transmission signal generating means 70 of UWB system using OFDM for the stream modulation through IDFT instead of the primary modulating block of FIG. 11A. The means comprises an ordering block 702eb, a signal control block 713eb, an impulse generating block 712eb, an IDFT block 715eb, a multiple addition block 703eb, a GI block 707eb, a DAC block 708eb, an orthogonal modulation block 709eb and main carrier generating block 710eb. In addition, the impulse generating block 712eb includes a δ-delay sub-block 712eb1, an r-multiple addition sub-block 712eb2, a δ-pulse generating sub-block 712eb3 that generates transit pulses with the pulse widths δ in synchronization with the multiply added pulses and a δ-pulse multiple addition sub-block 712eb4 each circuit of which adds multiply the output signals from the corresponding circuits of the δ-pulse generating sub-block 712eb3. The ordering block 702eb, the δ-delay sub-block 712eb1 and r-multiple addition sub-block 712eb2 are configured in the same way as 702e, 712e1 and 712e2, respectively.

Each output signal from the ordering block 702eb is built into a sequence together with control signals and so forth by the signal control block 713eb, then the sequence signal is sent to the impulse generating block 712eb. Each output signal from the circuit of the ordering block 702eb is set respectively in a sequence by the corresponding circuit of the signal control block 713eb and sent to the corresponding circuit of the sub-block of the impulse generating block 712eb. The signal input is delayed by the circuit 712eb1j of the δ-delay block 712eb1 in the same way as 712e1j where j represents j-th sub-band. Then the all the delayed signals are added multiply by the r-multiple addition circuit 712eb2j to generate multiply added basic pulse sequences for I-channel and Q-channel each of which has the degree of multiplication r in the same way as 712e2j, then those sequences are sent to the δ-pulse generating circuits 712eb3j, respectively. The δ-pulse generating circuit 712eb3j generates transit pulses as many as pr at each leading edge having pulse widths of δ and the amplitudes representing the change of the chip from the previous one. In parallel with I-channel, the transit pulses of the leading edge as many as pr for Q-channel are generated similarly. The transit pulses for the I-channel and the Q-channel having the same delay time form a complex set. The sets of the complex pulses among all sub-channels are synchronizing and sent to the IDFT block 715eb to be modulated through an inverse Fourier transform. Then the output signals from the IDFT block 715eb are sent to the multiple addition block 703eb where those signals are added multiply in accordance with channel. Thus generated multiple signals are sent to the GI block 707eb in which GI s are added. The orthogonal modulation is executed for the signals processed in the same way as FIG. 11A.

The processes between the generation of the transit pulses at the leading edges by the impulse generating block 712eb and generation of the orthogonally modulated signals for the sets of complex transit pulses generated at the leading edges of the chips of the r-multiple basic pulse sequences by the orthogonal modulation block 709eb are conducted synchronously among all the sub-bands to transmit the information on the pr leading edges of the corresponding chips of the sub-bands. Then, the information on the rear edges of the corresponding chips are sent in the same way. The process for transmitting the edge information is repeatedly done for all the chips as many as NK included in a period of the basic pulse sequences.

It may be done that the parallel modulation is employed instead of the stream modulation for UWB system using OFDM. FIG. 11C shows an embodiment of the transmission signal generating means 70 for UWB systems using OFDM method employing parallel modulation. The means comprises an ordering block 702ec, a signal control block 713ec, an impulse generating block 712ec, an IDFT block 715ec, a multiple addition block 703ec, a GI block 707ec, a DAC block 708ec, an orthogonal modulation block 709ec and a main carrier generating block 710ec.

The basic pulse sequences for I-channel and Q-channel made through the ordering block of the transmission signal generating means 70 are input to the corresponding circuits of the signal control block 713ec to be built into a sequence which is sent to the impulse generating block 712ec which includes δ-delay circuits 712ec1 for I-channel and for Q-channel, r-multiple addition circuits 712ec2 and δ-pulse circuits 712ec3. The δ-delay circuits for I-channel contained in the δ-delay circuits 712ec11 to 712ec1m delay each r basic pulse sequences grouped by a δ interval. The r-multiple addition circuits 712ec2 add the delayed sequences multiply to form multiply added basic pulse sequences with the degree of multiplication r. The pr chips of the r-multiple basic pulse sequence are sent to the corresponding circuits of the δ-pulse circuit 712ec3 in parallel, then are converted into transit pulses having pulse widths of δ and the amplitude representing the changes of the chips. The transit pulses are latched by the output circuits for the period of IDFT conversion. Similarly, pr transit pulses of the leading edges for Q-channel are generated in parallel with I-channel execution. These 2pr transit pulses form pr sets of complex transit pulses which are input to IDFT block 715ec in parallel to produce primary modulated signals. Then, these primary modulated signals are sent to the multiple addition block 703ec in parallel to produce multiply added modulated signals for I-channel and for Q-channel. Next, the modulated signals are sent to the GI block 707ec to obtain GIs. The GI added signals are converted into analogue signals by the DAC block 708ec, then are sent to the orthogonal modulation block 709ec in which they modulate the main carrier generated by the main carrier generating block 710ec orthogonally to produce the transmission signal. Subsequently, the transmission signal for the rear edges are generated through the similar process.

The processes described hereinabove are executed repeatedly until all the data on the chips contained in a period of the multiply added basic pulse sequence are transmitted. Thus, in the parallel method, the pr transit pulses of the leading edges corresponding to each chip of the multiply added basic pulse sequence are allocated to sub-bands and are sent in parallel in synchronization with the clock pulse, and similarly, the transit pulses for the rear edges are sent by the next clock. Thus the information on NK chips for the period is transmitted. Consequently, it is possible that the transmission rate is controlled by one of or some of, but not limited to, the code length of the code pulse sequence, the number of sub-bands, the sub-band width, the transmitting clock frequency and the degree of the multiplication of the allocated basic pulse sequences. By the way, the GI block is not always necessary for the transmission through paths having no serious distortion.

It is possible that both narrow band transmission systems and UWB systems using the OFDM method are so composed that the measurement of the characteristics of the transmission paths is executed via pilot channels. As is well known to those skilled in the art, it is possible that an estimation of the characteristics of the adjacent channels for the systems having scattered pilot channels (SP channels) is conducted in the way that the frequency characteristics of the channels in question are estimated through an interpolation between that of the pilot channel measured and the channel in question in order to achieve its frequency response equalization.

For the frequency hopping systems, the receiving devices rebuild the transmission signal generating pulse sequences from the detected signals in order that the data-mapped code pulse sequences are detected in the same way as non-hopping carrier systems and are localized to calculate the data from the shift times of their localized pulses. It is possible that the systems are so configured that the hopping carriers are modulated directly by the impulses. The same processes for transmission and reception are applicable to these systems as well.

FIG. 12(a) represents an embodiment of transmission signal generating means 70 of the code type transmitting device 1 employing the frequency hopping method. The transmission signal generating means 70 comprises an ordering block 702L, a multiple addition block 703L, a binary conversion block 712L, a signal control block 716L, a primary modulating block 714L and a synthesizer block 715L. Moreover, the synthesizer 715L includes a hopping code generating circuit 715L1, a synthesizer 715L2 and a band pass filter BPF 715L3.

The output signals of the data-mapped code pulse sequence generating means 30 are ordered by the ordering pulse sequences generated in the ordering block 702L of the ordering pulse sequence generating means 50, then the ordered sequences are multiply added to generate multiply added basic pulse sequences by the multiple addition block 703L. The multiply added basic pulse sequences are converted to binary pulses by the binary conversion block 712L forming a bit stream, then the stream is input to the signal control block 716L in which the binary pulses are built into a sequence together with control signals and so forth. The hopping carriers are synthesized by the synthesizer block 715L2 and have frequencies that hop randomly in accordance with hopping patterns with hopping period of T generated by the hopping pattern generating circuit 715L1 and in synchronization with a change of the chips.

FIG. 12(b) expresses an embodiment of a primary modulating block 714L consisting of delayed APSK circuit for the input signals made of multiply added basic pulse sequences. The multiplying circuit 7145L in it multiplies the multiply added basic pulse sequences by the delayed pulses from a delay circuit 714L2 having delay time of T that represents the hopping interval. The input signal of the delay circuit 714L2 is the zero cross signal representing the polarity of the chip derived from the output signal from the product signal through a polarity detection circuit 714L1. The product signals are modulated using PSK by the primary modulating circuit 714L3, then filtered by 714L4 to form the primary modulated signals. Then, the signals are sent to the corresponding receiving devices by which data are obtained.

In FIG. 12(a), it is possible that, instead of use of the binary conversion block 712L, multiply added basic pulse sequences are used to be built into a sequence, and then the primary modulated signal is generated for transmission. In this case, the multiplying circuit 714L5 in (b) is made by making use of a linear multiplying circuit and the primary modulation circuit 714L3 employs APSK method.

FIG. 13 expresses an embodiment of code type receiving device 200 that receives transmission signals sent from the code type transmitting device 1. The code type receiving device 200 comprises a detecting means 210, a synchronizing means 220, a communication means 230, a localizable signal detecting means 240, a localized pulse detecting means 250, a data calculating means 260, an output means 270 and a control means 280. The localizable signal is defined as a signal that generates at least one localized impulse when localized.

It is obvious to those skilled in the art that various changes, reconstruction, deletion and addition may be made without departing from the scope of the invention. In addition, all or a part of hardware may be replaced with equivalent software, and vice versa.

The code type receiving device 200 to communicate with the code type transmitting device 1 that transmits signals using encoded data for error correction is so configured to have a block for decoding or to have a part of a block or blocks that are used for decoding together with other blocks.

The data-mapped code pulse sequences generated by making use of the encoded data for error correction are sent to the receiving devices by which the sequences are localized in order that the shift times are detected from the localized pulses in reference to the synchronous signal. Data are calculated from the shift times, then those data are decoded to obtain original data.

It is possible that the localized pulses of the data-mapped ordering code pulse sequences generated by making use of the data or encoded data for error correction are detected in the way that those sequences are stored in the ring memory made of CCDs, for example, then those data are read to be localized by a matched filter made of CCDs or by a correlation circuit. It is possible that the modulated signals modulated by data-mapped code pulse sequences are localized by SAW filter instead of the CCD matched filter. It is also possible that the detected signals are converted into digital data first and stored in a ring memory, and those digital data are localized through digital processing.

The basic pulse sequences that have data-mapped ordering pulse sequences using encoded data for error correction are decoded first, then present data-mapped code pulse sequence is separated through a digital filter, for example. Next, the sequence is localized for detection of localized pulses from which data are calculated.

On the other hands, the transmission signals generated by the data signals using product basic pulse sequences are detected by the receiving device to stored in a ring memory, then data-mapped code pulse sequences are separated through a multiplication by ordering pulses synchronously and the product signals are filtered. The output signals from the filter are localized one by one by CCD matched filter or by a correlation circuit. If signals contain data which are encoded for error correction in relation with the chip set, first they are decoded to reconstruct the multiply added basic pulse sequence from which localized pulses are detected. For the sequence, the chip width and the chip number are defined as those of the ordering pulse sequence. Therefore, the ordering pulse sequences used for the receiving devices are generated by making use of the local oscillator the frequency of which is so controlled that a synchronization is maintained. In stead of analog processing described hereinabove, it is possible that the detected signal is converted to digital data to store in the ring memory, then the decoded digital data signals are multiplied by the ordering pulses digitally to be filtered for a separation of the data-mapped code pulse sequences, and next the separated data-mapped code pulse sequences are localized to detect localized pulses.

The detecting means 210 comprises a detector having at least a sensor for, but not limited to, electromagnetic waveform, light ranging from infrared to ultraviolet, controllable radiation such as X-ray, magnetism and ultrasonic waves. Information on data and synchronous timing are obtained via those energy media. The detecting means 210 detects the signal and converts its frequency.

The detected signal from the detecting means 210 are input to the synchronizing means 220 and is used for acquisition and tracking as well as identification. Simultaneously, the detected signal is input to the localizable signal detecting means 240 to detect the data-mapped code pulse sequences synchronously in accordance with the ordering sequence. If the signal has control pulses, the data-mapped code pulse sequences keep the pulses as well. It is preferable that the product basic pulse sequence be so configured that the chip rate of its ordering sequence is to be K times as fast as that of data-mapped code pulse sequence in order that interference from other basic pulse sequences are reduced in the despreading process to achieve an improvement of the SNR for despread signal by K times.

It is preferable that the localizable signal detecting means 240 have a canceller to reduce an interference from other basic pulse sequences in the process for detecting the data-mapped code pulse sequences. The cancellers for this purpose are, but not limited to, a cross-correlation canceller and a replica-type canceller using localized pulses as well as replicas of the basic pulse sequences and/or data-mapped code pulse sequences. It is also preferable that the cancellers be so composed that external interference from other devices as well as internal interference are reduced.

The detected data-mapped code pulse sequences are localized by localized pulse detecting means 250. The localized pulse detected from the basic pulse sequence having a control pulse has the polarity determined by the control pulse.

It is preferable that, for transmission signals making use of code pulse sequences and for those using modulated signals by those pulses, a whole period of sequences of the data signals and synchronous signals are used in the steps of separation of the code pulse sequences and localization of the code pulse sequences in order to obtain data information as well as synchronous information.

In case of the transmission signal being generated by making use of the transmission signal generating pulse sequence for data information, the localization is executed against the data-mapped code pulse sequence to detect its localized pulses. In the present invention, the transmission signal generating pulse sequence consists of a basic pulse sequence or a multiply added basic pulse sequence.

In addition, the data-mapped ordering basic pulse sequence or the multiply added data-mapped ordering basic pulse sequence are localized by making use of matched filter for the kind of the code sequence or correlation circuit.

On the other hands, analogue multiple level signals are localized by making use of matched filters made of CCD for example, or those signals are converted into digital data first, then are processed for localization by making use of hardware or software. On the other hands, demodulated signals demodulated by digital data signals are localized directly, after their frequencies having been converted, or in case of transmission signals containing primary modulated signals after the primary modulated signals having been detected through SAW matched filters, or after demodulated through CCD matched filters or through digital processing for digital signals, or the signals are converted into digital signals first, then are localized through digital processing, for example.

The data calculating means 260 detects shift times from the localized pulses and data are calculated. In case of the encoded data for error correction, the means 260 decode the data to obtain the original data. The output means 270 sends the data to, but not limited to, display devices, computers, data bases and so forth.

The communication means 230 are used to communicate with the communication means 100 of the code type transmitting device 1 for a transmission of control signals and so forth via sub-channel or sub-channels. It is possible that the communication means 230 is so configured that it communicates with the transmitting device 1 via the same channel or channels as those for data signals and/or synchronous signals on a time division basis. Those control signals are, but not limited to, output control signals sent from the receiving device to the transmitting device, request signals for retransmission, start/stop control signals and so forth. In wireless communication systems via electromagnetic waveform, the sensors used in the communication means 230 are made of antenna. It is possible that those antenna are so configured that they are commonly used for transmission and reception and/or that the antenna of the detection means 230 and the antenna of communication means 230 are used commonly. Such configurations are applicable to RF IC tags, for example.

Each of figures from FIG. 14A to FIG. 14E shows an embodiment of detection means 210, synchronizing means 220 and communication means 230.

The means shown in FIG. 14A are a detecting means 210, synchronizing means 220 and communication means of the code type receiving device communicable with the code type transmitting device 1 that has the data-mapped code pulse sequence generating means 30 in FIG. 3. The detecting means 210 comprises a sensor block 211s, a filter 213s and a frequency conversion block 213s. A sensor for the sensor block 211s of the electromagnetic wireless system is made of antenna which can be commonly used by the communication block and the output block of the communication means 230s. The sensor blocks for both wired and wireless optical communication systems comprise photo sensors such as photo diodes while metallic wired transmission systems employ buffer amplifiers, for example.

The signal detected by detecting block 211s is input to frequency converting block 212s through filter 213s to be converted into the primary modulated signal. Simultaneously, the detected signal is input to synchronizing block 220s and the synchronous information for an acquisition and tracking is obtained. The frequency of the frequency control block 212s is controlled in accordance with this synchronous information.

On the other hands, the communication means 230 comprises a detection/output block 230s, a circulator 233s, a filter 235s1, demodulating block 236s and a modulating block 237s. The control signal from the transmitting side detected by the detection/output block 230s is isolated by the circulator 233s and sent to filter 235s1, then demodulated by demodulator 237s and then output to control block 280. On the other hands, the control signal generated by the transmitting side is modulated by the modulating block 237s, then is sent to the circulator 233s through the filter 235s2. By the circulator 233s, the signal is sent via antenna of the detection/output block 230s to the receiving side. By the way, the circulator is not used for the device in which the detection circuit and the output circuit are isolated each other.

In case of antenna are used for detection of the signal in the devices shown in the figures from FIG. 14A to FIG. 14D and FIG. 14E(a) and (b), those antenna are so configured that they are commonly used by the detection/output blocks of the communication means 230.

The code type receiving device 200 comprising the detecting means 210 shown in FIG. 14B covers the receiving device 200 that employs OFDM method and the receiving device 200 equipped with a synchronizing means that detect timing information digitally and a localizable signal detecting means 240, which makes use of block demodulation, that has a cross-correlation canceller 247c to reduce an internal interference for a reception of orthogonally modulated signals.

In FIG. 14B, the detecting means 210 comprises a detecting block 211a to detect the transmitted signals made of orthogonally modulated signals generated in the way that two orthogonal carriers of the same frequency are modulated by the input signals respectively, a frequency converting block 212a having a frequency converting circuit 212a1 for I-channel and 212a2 for Q-channel to convert frequencies of the input signals and a filter block 213a having a filter 213a1 for I-channel and filter 213a2 for Q-channel. In the device, the transmission signals sent are detected by detecting block 211a and are sent to the frequency converting block 212a in which the I-component and the Q-component of the primary modulated signals are detected.

In the code type receiving device 200 employing the block demodulation processing, the input signals from the filter 213a are converted into digital data by an A/D converter of the localizable signal detecting means 240 and the data are calculated digitally through a reduction of noise. This detecting means 210 is also applicable to the code type receiving device 200 for an analog processing.

The detecting means 210 shown in 14B expresses an embodiment of detecting means 210 of the code type receiving device 200 communicable the code type transmitting device having transmission signal generating means 70 shown in FIG. 7A, FIG. 7B, FIG. 8A, FIG. 8B, FIG. 9A, FIG. 9B, FIG. 11A or FIG. 11C.

FIG. 14C expresses an embodiment of the detecting means 210 of the code type receiving device 200 communicable with code type transmitting device 1 for multiple band UWB transmission system the number of the bands of which is w using OFDM method. In each band, transmission signals generated by the transmission signal generating means 70 shown in FIG. 11A, FIG. 11B or FIG. 11C are detected.

This detecting means 210 comprises a detecting block 211I, a filter containing filter circuits from 213i1 to 213iw and frequency converting block 212I containing frequency converting circuits from 212i11 to 212 iw for I-channel and from 212i12 to 212iw2 for Q-channel. These frequency converting circuits are configured similarly to those in FIG. 14B.

The output signal from the detecting block 211i is filtered by the filter 213iu to generate the signal of the u-th. Then, the output signal from the filter 213iu is input to the frequency converting circuit 212iu1 through which the primary modulated impulse sequence is generated. Similarly, the primary modulated impulse sequences for Q-channel are detected. Especially, if the w is 1, the detecting means 210 in the FIG. 14C becomes the detecting means to detect the orthogonal modulated signals produced by the transmission signal generating means 70 of the UWB systems shown in FIG. 11A, FIG. 11B or FIG. 11C. It is preferable for simple structure and processing of the follow on means that the frequency converting circuits are so configured that all the detected signals have a unified intermediate frequencies.

FIG. 14D expresses an embodiment of the detecting means 210 of the UWB system using the impulse radio method. It is possible that this means 210 may be used for, but not limited to, the detecting means of the piconet system defined in IEEE802.15.3a. Furthermore, it will be obvious to those skilled in the art that various changes may be made without departing from the scope of the invention. In the piconet, timing is carried via beacon to be detected by the synchronizing means 220.

The detecting means 210 comprises antenna 211g, a filter 213g and an amplifier 215g, and the antenna 211g can be so configured to be commonly used by the antenna 230g of the communication means 230. The impulses having frequency component covering the ultra wide band are filtered by the filter 213g reducing external noise, then input to an amplifier circuit 215g to be amplified.

FIG. 14E(a) represents an embodiment of the detecting means 210 of the code type receiving device 200 for frequency hopping systems communicable with code type transmitting device 1 having the transmission signal generating means 70 shown in FIG. 12. This means 210 comprises a detecting block 211L, a delayed detecting block 214L containing circuits of delay detection circuit from 214L1 to 214LJ and a hopping multiplexer 215L that hops in accordance with a predetermined hopping sequence by PRC having N chips and the period of the time T. This detecting means 211L detects hopping chips that make the carrier to hop and conducts delay detection by one of the delay detection circuits from 214L1 to 214LJ. The output signal from the delay detection circuit is held for T in accordance with the hopping sequence, then is converted to serial pulses by HP multiplexer 215L to be sent to the localizable signal detecting means 240.

It is possible to directly convert the output signals from the delay detection circuits from 214L1 to 214LJ to digital pulses by controlling the multiplexing sequence of the multiplexer of the A/D converter of the localizable signal detecting means 240 in accordance with the hopping sequence.

FIG. 14E (b) shows an embodiment of the j-th delay detection circuit 214Lj of the detecting means 210. The signal detected by the corresponding circuit of the detecting block 211L is sent to both multiplying circuit 214Lj3 and polarity detecting circuit 214Lj2 that detects its polarity. The detected polarity signal is delayed by T, the hopping period, via T-delay circuit 214Lj1. Then the delayed signal is sent to multiplying circuit 214Lj3 where it is multiplied by the detected signal. The product signal is filtered by filter 214Lj4 to detect binary pulses converted from the chips of the multiply added basic pulse sequences. For the primary modulated signal made of orthogonally modulated signal, since the detected chips contain both I-component chip and Q-component chip, the transmission signal is so composed that ordering sequences of the multiply added basic pulse sequences for I-channel are different from those of Q-channel.

FIG. 14E(c) represents an embodiment of detecting means 210 for frequency hopping system making use of synchronous detection. The transmission signal detected by detecting block 211m is sent to both synchronizing means 220 in which acquisition or/and tracking are executed and synthesizer block 217m. The synthesizer block 217m comprises a hopping pattern generating circuit 217m1 to generate a hopping sequence, a synthesizer circuit 217m2 to synthesize carriers the frequencies of which are determined by the hopping pattern, a multiplying circuit 217m3 to make a product of the output signal from the detecting block and the carrier, and a filter 217m4 to filter the output signal from the multiplying circuit 217m3, then the output signal from the filter 217m4 is detected by detecting block 219m.

The synchronizing means 220 detects the synchronous signal from the output signal from the detection block to execute acquisition or/and tracking. It is possible that the synchronous signal is sent in advance of the data signal on a time division basis. In this case, a synchronization is acquired and maintained through controlling the frequency of the local oscillator for clock generation by making use of the synchronous signal having a constant period. It is also possible to control the local oscillator for clock generation by making use of the synchronous signal sent in parallel with the data signals or in parallel with and prior to the data signal. The acquisition and the tracking by synchronizing means 220 are executed by detecting the synchronous signal composed of a timing pulse sequence, a code pulse sequence, or a multiply added product pulse sequence containing two or more sequences having synchronous information. In UWB transmitting system, it is possible to transmit timing impulses for an acquisition and a tracking in parallel with or/and in series with impulses of data signal. Especially for the UWB system using OFDM method, a common timing impulses among all sub bands are sent in series with the data signal or in parallel with data signals of other sub bands by making use of fixed channel(s), or pilot channel(s).

On the other hands, for the code type transmitting device 1 that detects and demodulates the received signal digitally by making use of a cross-correlation circuit, it is possible that an acquisition and a tracking are executed by making use of the synchronous signal contained in a preamble, placed in parallel with data signals or data signal or signals.

Localizable signal detecting means 240 separates the data mapped code pulse sequences, a localizable signal, from the detected signal. For the detected signal comprising multiply added basic pulse sequences that are products pulse sequences made of ordering pulse sequences multiplied by data mapped code pulse sequences, the localizable signal detecting means 240 repeatedly separates data mapped code pulse sequences by multiplying the detected signal and the ordering pulse sequence as many times as m, the degree of multiple addition, per period of the data mapped code pulse sequence.

In order to improve the SNR of the separated signal, it is preferable that the localizable signal detecting means 240 have an interference cancellar to eliminate an internal interference caused by other basic pulse sequences. Moreover, the cancellar is to be so composed that, in order to achieve necessary level of SNR, it eliminates an internal as well as an external interference from other devices in use for multiple access.

For the localizable signal including the data mapped code pulse sequence separated due to multiplication of multiply added basic pulse sequences by an ordering sequence has a narrow band spectrum, the SNR improvement ratio by despreading is K, where K, the spreading ratio, represents Tk/Tc.

For the transmission signal with high hopping rate, it is possible that the localizable signal detecting means 240 separates the data mapped code pulse sequence directly from the detected signal or by making use of the averaged signal that is made in the way that the detected signal is averaged Tk/Tc times to detect averaged chips for a period of the data mapped code pulse sequence. Then the localizable signal is sent to localized pulse detecting means 250 in which the signal is localized through which SNR is improved in proportion to the code length of the data mapped code pulse sequence.

FIG. 15 represents an embodiment of the localizable signal detecting means 240 for orthogonal modulation system. The means 240 comprises a demodulating block 245a including demodulating circuits 245a1 and 245a2, an ADC block including A/D converting circuits 241a1 and 241a2, a ring memory 242a, a separating block 243a and a cancellar block 247a. The separating block 243a includes an ordering pulse sequence generating circuit 243a1, multiplying circuits 243a2 and 243a3 and filters 243a4 and 243a5. The cancellar block 247a includes a cancellar circuit 247a1, a replica generating circuit 247a2 and memory 247a3.

The primary modulated signals for I-channel and Q-channel detected by the detecting means 210 are input to a demodulating circuit 245a1 and 245a2 respectively to be demodulated, then those signals are converted into digital signals by 241a1 and 241a2, respectively and stored in the corresponding ring memories 242a1 and 242a2.

The I-channel data read from the ring memory 242a1 is sent to a multiply added basic pulse sequence regenerating circuit (M.A.B.P.S.R.C.) 243a6 in which the multiply added basic pulse sequences are regenerated. The regenerated sequences are multiplied by an ordering sequence with zero shift time generated by the ordering pulse sequence generating circuit 243a1 in a multiplying circuit 243a3, then filtered by filter 243a4 to detect the first data mapped code pulse sequence, a localizable pulse sequence. This sequence is sent to the localized pulse sequence detecting means 250 to be localized, then stored in a memory. Next, the ring memory 242a1 is so shift that the second basic pulse sequence is set to be in the standard state. By making use of this standardized data, the second data mapped code pulse sequence is detected and localized in the same way as the first data mapped code pulse sequence.

Similarly, data mapped code pulse sequences up to [m/2]-th are detected, where [m/2] represents Gaussian blanket which represents the maximum integer not exceeds m/2.

By the way, it is preferable that m be set to be even number. The data mapped code pulse sequence for Q-channel is detected and localized similarly.

Instead of the ring memory 242a, it is possible to use a memory 242a′ to store A/D data. In this device, the multiply added basic pulse sequence is regenerated by the multiply added basic pulse sequence generating block 243a6. The multiply added basic pulse sequence read from the memory 242a′ is multiplied by the ordering pulse sequence generated due to the multiply added basic pulse sequence generating circuit 243a1 which is so configured that the order increases by one per detection of the sequence in ascending order, then filtered by the filter 243a4 to detect the first localizable data mapped code pulse sequence and localizes it for detection of the localized pulse which is stored in the memory 247a3. Next, the state of the ordering pulse sequence generating circuit 243a1 is renewed by one increment for detection of the second data mapped code pulse sequence. It is possible that the device is so configured that the data mapped code pulse sequences for I-channel up to [m/2] are detected in the similar way. Q-channel is configured similarly. It will be obvious to those skilled in the art that the shift register may be changed to have decrement configuration.

A replica generating circuit 247a2 of the cancellar block 247a replicates the basic pulse sequences of all the orders for the I-channel and the Q-channel by making use of stored data of the localized pulses with which an interference noise is synthesized. The synthesized interference noise together with stored data in the ring memory 242a1 are used to calculate the basic pulse sequences of all orders by eliminating interference noise and those sequences are stored the ring memory 247a3 again and reused by the separating block 243a to separate the data mapped code pulse sequences which are localized by localizable signal detecting means 250.

It is possible that the devices or systems are so configured that the steps to separate the data mapped code pulse sequence, the step to detect a localized pulse and the step to cancel interference noise are to be repeated. It is also possible that, instead of the cancellar block 247a, the localized pulse detecting means 250 is so configured that it has a cancellar block, and the multiply added basic pulse sequences are regenerated by making use of the stored data of the ring memory 242a1 for I-channel and 242a2 for Q-channel, the data mapped code pulse sequences for both channels are separated respectively by making use of the regenerated sequences via separating block 243a, and then localized pulse is generated by localized pulse detecting means 250 and sent to the data calculating means 260 in order that a cancellation of noise including an interference noise is done against the signal including a localized pulse detected by the localized pulse detecting means 250. It is preferable that, for use in multiple access, the cancellar block be so configured that it cancels an internal interference due to other basic pulse sequences as well as an external interference from other devices. In addition, the cancellar block can be made by making use of a cross correlation cancellar circuit or any other cancellar circuit as far as it cancels interference.

The step to separate a data mapped code pulse sequence by separating block 243a, the localized pulse detecting step by the localized pulse detecting means 250 and the cancellation step of an interference noise by the cancellar 247a can be repeatedly done.

The localized pulse detecting means 250 detect execute a step to cancel an interference noise first, then detects the localized pulse from each basic pulse sequence of the multiply added basic pulse sequence and the results of a judgement for detection are sent to the data calculating means 260.

FIG. 16 shows an embodiment of the code type receiving device 200 that is communicable with code type transmitting device 1 using OFDM method comprising the data mapped code pulse sequence generating means 30 shown in FIG. 5 and the transmission signal generating means 70 shown in FIG. 8A, or the device 1 using OFDM method for binary pulses comprising the data mapped code pulse sequence generating means 30 shown in FIG. 5 and the transmission signal generating means 70 shown in FIG. 8B. This code type receiving device 200 comprise a detecting means 210, a synchronizing means 220, a localizable signal detecting means 240, a localized pulse detecting means 250 and a control means 280.

The localizable signal detecting means 240 comprises an ADC block 241b that converts the input signal into digital pulses according to the channels, a memory 242b0, a FFT block 248b, ring memory blocks 242b1 to 242bJ, separating blocks 243b1 to 243bJ and cancellar blocks 247b1 to 247bJ. In addition, FFT block 248b comprises a GI removing circuit 248b1, an FFT circuit 248b2 and an equalizer 248b3.

Each of the ring memory blocks 242b1 to 242bJ is made by making use of the ring memory 242a respectively, each of the separating blocks is made by making use of the separating block 243a and each cancellar block is made by making use of the cancellar 247a.

The synchronizing means 220 can execute an acquisition and a tracking for a synchronization by making use of the output signal from the detecting means 210. Or, it is also possible that an acquisition is done by making use of the output signal from the detecting means 210 and the tracking is done on a sub-band basis in the way that the timing information is detected by making use of the synchronous data stored in the ring memory 242bj for j-th sub-band and the timing is used for a tracking for the j-th sub-band of the localizable signal detecting means 240. Or, if the stored data is stable in terms of frequency of the carrier or carriers and sampling clock, in stead of the tracking done on a sub-band basis, it is possible that the tracking is executed by making use of the synchronous signal or a data signal transmitted by a specific sub-band and the synchronization of all other sub-channels is maintained by making use of the synchronous information. Or, it is also possible that, instead of the acquisition by using the output signal from the detecting means 210, the device is so configured that the acquisition and the tracking for the j-th sub-band are conducted on a sub-band basis by making use of the synchronous data stored in the ring memory block 242bj, or that each sub-band is used periodically as a pilot channel to which a synchronous signal is allocated and the acquisition and the tracking for the sub-channel itself or/and all other sub-channels are done by making use of the synchronous signal.

The detected signal from the detecting means 210 is converted into digital pulses by ADC block 241b according to the channels and stored in the memory 242b0. The stored data are read and sent to the FFT block 248b in which the GIs are removed by GI remover 248b1, then its output signal is demodulated by FFT circuit 248b2 to detect multi-level chips of the multiply added basic pulse sequences assigned to the sub channels through fast Fourier transform (FFT) by FFT circuit 248b2. The detected chips are equalized by equalizing circuit 248b3 then stored in the corresponding ring memories from 242b1 to 242bJ. It is preferable that, since the multi-level chip data detected be equalized by measuring the characteristics of the transmission line, FFT output data are corrected by making use of pilot channels, for example. In the processing above, judgement is preferably done against localized pulses. Regarding the equalization, please refer to non-patent literature 6 from 146 to 158 page. In addition, it is possible that the ring memory blocks from 242b1 to 242bJ are replaced by memories and the ordering pulse sequence generating circuits of the separating blocks from 243b1 to 243bJ are so configured that they generate pulse sequences having shift times determined by the ordering sequence.

These steps are repeatedly done KN times to detect the allocated multiply added basic pulse sequences to sub-bands, where KN represents the number of the chips of the ordering sequence contained for a period of the data mapped code pulse sequence. Please refer to the FFT output waveform shown in FIG. 31(b) to see the number of the chips.

The complex data of the j-th sub-band are stored in the ring memory 242bj and processed by the separating block 243bj, the localized pulse detecting block 250bj of the localized pulse detecting means 250 and the cancellar block 247bj for a removal of the interference noise. The localized pulse detecting means 250 judge the localized pulses detected from the data mapped code pulse sequence of each basic pulse sequence contained in a multiply added basic pulse sequences in the sub-band and output the results to the data calculating means 260.

The data of the I-channel stored in the j-th ring memory 242bj for a period are read and sent to the separating block 243bj for I-channel in which the data mapped code pulse sequences of the channel are separated. Then, the data mapped code pulse sequences are sent to the corresponding localized pulse detecting blocks of the localized pulse detecting means 250 by which the localized pulses are detected. Next, the localized pulses are sent to the corresponding circuits of the cancellar 247bjs in which canceling signals are replicated. These replicas are subtracted from the stored data of the ring memory to detect the I-channel data the interference noise of which is removed.

The separating block 243bj and the cancellar block 247bj are made similarly to the separating block 243a and the cancellar block 247a of the FIG. 15 to have the same functions, respectively.

The Q-channel is configured similarly to I-channel and an interference noise is removed from the stored data in the ring memory 242bj. It is also possible that the device is so configured that the interference noise is removed from the output signal from the localized pulse detecting means 250.

FIG. 17 shows an embodiment of the code type receiving device 200 comprising a detecting means 210, a synchronizing means 220, a localizable signal detecting means 240, a localized pulse detecting means 250 and a control means 280. This device 200 is used to communicate with code type transmitting device 1 that uses the OFDM method for parallel modulation and that comprises a data mapped code pulse sequence generating means 30 shown in FIG. 5 and a transmission signal generating means 70 shown in FIG. 9A. This configuration of the device 200 also enables communication with code type transmitting device 1 that uses OFDM method for parallel modulation by the binary pulses converted from the multiply added basic pulse sequence and that comprises a data mapped code pulse sequence generating means 30 shown in FIG. 5 and a transmission signal generating means 70 shown in FIG. 9B.

The localizable signal detecting means 240 comprises an ADC block 241c, a memory 242c1, a FFT block 248c, a ring memory 242c2, a separating block 243c and a cancellar block. Moreover, the FFT block 248c comprises a GI remover circuit 248c1, a FFT circuit 248c2, an equalizing circuit 248c4 and a P/S converter circuit 248c3. In addition, the separator block 243c is configured similarly to 243a and the cancellar block 247c is configured similarly to 247a.

The synchronizing means 220 does the acquisition and the tracking through, but not limited to, a detection of the periodically inserted synchronous pilot signals among the data signals in the scattered pilot channels. It is possible that detection of the synchronous signals is conducted in the way that it is done directly from the output signals by detecting means 210 in anticipation of the detection of the localizable signals by the localizable signal detecting means 240, is done in the process by the localizable signal detecting means 240, or the acquisition is done in anticipation of the process by the localizable signal detecting means 240 and the tracking is conducted in the process.

The synchronized signal for a period of the data mapped code pulse sequence is detected and converted into digital pulses to be stored in the memory 242c1. The data stored in the memory 242c1 are read and the GIs are removed by the GI removal circuit 248c1 of the FFT block 248c, then, the signal is analyzed through a fast Fourier transform process by FFT circuit 248c2 in order to detect multi-level chips of the multiply added basic pulse sequences for a period of the data mapped code pulse sequences. The analyzed chips are equalized by the equalizing circuit 248c4, then converted into serial pulses by the P/S converting circuit 248c3, and next those pulses are stored in the ring memory 242c according to the channels.

The I-channel data and the Q-channel data stored in the ring memory 242c2 are input to the separating block 243c in which data mapped code pulse sequences are separated, respectively and sent to the localized pulse detecting means 250. The cancellar block 247c regenerates interference noise through synthesizing all the basic pulse sequences by making use of the localized pulses sent from the localized pulse detecting means 250. Then, the replicated interference noise are subtracted from the stored data in the ring memory 242c2 and sent to the separating block 243c in which the first localizable signal is separated from the signal replicated interference noise is subtracted for I-channel.

The steps from a read of the stored data through a separation of the localizable signals can be repeated as many as necessary times.

Next, the ring memory 242c1 is so rotated in ascending order that the second data come to the standard position, then the second data mapped code pulse sequence of the I-channel is detected in the similar way. Similarly, data mapped code pulse sequences up to mi/2-th order for I-channel are detected. Data mapped code pulse sequences for Q-channel are detected in the same way. It will be obvious to those skilled in the art that rotation of the ring memory in descending order may be made without departing from the scope of the invention. It is also possible that, instead of the ring memory 242c2, a memory is used to store the output data from the FFT block 248c, and the ordering pulse sequence generating circuit 243c1 is so configured that it generates ordering pulse sequences the shift times of which are changed in ascending or descending order in synchronization with a completion of multiplication, and the ordering pulse sequences are repeatedly multiplied by the multiply added basic pulse sequences regenerated from the data stored in the memory until the I-channel and Q-channel data mapped code pulse sequences up to mi/2-th order are detected, where mi represents the degree of the multiple addition of the multiply added basic pulse sequences and this example shows that both the I-channel and the Q-channel are assigned the same number of basic pulse sequences, i.e. mi/2 sequences although I-channel and Q-channel can have different number of degree of multiple addition.

FIG. 18A represents an embodiment of the localizable code pulse sequence detecting means 240 using the primary modulation for the single carrier system. This embodiment is applicable to the frequency hopping system as well. If a primary demodulation is conducted by detecting means 210, the demodulated signal is sent to ADC 241s by passing the demodulating block 245s. The binary pulses demodulated by the demodulating block 245s are converted into digital pulses which are stored in the ring memory 242s, then the stored data are read and sent to the multiply added basic pulse sequence regenerating circuit 243s6 of the separating block 243s in which the multiply added basic pulse sequences are regenerated by making use of the input pulses. Then, the regenerated signal is multiplied by the ordering pulse sequence generated by ordering pulse sequence generating circuit 243s1 of the multiplying circuit 243s2, and next the product signal is filtered to obtain the data mapped code pulse sequence in question. The same steps are applied to the signals that are demodulated by linear signals or multi-level multiply added basic pulse sequences to obtain the data mapped code pulse sequences. However, the demodulating block 245s is not used for transmission signals made of impulses.

FIG. 18B represents an embodiment of the synchronizing means 220 and the localizable signal detecting means 240 of the code type receiving device 200. This device 200 is used to communicate with the code type transmitting device 1 having the transmission signal generating means 70 shown in FIG. 7A or 7B. The detecting means 210 employs the detecting means 210 shown in FIG. 14B. The I-component and Q-component of the output signal from the detecting means 210 are sent to the localizable signal detecting means 240, respectively, the localizable signals detected by which are demodulated by the demodulating circuits 245d1 and 245d2 of the demodulating block 245d. Then, the demodulated signals are converted into digital pulses by the ADC circuits 241d1 and 241d2 of the ADC block 241d and are stored in the ring memory 242d1 and 242d2, respectively. The separating block 243d that separates data mapped code pulse sequences comprises a multiply added basic pulse sequence regenerating circuit 243d6, a ordering pulse sequence generating circuit 243d1, a multiplying circuit 243d2 and a filter circuit 243d3. The stored data of each channel in the ring memory 242d are changed to a multiply added basic pulse sequence by the multiply added basic pulse sequence generating circuit 243d6, then the regenerated sequence is multiplied by ordering pulse sequences generated from the ordering pulse sequence generating circuit 243d1 in the multiplying circuit 243d2. The product signals are filtered by the filter 243d3, respectively, so that data mapped code pulse sequences for the I-channel and the Q-channel are separated.

FIG. 19 shows an embodiment of the code type receiving device 200 having a localizable signal detecting means 240 with a cross-correlation type cancellar block and a synchronizing means 220. The localizable signal detecting means 240 comprises a demodulating block 245e, an ADC block 241e, a ring memory 242e, a block demodulator 240e and a cancellar block 247e.

As will be understood by the skilled persons, the cross-correlation type cancellar detects the signal digitally by eliminating interference noise from the signals the carrier frequency of which is converted by making use of cross-correlation. In the detecting process, timing pulses are detected from the data signal for an acquisition and a tracking, then an interference noise is removed by making use of a data vector calculated through a block demodulation and a partial cross-correlation matrix. In block demodulation and process, it is not always necessary for the frame that makes up the transmission signal to have a preamble that carries timing pulses as a synchronous signal, but it is possible to detect timing pulses from the data signal. Please refer to the non-patent literature 1, pages from 122 through 124 for a cross-correlation type cancellar using a block demodulator.

In this embodiment, the acquisition and the tracking are executed by making use of the output signal from the block demodulator 240e of the localizable signal detecting means 240 instead of the use of the detected signal. The detected signals demodulated by the demodulating block 245e are converted into digital pulses by ADC block 241e on a channel basis and stored in the corresponding memory circuits of the ring memory 242e.

The ring memory 242e stores digital data for a period of the data mapped code pulse sequence. This memory is so configured that the last address is linked just in front of the top address to shift in ascending order for a setting of the top address in each order, and the data for a period are read in the fixed order. In stead of the data for a period, it is possible that the ring memory is so configured that data for more than one period are stored and read. It is also possible to shift the ring memory in descending order in stead of ascending order. The data stored in the ring memory 242e are sent to the matched filter 240e1 of the block demodulator 240e to generate pulses of I-component and Q-component through pulse compression, then the pulses are sent to synchronizing means 220 and their peaks are detected for the acquisition and the tracking. It is possible that, in stead of a use of the ring memory 242e, a memory that stores digital data on the data signal or the synchronous signal for one or more periods can be used for an detection of timing pulses by the synchronizing means 220.

The output signal from the matched filter 240e1 is sent to the estimating and demodulating circuit 240e2 simultaneously with an input to the synchronizing means 220. The estimating and demodulating circuit 240e2 detects the chips of the data mapped code pulse sequences while correcting the offset by making use of the phase and frequency of the carriers of interference noise synchronously with the timing pulses detected by the synchronizing means 220. Please refer to the non-patent literature 1 from 120 pages to 124 pages for the block demodulation and the cross-correlation type cancellar.

The cross-correlation circuit 247e1 of the cancellar block 247e calculates a partial cross-correlation matrix by making use of a vector the elements of which represent the chips of the data mapped code pulse sequence. The cancellar 247e2 separates the chip vector of the data mapped code pulse sequence by making use of the cross-correlation matrix and the output signal from the estimating and demodulating circuit 240e2.

It is preferable that each sub-band equip with a cancellar block to separate a chip vector from the transmitted signal sent by using OFDM method since a small scale matrix calculation is enabled, which makes the configuration of the cancellar simple.

FIG. 20 shows an embodiment of the code type receiving device 200 having localizable signal detecting means 240 that includes a block demodulator and the localized pulse detecting means that includes a cancellar block, and is communicable with code type transmitting device 1 having a transmission signal generating means 70 shown in FIG. 7A or FIG. 7B. The data vector made of the partial cross correlation calculated by making use of synchronizing chips of the data mapped code pulse sequence detected by the block demodulator 240f in synchronization with the timing pulses detected by the synchronizing means 220 is sent to the cancellar circuit 252f1 of the localized pulse detecting means 250 in which the chip vector is separated by making use of the partial cross-correlation calculated by the correlator circuit 252f2.

Then, the vector is sent to the multiply added basic pulse sequence regenerating block 254f in which multiply added basic pulse sequences are regenerated from the vector and the sequences are sent to the localizing block 253f. The block 253f localizes the input sequences to generate localized pulses which are sent to the ordering circuit 243f1 of the replica generating block 243f involved in the localizable signal detecting means 240. In the ordering circuit 243f1, the input signals are multiplied by ordering pulse sequences generated by the ordering pulse sequence generating circuit 243f2 in order to make replicas of the basic pulse sequences. The replicas are sent to the matched filter 240f1 for an detection of the timing and for an estimation and demodulation by the estimating and demodulating circuit 240f2. Then the output signal from the circuit 240f2 is sent to the cancellar block 252f in which the chip vector is separated by the aid of the cancellar circuit 252f1 and the correlation calculating circuit 252f2. The vector is used to regenerate multiply added basic pulse sequences by the multiply added basic pulse sequence generating means 254f. Next, localized pulses are detected from the regenerated multiply added basic pulse sequences via localizing block 252f3 and those pulses are sent to the data calculating means 260. The judgement is applied to the localized pulses.

It is preferable that the systems using OFDM method be so configured that the steps described hereinabove are executed in each sub-channel since low speed processing and simple configuration can be accomplished.

In the UWB transmitting systems using impulses, the detecting means of the receivers detect the transmission signals made of impulses or demodulated signals by impulses. The localizable signal detecting means regenerates chips for the transmission signal generating pulse sequences by making use of the detected signals while maintaining the timing, then detects localizable signals including data mapped code pulse sequences from the regenerated pulse sequences. Next, the localizing means localizes the localizable signals for detection of the localized pulses.

Since the averages of the impulses and the modulated signals are 0, it is possible that the pulses to represent the chips are regenerated in the way that the signals are converted into unipolar signals with the aid of templates, then the unipolar signals are integrated, or the signals are integrated through peak hold circuits.

Since the chips of the transmission signal generating pulse sequences of the r−δsignals having the degree of multiple addition r and delay time δ are synthesized by regenerating pulses representing the degree of multiple addition of r in synchronization with the transit time of the front edges with a δ-interval and adding those pulses multiply, the chips are determined by sampling the synthesized pulses at the time between the transit time of the front edge of the chip of the pulse sequence having the degree of addition r corresponding to the maximal order and the rare edge corresponding to minimal order.

FIG. 21 represents an embodiment of the detecting means 210, the synchronizing means 220, the localizable signal detecting means 240 and the localize pulse detecting means 250 of the code type receiving means 200 that is communicable with the code type transmitting device of the UWB system having the data mapped code pulse sequence generating means 30 shown in FIG. 6A and the transmission signal generating means 70 shown in FIG. 10A, or having the data mapped code pulse sequence generating means 30 shown in FIG. 6B and the transmission signal generating means 70 shown in FIG. 10B, The localizable signal detecting means 240 comprises a chip regenerating block including a unipolar circuit 249h1, a pulse synthesizing circuit 249h2, a sampling circuit 249h3 and a template 249h4, a ring memory block 242h and a separating block 243h having a multiply added basic pulse sequence regenerating circuit 243h4, an ordering pulse sequence generating circuit 243h1, a multiplying circuit 243h2 and a filter circuit 243h3.

The synchronizing means 220 executes an acquisition and a tracking by making use of the synchronous impulses sent in series with or in parallel to the data signal and detected by the detecting means 210.

The detected signal is sent to the chip regenerating block 249h, so that the impulses are converted into unipolar impulses bin the unipolar signal generating circuit by making use of the template signals generated by the template generating circuit 249h4. The unipolar impulses are integrated by the pulse synthesizing circuit 249h2 to synthesize pulses, then the unipolar impulses are sampled by the sampling circuit 249h3, so that pulses for the transmission signal generating pulse sequence are regenerated. The linear regenerated signals represent the chips themselves while the binary regenerated signals represent the binary pulses converted from the multi-level chips. Then, the output signal from the sampling circuit 249h3 are stored into the ring memory 242h. The stored chip data of a period or periods are sent to the separating block 243h in which the multiply added basic pulse sequences are regenerated from the data by the multiply added basic pulse sequence regenerating circuit 243h4, then the regenerated sequences are multiplied in the multiplying circuit 243h2 by ordering pulse sequences generated from the ordering pulse sequence generating circuit 243h1, and next the multiplied sequences are filtered through the filter 243h3 to be output to the localized pulse detecting means 250.

FIG. 22 represents an embodiment of the code type receiving device 200 that includes the detecting means 210, the synchronizing means 220, the localizable signal detecting means 240 and the localized pulse detecting means 250, and is communicable with the code type transmitting device 1 for UWB transmission system using impulse radio including the data mapped code pulse sequence generating means 30 shown in FIG. 5 and the transmission signal generating means shown in FIG. 10A or 10B. In addition, the localizable signal detecting means 240 comprises a chip regenerating block 249i having the same configuration as the chip regenerating block 249h, a separating block 243I and a cancellar block 247i. The separating block 243I comprises a multiply added basic pulse sequence regenerating circuit 243i5, an ordering pulse sequence multiplying circuit 243I, an ordering pulse sequence generating circuit 243i2, a filter 243i3 and a memory 243i4, while the cancellar block comprises a replica generating circuit 247i2, cancellar circuit 247i1 and a memory 247i3.

The chip data for a period regenerated by the chip regenerating block 249Ii are stored in the ring memory, then they are read and sent to the separating block 243I in which multiply added basic pulse sequences for I-channel and Q-channel are regenerated by the multiply added basic pulse sequence regenerating circuit, then those sequences are multiplied in the ordering pulse sequence multiplying circuits 243i1 by ordering pulse sequences generated by the ordering pulse sequence generating circuit 243i2, respectively, and next, those multiplied sequences are filtered through the filter LPF 243i3 in order that the data mapped code pulse sequences are separated. Then the output signal from the filter LPF 243i3 are stored in the ring memory 243i4. The data are read from the ring memory 243i4 and sent to the localized pulse detecting means 250 to be localized. The localized pulses are sent to the replica generating circuit 247i2 of the cancellar block 247I in which all the basic pulse sequences are replicated.

Simultaneously with generation of the replicas, the I-channel and Q-channel data stored in the ring memory are sent to the cancellar circuit 247i1 in which a basic pulse sequence in question is detected by eliminating the replicas of other orders generated by the replica generating circuit from the input data and stored in the memory 247i3.

The stored data are sent to the ordering pulse multiplying circuit 243i1 of the separating block 243i in which the signal made by the input data are multiplied by the ordering pulse sequences generated by the ordering pulse generating circuit 243i2, then the output signal is filtered by the filter LPF 243i3 and stored in the memory 243i4. The stored data are sent to the localized pulse detecting means 250 and localized again and an output of the localized pulse data is conducted. It is possible to be so configured that the step to eliminate the interference noise is repeated as many times as necessary.

FIG. 23A represents an embodiment of the detecting means 210, the synchronizing means 220, the localizable signal detecting means 240 and the localized pulse detecting means 250 of the code type receiving device 200 that is communicable with the code type transmitting device 1 for UWB system using OFDM method equipped with a transmission signal generating means 70 shown in FIG. 11 for stream modulation.

The localizable signal detecting means 240 comprises a GI removing block 244, detector blocks from 245k1 to 245kJ, and localizable signal detecting blocks from 246k1 to 246kJ.

An acquisition and a tracking of synchronization are executed by making use of the timing beacon, common synchronous impulses periodically transmitted in series with data signals, synchronous impulses transmitted via specific sub-band or sub-bands or exclusive synchronous impulses to the sub-bands.

GIs of the detected signal from the detecting means 210 are removed by the GI removing block 244k the output signals from which are sent to the detecting blocks from 245k1 to 245kJ. The input signal sent to the detecting block 245kj of the J-th sub-band is demodulated and base band impulses for I-channel and Q-channel are output, Interference noises of these base band impulses are removed by the localizable signal detecting block 246kj and the corresponding localizing block of the localized pulse detecting means 250 in the same manner as the localizable signal detecting means 240 shown in FIG. 22, outputting localized pulses. It is so configured that the chip regenerating block of the localizable signal detecting means 240 has a pulse synthesizing circuit and a sampling circuit and detected signals from the detecting means 210 are input to the pulse synthesizing circuit.

It is possible that, instead of the localizable signal detecting means 240 shown in FIG. 22, the localizable signal detecting means 240 shown in FIG. 22 using the chip synthesizing block comprising a pulse synthesizing circuit and a sampling circuit are used for the localizable signal detecting block 246kj. In this case, the corresponding localized pulse detecting means 250 can be so configured that it has exclusive localizing blocks for respective sub-bands and the output signal from the localizable signal detecting block 246kj is localized in the sub-band to output the localized pulse to the data calculating means 260.

FIG. 23 B represents an embodiment of the localizable signal detecting means 240 employing a FFT for demodulation, the detecting means 210, the synchronizing means 220 and the localized pulse detecting means 250 for UWB systems communicable with the transmission signal generating means 70 using the stream modulation shown in FIG. 11B or parallel modulation shown in FIG. 11C. The localizable signal detecting means 240 comprises a ADC block 241kb, a memory 242kb0, GI removing block 244kb, FFT block 245kb, an equalizing block 247kb1 and localizable signal detecting blocks from 246kb1 to 246kbJ. In addition, the localized pulse detecting means 250 includes the localized pulse detecting blocks from 251kb1 to 251kbJ that are configured in the same way as the localized pulse detecting means 50 shown in FIG. 23A.

The localizable signal detecting blocks from 246kb1 to 246kbJ as well as the localizable signal detecting means 240 shown in FIG. 23A are configured by making use of, but not limited to, the localizable signal detecting means shown in FIG. 21 or FIG. 22 that are equipped with the chip regenerating blocks comprising pulse synthesizing circuits and sampling circuits.

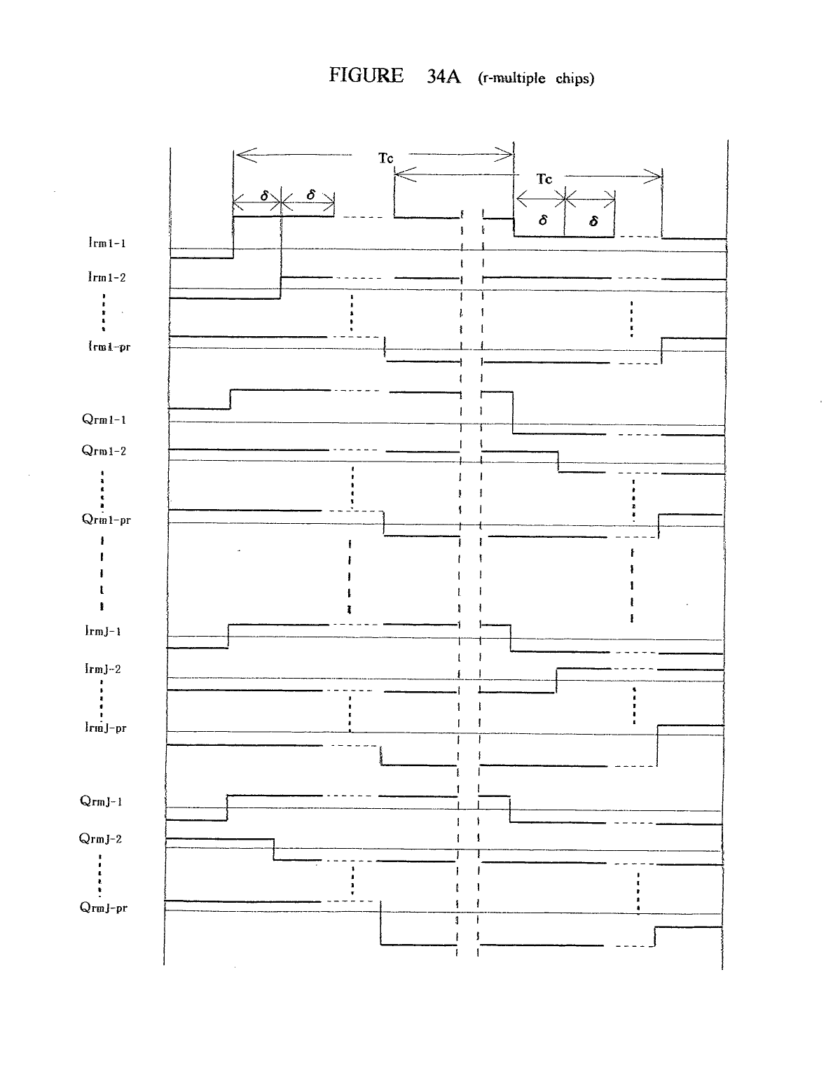

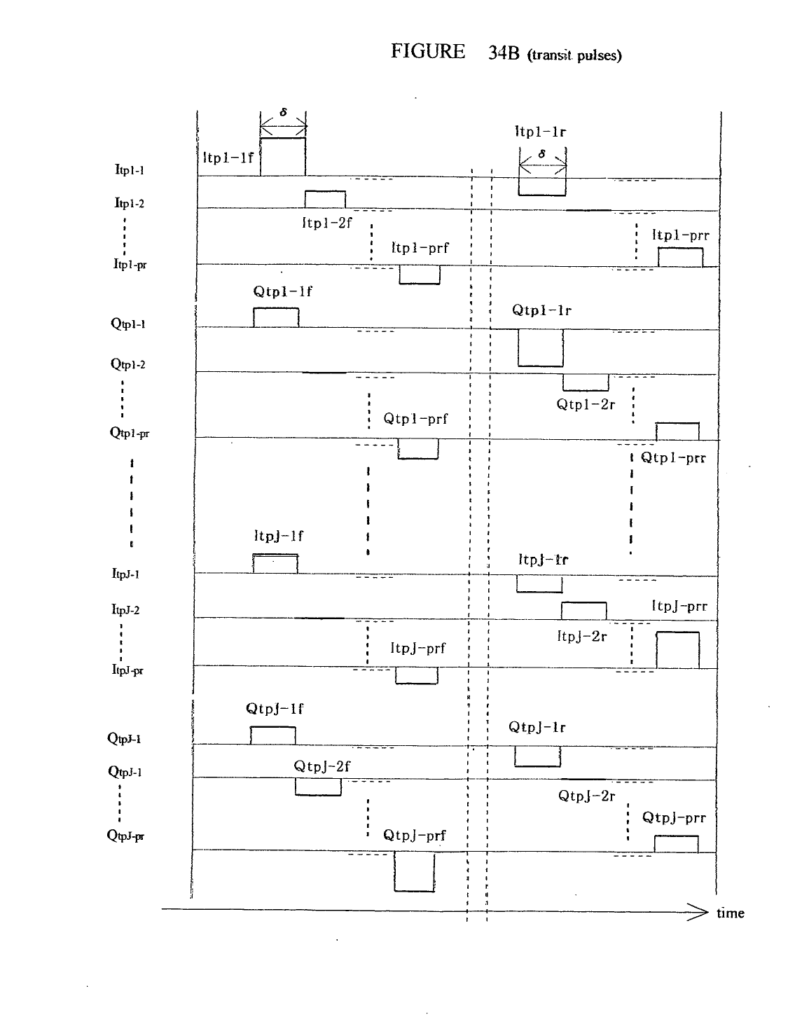

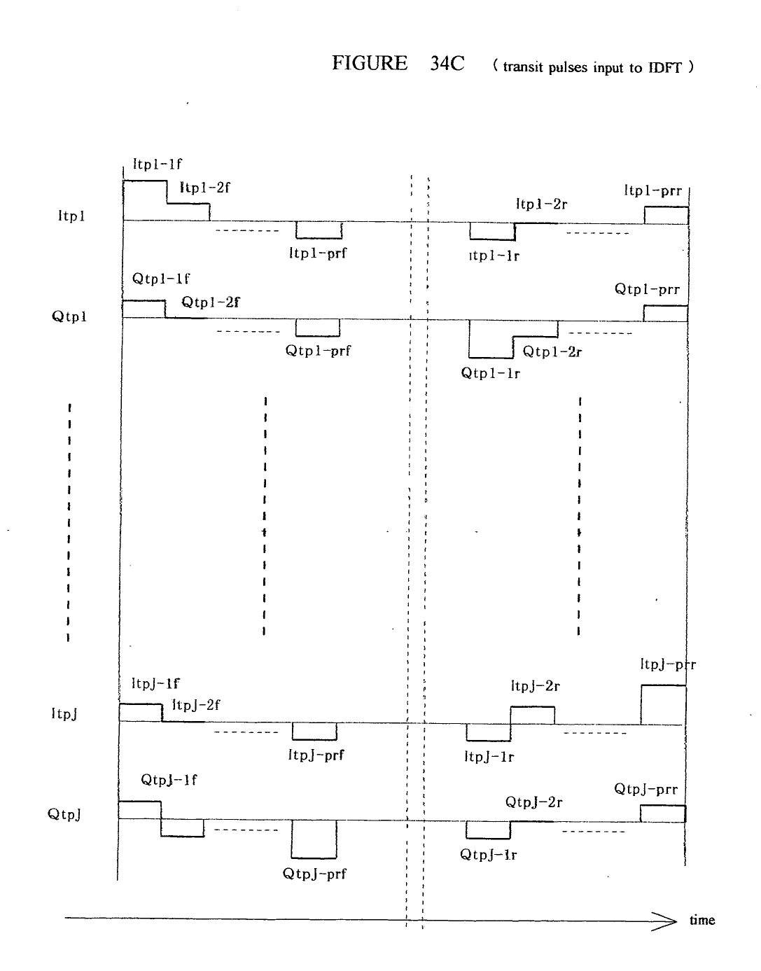

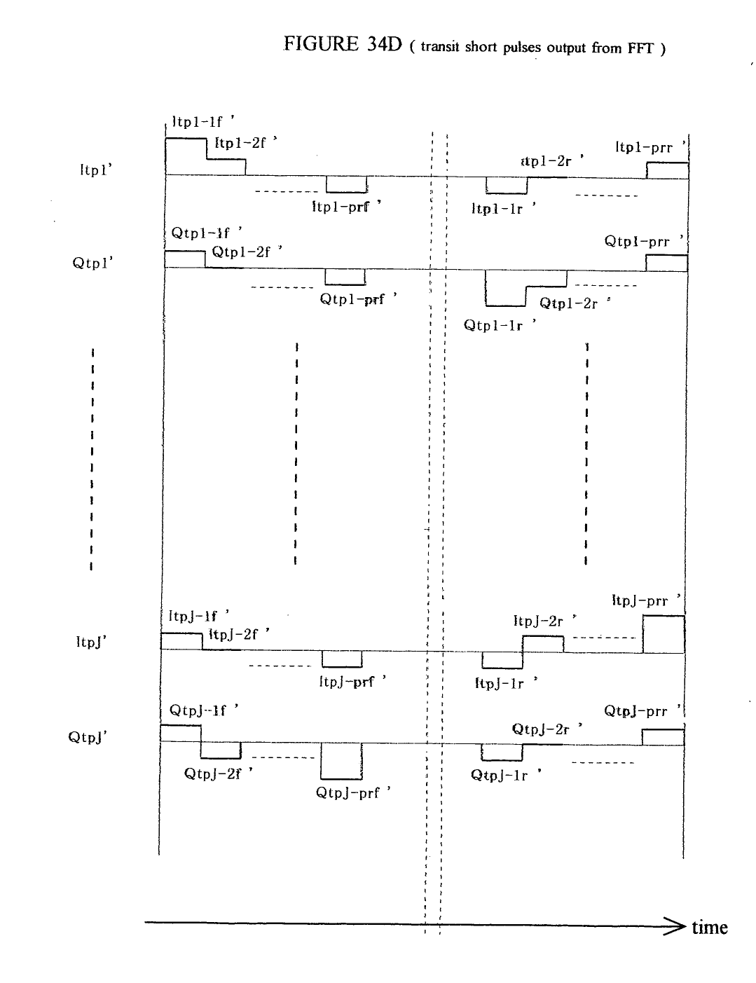

In GI removing block 244kb, the GIs are removed from the output signal from the detecting means 210, then the modulated multiple added signals GIs are removed are sent to the FFT block 245kb. The multiply added modulated signal is generated by the transmitting device 1 through an IDFT by making use of the synchronizing transit pulses of the respective sub bands having pulse widths of δ, and the modulating signal consists of δ-pulses that are made by allocating delay times expressed by (u−1) δ to the transit edges of respective chips of the r-multiple addition basic pulse sequences that are complex multiply added basic pulse sequences with the degree of addition of r as many as which basic pulse sequences are allocated to respective sub-bands. In the above, u represents an integer to identify the order of groups of basic pulse sequences in the band or the sub-band. (Please refer to FIGS. 34A, 34A and 34B).

The FFT block 245kb transforms the multiply added modified signals in synchronization with every delay chip of the r-multiple addition basic pulse sequences to produce base band complex pulse sets having δpulse widths and the pulse heights representing the amounts of changes of the transient edges and outputs the data on the sets to the equalizing block 247kb. The equalized signals are output to corresponding localizable signal detecting blocks from 246kb1 to 246kbJ with a interval. The steps to calculate FFT by FFT block 245kb stated above are repeated pr times per chip where pr represents the number of sets of the basic pulse sequences in a sub-band. Then, by making use of the output signals from the FFT blocks, chips of r-multiple addition basic pulse sequences in respective sub-bands are regenerated synchronously by localizable signal detecting blocks from 246kb1 to 246kbJ. The steps to regenerate chips are repeated as many as NK times per period in each sub-band and J sets of complex multiply added basic pulse sequences are regenerated by the whole band.

For OFDM system the signal of which is generated by making use of the binary pulse sequences with m′ figures converted from chips, localizable signal detecting blocks 246b1 to 246bJ generate chips from every m′ digits of the FFT output signals, then from the NK sets of regenerated chips, a multiply added basic pulse sequence is synthesized. Next, the synthesized sequence of each sub-band is multiplied by ordering pulse sequences to separate data mapped code pulse sequence in each sub-band. Other steps are done similarly to the stream modulation.

The chip signal for a period of the complex multiply added basic pulse sequence from the localizable signal detecting blocks from 246kb1 to 246kbJ are sent to the corresponding localizing blocks from 251kb1 to 251kbJ to be localized, then are fed back to the corresponding localizable signal detecting blocks from 246kb1 to 246kbJ removing a interference noise. If the localizable signal detecting block is configured by making use of the localizable signal detecting means 240 shown in FIG. 21, it is not necessary to use a feed back connection from the block to the cancellar block.

FIG. 23C expresses an embodiment of code type receiving device 200 for UWB system using OFDM method with parallel modulation. The device 200 is communicable with the code type transmitting device 1 in which pr sets of complex transient pulses representing chips are converted by IDFT for primary modulation. The localizable signal detecting means 240 comprises a ADC block 241kc that converts input signal into digital pulses, a memory 242kc0 that stores the digital pulses, a GI removing block 244kc that removes GIs from the stored data, a FFT block 245kc that employs FFT processing to analyze the signal GIs are removed, an equalizing block 246kc to equalize the signals output from the FFT block 245kc, a P/S converting block 248kc that convert the equalized signals to serial data in respective sub-bands, a chip regenerating block 249kc comprising a pulse synthesizing circuit 249kc2 to synthesize pulses for the I-channel and the Q-channel and a sampling circuit 249kc3 to sample the synthesized pulses, a ring memory 242kc1 to store the sampled data for the I-channel and the Q-channel, a separating block 243kc having a multiplying circuit to multiply the stored data and the ordering pulse sequences generated by an ordering pulse generating circuit and a filter circuit to filter the product signal, and a cancellar block 247kc to remove interference noise. In case of the localized pulse detecting means 250 employs a cancellar, the localizable signal detecting means 240 does not need to have a cancellar.

The detected signal is converted into digital pulses by ADC block 241kc, and stored in the memory 242kc0. Then, the GIs are removed from the stored data by GI removing block 244kc and the signal with removed GI is sent to the FFT block 245kc.

The FFT block 245kc has a input signal made of a multiply added primary modulated signals generated by making use of the complex transient pulses representing the front edges of the chips as many as pr sets allocated to the sub-band. The input signal is transformed through an FFT process, then the output signals are sent to the equalizing block 246kc. The equalizing block 246kc output pr sets of equalized complex transient pulses to P/S block. It is preferable that J be selected to be equal to pr because of the high usability of the frequency.

The complex pulse sequences are generated by the pulse synthesizing circuits of the chip regenerating block 249kc at the front edges of the chips of the complex pulse sequence converted by the P/S converting block 248kc. Next, the FFT block has complex input signals of multiply added primary modulated signals by the transient pulses at the rear edges of the chips and pr sets of rear edges are analyzed. The output signals from the FFT blocks 245kc are converted to serial pulse sequences by the P/S converting block 248kc and are used to regenerate the complex pulses representing the rear edges by the pulse synthesizing circuits of the chip regenerating block 249kc. Then, the sampling circuit 249kc3 samples the regenerated pulses at the time expressing their amplitudes between the front edges and the rear edges to detect the sets of the complex chips.

The steps up to the regeneration of the complex pulses are repeated by NK times to regenerate a period of multiply added basic pulse sequences. Then the pulse sequences are sent to the separating block 243kc in which the data mapped code pulse sequences for I-channel and for Q-channel are separated, respectively. Next, the data mapped code pulse sequences are localized and detected by the localized pulse detecting means 250.

The code type receiving device 200 for OFDM system using parallel modulation technique by the binary chips converted from the chips can have the localizable signal detecting means 240 that is equipped with the ring memory 242kc1 with the similar configuration. In addition it can have the similar steps of a separation, a removal of interference and a detection of localized pulses to those mentioned above.

FIG. 24A shows embodiments of the localized pulse detecting means 250 used for a detection of the localized pulses from the multiply added basic pulse sequences (MABPS), the impulses generated from MABPS, the binary pulses converted from MABPS, the impulses generated from the binary pulses, or the single carrier modulated signals modulated by one of these impulses or pulses. This localized pulse detecting means 250 comprises a ring memory 253s, a localizing block 251s and a localized pulse detecting block 252s. The data mapped code pulse sequences separated by the localizable signal detecting means 240 are stored in the ring memory 251s, respectively and sent to the localizing block 251s. The localization is conducted by such circuits to localize the data mapped code pulse sequences as the matched filter. Then the localized pulses are detected by the localized pulse detecting block 252s and determined. In case of a cross-correlation calculating circuit being used instead of the matched filter, the ring memory can be replaced by a fixed memory.

FIG. 24B expresses an embodiment of the localized pulse detecting means 250 for orthogonal modulation. This means 250 comprises a ring memory block 253a including ring memories 253a1 and 253a2, a matched filter block 251a having matched filter circuits 251a1 and 251a2 and a localized pulse detecting block 252a having localized pulse detecting circuits 252a1 and 252a2, where the last suffixes 1 and 2 represent I-channel and Q-channel, respectively.

The data mapped code pulse sequences for I-channel detected by the localizable signal detecting means 240 are localized by the matched filter 251a1 and the localized pulses are detected by the localized pulse detecting means 252a1. The ring memory can be replaced by a fixed memory if the cross-correlation circuit is used as a localizing circuit instead of the matched filter. The localized pulse for Q-channel is detected and judged in the same manner. These steps are repeated as many times as the degree of the multiple addition and all the localized pulses detected are sent to the data calculating means 260. If the cancellar makes use of the replicas, the detected localized pulses are fed back to the cancellar to generate the cancellar signals. It is possible that in case of the localized pulses being not detected, a signal of request for redetection is sent the localizable signal detecting means 240. If the redetection is failed, then, a signal of request for retransmission from the transmitting side can be sent to the side via control means 280. Or, it is possible to send the request signal via the means 280 without executing the redetection by the means 240.

FIG. 25 represents an embodiment of the localized pulse detecting means 250 for OFDM system. The means 250 comprises a ring memory block having ring memories from 253h11 to 253hJ1 for the I-channel and from 253h12 to 253hJ2 for the Q-channel, a localizing block having localizing circuits from 251h11 to 251hJ1 for the I-channel and from 252h12 to 252hJ2 for the Q-channel and localized pulse detecting block having localized pulse detecting circuits from 252h11 to 252hJ1 for the I-channel and from 252h12 to 252hJ2 for the Q-channel. The ring memory circuits of the ring memory block 253h, the localizing circuits of the localizing block 251h and the localized pulse detecting circuits of the localized pulse detecting block 252h are made by making use of the ring memory 253a1 or 253a2, the localizing circuit 251a1 or 251a2 and the localized pulse detecting circuit 252a1 or 252a2 shown in FIG. 24B, respectively.

The output signals for I-channel and the Q-channel from the j-th localizable signal separating block of the localizable signal detecting means 240 are stored in the ring memory 253hj1 and 253hj2, respectively. If the localizing circuits are made by making use of matched filters, the stored data in the ring memory for the I-channel are sent to the matched filter circuit 251hj1 through which the data pulses are compressed in a cycle of the ring memory to produce localized pulses, then the localized pulses are detected by the localized pulse detecting circuit 252hj1. Localized pulses for Q-channel are detected in the same manner. The steps described hereinabove are common to all the sub-channels, and repeated as many time as the degree of addition respectively. If a correlation circuit is used instead of the matched filter, the ring memory is replaced by a fixed memory.

The data calculating means 260 calculates the data by making use of the shift times indicated by the localized pulses. If the data represent encoded data, the original data are calculated from the decoded data.

It is possible that this localized pulse detecting means 250 is also so configured that a request for a redetection or a retransmission is made if localized pulses are not detected.

FIG. 26A shows an embodiment of the data calculating means 260 having a memory block 261s, an inverse conversion block 262s and an error correction decoding block 263s. The output data from the localized pulse detecting block 252s are stored in the ring memory 261s, then are read and sent the inverse conversion block 262s in which the data are converted inversely from the notation system of base N to the notation system of required base number including, but not limited to, a binary, an octal, a hexadecimal and a decimal number or the notation system of the original data. Next, the error correction decoding block 263s corrects and decodes the data to calculate the original data.

FIG. 26B represents an embodiment of the data calculating means 260 comprising a memory block 261a having memory circuits 261a1 and 261a2, an inverse conversion block to calculate data from localized pulses, a error correction decoding block 263a and P/S converting block 264a. The output signals from the localized pulse detecting circuits 252a1 and 252a2 are stored in the memory 261a in accordance with the channels, respectively. These stored data are sent to the inverse conversion block 262a in which the notation system of those data is converted to the original or any notation system required, then the data are sent to the error correction decoding block 263a by which the original data are calculated. The output data from the block 263a are sent to the output means 270 by which the data are displayed on the screens and/or are sent to external computers, and so forth.

It is preferable that the inverse data conversion by the data conversion block and the error correction by the error correction decoding block in the data calculating means 260 be done in accordance with, but not limited to, the size of the data set of the error corrected data and that of the data the notation system of which have been converted by the transmitting device 1. In addition, it is preferable that the device 1 is so configured that the read from the memory to the inverse conversion block and the transmission from the inverse conversion block to the error correction decoding block, and so forth are done in parallel for high speed processing.

FIG. 27 shows an embodiment of the data calculating means 260 for OFDM system.

The means 260 comprises a memory block 261h having memories from 261h11 to 261hJ1 for the I-channel and from 261h12 to 261hJ2 for the Q-channel, a inverse conversion block 262h and an error correction decoding block 263h.

The output signals from the localized pulse detecting blocks 252hj1 and 252hj2 are stored in the corresponding memories 261hj1 and 261hj2, respectively, then those data are sent to the inverse conversion block 262h in parallel in which encoded data for error correction are detected, then the data are sent to the error correction decoding block 263h for a calculation of the original data which are output to the output means 270.

The data calculating means 260 is so configured that its transmission system matches that of the code type transmitting device 1. It is possible that, in the OFDM system using the stream modulation, the converted data sets with the notation system of base N for both the I-channels and the Q-channels contained by all the sub-bands are used, together or respectively, to calculate the original data through a decoding for error correction by the error correction decoding block 263h. Or, if the converted data of the transmission signal are composed through a categorization into some number of the sets according to the classified sub-bands, it is possible that, instead of the use of the decoded data of all the sub-bands, the original data are calculated from the inversely converted data through a decoding on a channel basis by the error correction decoding block.

The present invention is the RF IC tags that transmit, receive and/or store the signals based on the multiply added basic pulse sequences. The RFID tags are so configured that they are communicable with RF reader/writers which are used for read and write to the tags.

The RF tags transmit to, or transmit to and receive from the RF reader/writer at least the ID data and chip data of the multiply added basic pulse sequences to be stored to or read from the memory. The chip data are stored as bit data into the memory while they are transmitted to the RF reader/writer as answering waves forming a bit stream or an impulse stream, or in the form of a signal modulated by either the bit stream or the impulse stream. Or, it is possible that, instead of the bit stream, the answering waves can be composed by making use of the linear impulses or pulses to the chip amplitudes, or signals modified by either of them.

It is preferable that the RF IC tags be so configured that they have means to identify the data formats as well as the objects attached.

Those data are written on ROM memory during production or are written on writable or nonvolatile memories by the RF reader/writer after shipped.

The RF IC tags have features of high memorization rate (bits/cell) for the large degree of addition, reduction of R&D and manufacturing costs by the use of the stream modulation that enables applications of the existing technologies to RF IC tags, low error rate and expansion of communicable area due to improvement of SNR and so forth. The communications between the tag and the RF reader/writer employs a half duplex system or a full duplex system by frequency division. Moreover, it is possible that the tags are so configured that they communicate among themselves.

The tags are divided into two categories according to power sources one of which is a passive power group and the other is active tag group. The passive tag is supplied the power from the RF reader/writer via wireless energy carriers while the active tag is equipped with a battery or batteries. The passive tag has at least an antenna commonly used by the input circuit and the output circuit and stores chip data on the multiply added basic pulse sequences. The tag processes the stored data and outputs the result in synchronization with the input signal with the aid of energy supplied via the antenna. Especially for downsizing, reduction of costs and commercial production, it is preferable that the antenna is formed on a single chip with circuits. It is possible that the necessary data including those on ID are written either on ROM in a factory or on rewritable memory.

When a query wave sent by the RF reader/writer is detected by the antenna of the RF IC tag, the stored data in the memory are read and used to generate a transmission signal based on the transmission signal generating pulse sequence, then an answering wave including the signal and command signal are sent back to the RF reader/writer.

This transmission signal is made of impulses, pulses, or modulated signal by the impulses or by the pulses based on the multiply added basic pulse sequences. The modulated signal can be a primary modulated signal or a modulated signal generated by modulating the RF single carrier or a set of orthogonal carriers with the signal based on the transmission signal generating pulses.

On the other hands, the active RF IC tags can be so configured that the tags equip with operational circuits and send back the calculated data via the answering wave made of the impulses, the pulses or the modulated signal by either the impulses or the pulses that are generated by making use of the bit stream converted from multiply added basic pulse sequences. Or, the tag can be so configured that, instead of the use of the bit stream made from the chips, it sends back an answering wave consisting of liner impulses or pulses linear with respect to the chip amplitudes, or modulated signals by them.

It is allowed that the tags have some of such features to execute an arithmetic operation to calculate original data from the signals detected and those read from the memory as well as to process those data, to convert the calculated data to multiply added basic pulse sequences and to memorize the data, to generate the transmission signals and to transmit those signals, to communicate among tags including transference, to process those data, and so forth.

Or, the tags can be so configured that they receive the original data or the encoded data for error correction from the reader/writer and execute arithmetic operation with the stored data, then store the results and generate a multiply added basic pulse sequences bay making of the chips of which impulses or pulses based on the binary pulses or linear pulses to the amplitudes, or the modulated signals with those signals are made and transmitted as answer waves.

In additions both types of tags are allowed to be so configured that carrier generating circuits of them modify the synchronized carrier free from the control of congestion by making use of the data gathered from communicable tags through congestion control to send to the RF reader/writer. It is possible to use non-linear elements with pull-in effect to achieve such a synchronized frequency, by which transmission energy are concentrated to increase SNR of the detected signal and communicable area is expanded.

The tags may be so configured that they have arithmetical operation means that work cooperatively and implement assigned jobs, respectively. Moreover, it is also allowed that the tags have self organizing means and are systemized through control by a base tag or tags by optimizing themselves to implement assigned parts of jobs in comparison to the criteria, effectively. The base tags can have such built-in specific functions or acquire them in the development process. The self organization of the member tags and the base tags are done by making use of mutual interaction among themselves or with the aid of the RF reader/writer, for example.

FIG. 28A shows an embodiment of passive RF IC tag 300 storing multiply added basic pulse sequences. The tag comprises an antenna 3001a, a power source means 3009a, an initializing circuit 3008a, a clock circuit 3006a and a processing and control means 3007a. The tag makes use of the binary pulses converted from the chips of the pulse sequences for transmission and memorization. It is preferable that the tag have a memory to store data with which the RF reader/write identifies the object to which the tag is stuck on and the data format it uses for communication.

The tag 300 has the features of a high memorization rate, an improved SNR which enables an expansion of the communicable area and so forth and it is preferable that the tag be exclusively used for the read for a production control, an inventory control, a product management, a distribution control, a quality control, an informational management on location, an environment management, possession management, security management for commuter passes, tickets, securities, bills and so forth, management of immobilizers, administration management of medicine, and so forth.

The processing and control means 3007a comprises a congestion control block 30071, decorder 30072, a transmission control block 30073, a memory control block 30074 and a and an memory. This invention can reduce input signals from the tags other than communicating one as interference noise, and the congestion control means will cooperatively work to achieve the high SNR for the RF reader/writer.

The memory 30075 stores at least bit data converted from the chips of the multiply added basic pulse sequences.

The power source means 3009a works as a rectifier as well as input/output means and has overvoltage control circuit to suppress an over voltage.

The query wave from the RF reader/writer is received by antenna 3001a and input to the power means 3009a through which power is obtained and supplied to the RF IC tag circuits. Simultaneously, the signal is sent to the clock generating circuit 3006a which starts to work when power is obtained, then the initializing circuit 3008a initializes the tag to start the decoder 30072 to generate commands for memory control block 30074. Accordingly, the memory control block sends the stored data to the transmission control block to generate the transmission signal which is transmitted to the RF reader/writer as an answering wave from the antenna via the power supplying means 3009a. The transmission system can employ a half duplex communication method or a full duplex method. In addition, the congestion control block 30071 is given a sleep command to suppress transmission until it is reset once a read is completed in order to suppress congestion due to a number of tags.

An data update of the tag is conducted by the RF reader/writer. The signal including command and the data from the RF reader/writer supply the power to power source means 3009a, and simultaneously initialize the initializing circuit and then the tag and make the clock circuit 3006a to generate clock pulses. In addition, commands are decoded by the decoder 30072 from the detected signal by the power source means 3009a to make the memory control block 30074 to work for memorization of data. During this time, the transmission control block 30073 controls the input circuit for the impedance matching. Soon after the memorization of the data to the memory, the transmitting block 30073 controls the memory control block 30074 to send the chip data stored in the memory 30075 to the RF reader/writer as an answering wave. It is possible the tag is so configured that it has a transferring means to transfer the data.

FIG. 28B shows an embodiment the active RF IC tag 300 that has power source means made of a battery. The tag comprises an antenna 3001b commonly used for transmission and reception, a synchronous means 3002b, a transmitting means 3004b, a receiving means 3003b, a power source means 3009b, an arithmetic operation means 3005b, a memory 3008b, a control means 3000b and a congestion control means 3010b, and are used in the same manner as a tag 300 shown in FIG. 28A, although it has capabilities of more applications due to wider communicable area.

The tag can have arithmetic operation means 3005b with the aid of the power source means 3009b, so that it executes the operation and generates the transmission signal based on the results and sends it as an answering wave.

The control means 3000b executes at least a control of the arithmetic operation means 3005b, a state control of an issue and a release of the sleep commands and the control of the transmitting means 3004b.

The code pulse sequences for acquisition and tracking detected by the antenna 3001b are sent to the synchronous means 3002b in which timing is detected and, by using the timing, the generation of the clock by the control means 3000b is regulated. In addition, the detected by the receiving means 3003b is sent to the control means 3000b to read the data on the chips of the multiply added basic pulse sequences stored in the memory 3008b, then the data are sent to the transmitting means 3004b and are transmitted via antenna 3001b. The control means 3000b controls the write and the read of the data calculated by the arithmetic operating means 3005b in and from the memory 3008b as well as the operational processing then controls the write of the results to the memory and generation of the transmission signal by making use of the multiply added basic pulse sequence. Next, the means 3000b controls generation of impulses, pulses generated based on the binary pulses converted from the sequence or the modulated signals or hopping signals modulated those signals. Or, instead of the binary pulses, linear signals to the amplitudes of the chips can be used for generation and transmission.

The power source means 3009b can be so configured that it make has a energy source making use of electromagnetic induction in addition to the battery.

The control means 3000b of the tags of this invention can be so configured that it transfers the stored data of the adjacent tags. In addition it can be so configured that it controls memory 3008b to store the data read from near-by tags and execute an arithmetic processing for the data, then the results are stored and transmitted.

This invention is the RF reader/writer equipped with a writer means that supplies power to the circuits of the tag and generates the transmission signals based on the chip data of the multiply added basic pulse sequences by making use of at least data and the IDs to the memory of the tag, and a reader means that sends to the RF IC tag a query wave comprising the transmission signals based on the binary pulses converted from chips of the multiply added basic pulse sequence onto which data, IDs and so forth are mapped and receives the answering waves of the stored data reflected or sent back from the tag to calculate the original data, and so forth.

FIG. 29 shows an embodiment of the RF reader/writer comprising an antenna 4000rc, a circulator 4001rc, an amplifier 4002rc for reception, an TX amplifier 4003rc for transmission, an arithmetic operation means 4004rc, memory 4005rc, an interface 4006rc, control means 4007rc, a transmitting means 4008rc, a receiving means 4009rc and a clock oscillating and control means 4010rc.

The transmitting means 4008rc is made by making use of the code type transmitting device 1 while the receiving means 4009rc is made by making use of the code type receiving means 200, and both means commonly use the antenna and are controlled by the control 4007rc.

For read, when power is on, clock pulses are generated by oscillation and control means 4010rc to start the control means 4007rc. Then, the query wave generated by the transmitting means 4008rc is sent to the TX amplifier 4003rc, then to the circulator, and next to the antenna 4000rc to be sent to the tag, while supplying power and reading the store data via the answering wave. The query wave is the modulated signal modulated by the binary pulses converted from the chips of the multiply added basic pulse sequences by the linear chips. The answering wave is sent to the antenna 3000rc, then to the circulator 4001rc, next to the amplifier 4002rc, and then to the receiving means 4009rc which calculate the original data. The calculated data are collated with the ID stored in the memory 4005rc by the arithmetic operating means 4004rc. Next, the calculated original data are sent to external devices via the interface 4006rc. It is possible to make use of ASK, AM, FM and so forth for modulation in read process.

To lessen influence on the transmission from the conditions of the transmission, it is preferable that the clock oscillating and control means 4009rc hops the frequency of the carrier. The arithmetic operating means 4004rc converts the frequency of the detected signal from the receiving means 4009rc by controlling the frequency of the clock oscillating and control means 4010rc. In addition, the control means 4007rc controls the transmitting and the receiving process following the control signals from the arithmetic operation means 4004rc. Moreover, the arithmetic operation means 4004rc switches the carrier frequency of the transmission signal, the order and so forth. It also controls that the congestion among the tags does not occur. Since the tags are allocated the identifiable ordering sequences, the input signals from other tags are deemed to be noise to be eliminated when a congestion occurs.

When the transmitting means 4008rc sends query waves made of impulses to passive tags, a carrier having timing signals and the impulses are used for transmission of the wave, so that the RF IC tags are charged to generate an answering wave, Or, If the timing is provided via beacon, the tag make use of it for acquisition and tracking.

Write by the RF reader/writer 400 is done in the way that the arithmetic operating means 4004rc makes the data and the ID sent via interface 4006rc to be stored in the memory 4005rc and simultaneously the control means 4007rc activates the transmitting means 4008rc to generate the transmission signals by making use of the chip data of the multiply added basic pulse sequence having data and ID information and send the signal via the TX amplifier for transmission 4003rc, the circulator 4001rc and the antenna 4000rc.

The RF reader/writer provides timing information via beacon and transmits impulses representing the data by making use of the similar way to the passive RF IC tags.

Please refer to FIGURES from 36A to 36C for the binary pulses waveforms converted from the chips of the multiply added basic pulse sequence and format of the memorization.

FIG. 30 shows waveforms illustrating the embodiment of the code type transmitting device 1 having the error correction-encoding means 20 shown I FIG. 2, the data mapped code pulse sequence generating means 30 shown in the FIG. 3 and the transmission signal generating means 70 shown in FIG. 6A, and of the code type receiving device 200 communicable with the code type transmitting device 1 having the detecting means 210 shown in FIG. 14A, the localizable signal detecting means 240 shown in FIG. 18A, the localized pulse detecting means 250 shown in FIG. 24A and the data calculating means 260 shown in FIG. 26A. The I-channel and the Q-channel of the orthogonal modulation system have the similar waveforms, respectively. For FIG. 30, a maximal length code having the code length of 7 is used for the data mapped code pulse sequences the shift times of which are determined according to the data in synchronization with the clock pulses. The data are converted to a number (0343026) with the notation system of base 7 by the data converting block 31s of the FIG. 3. Then, according to the converted data the shift register 32s of the data mapping block on which code pulse sequences in the initial state generated from the code pulse sequence generating block 33s are loaded on is shifted to generate 7 data mapped code pulse sequences.

The figures from b- through b-7 show examples of the output waveform from the data mapping block 32s of the data mapped code pulse sequence generating means 30 of the code type transmitting device 1, in which b1 shows the first data mapped code pulse sequence having the data of 0, a positive control pulse and the chip width of Tk. The waveform of the first data mapped code pulse sequence is the same as that of the sequence in the initial state. The b-2 shows a waveform of the data mapped code pulse sequence having the shift time of 3Tk with a negative control pulse. Similarly, the b-3, the b-4, the b-5, the b-6 and the b-7 have the shift times of 4Tk with a positive control pulse, 3Tk with a positive control pulse, Tk with a negative control pulse, 2Tk with a positive control pulse and 6Tk with a negative control pulse, respectively.

The Figures from c1 through c-7 show examples of the ordering pulse sequences with the chip widths of Tc generated from the ordering pulse sequence generating means 50. The c-1 shows an ordering pulse sequence having the shift time of 0 and c-2 has a shift time of Tc. Similarly, the j-th ordering pulse sequence has the shift time of (j−1)Tc. The chip width represented as Tc is equal to that of the basic pulse sequence shown in FIG. 30 (d) and that of the multiply added basic pulse sequences shown in (e).

The figure from d-1 to d-7 show basic pulse sequences generated from the ordering block 702s through a multiplication of the data mapped code pulse sequences by ordering pulse sequences and control pulses, respectively. Similarly, The d-1 represents the waveform of the basic pulse sequence generated through a multiplication of the waveform shown in b-1 by c-1 with a positive control pulse. Similarly, the waveform shown in d-7 are generated through a multiplication of the waveform shown in b-7 by c-7 with a positive control pulse (e) of the FIG. 30 shows a waveform of the output signal from the multiply adding block 703s of the code type transmitting device 1 shown in FIG. 6A. The waveforms are made by multiply adding the waveform shown d-1 through d-7. The pulse sequences represented by these waveforms modulate the sub carriers in 701s, next, are filtered in filter 708s, then the modulated signals are sent to the modulating block 709s to modulate the main carrier generated from the main carrier generating block 710s.

FIG. 30 (f) shows waveforms of the output signals from the product circuit 243s of the code type receiving device 200 shown in FIG. 18A. The waveforms of (f) are generated in the way that the waveform representing the demodulated multiply added basic pulse sequence shown in (e) is multiplied by the ordering pulse sequences from c1 to c-7 shown in (c), respectively. These signals are filtered through the filter LPF 243s3 to output the data mapped code pulse sequence signals with the waveform shown from b-1 to b-7. Then, these data mapped code pulse sequences are localized by the localizing block 251s of the localized pulse detecting means 250 generating the signals having the waveform shown from g-1 to g-7. The localizing block 251s are made by making use of a matched filter circuit, a cross-correlation calculating circuit and so forth.

In FIG. 30 (g), from g-1 through g-7 represent waveforms generated by the localized pulse detecting block 252s. The waveforms in g-1, g-3. g-4 and g-6 represent the positive localized pulses having shift times of 0, 4Tk, 3Tk and 2Tk respectively, while the waveforms in g-2, g-5 and g-7 represent the negative pulses having shift times of 3Tk, Tk and 6 Tk, respectively. These localized pulses are sent to the data calculating means 260 where original data are calculated. The original data for the I-channel and the Q-channel of the orthogonal modulation system are calculated in the similar way. For the OFDM systems and other frequency division systems using stream modulation, both channels of respective sub-bands generate the localized pulses in the same way. Besides, the I-channel and the Q-channel of the systems that employ parallel modulation by the complex multiply added basic pulse sequences generate localized pulses in the same way. The frequency hopping system and UWB system also generate localized pulses in the similar way.

s1I to sJ1 and s1Q to sJQ of the FIG. 31 (a) show respectively a period of the waveforms of the multiply added basic pulse sequences for I-channel and for Q-channel output from the multiply adding blocks from 703b11 to 703bJ1 and from 703b12 to 703bJ2 of the embodiment of the code type transmitting device 1, for linear stream modulation employing OFDM system, comprising the error correction-encoding means 20 shown in FIG. 2, the data mapped code pulse sequence generating means 30 shown in FIG. 5 and the transmission signal generating means 70 shown in FIG. 8A. The multiply added basic pulse sequences having the degree of addition m are divided and allocated to sub-channels according to transmission rate, characteristics of the transmission paths and so forth in the way that the multiply added basic pulse sequences allocated to respective sub-channels form a set of complex multiply added basic pulse sequences the synchronized chips of which are sent in parallel. For high speed processing, it is possible that a parallel architecture is employed for the transmitting device 1.

Waveforms from s1I to sJI represent those of the multiply added basic pulse sequences having the period of the time T, chip width Tc and the degree of multiple addition m1j, j=1 to J allocated to the I-channels of respective sub-bands.

Between t0 and t1, the I component of the complex symbol of the j-th sub-band having frequency f1 are shown by the chip C^{I}11 of S1I. Similarly, the Q-component (imaginary component) are shown by the chip C^{Q}11.

Similarly, chips for I-component and Q-component of the j-th sub-band having frequency fj between t0 and t1 are shown by C^{I}1j and C^{Q}1j, respectively. The complex symbols consisting Of (C^{I}1j, C^{Q}1j), j=1 to J, are sent to the IDFT block 704b in parallel to generate signals for the I-channel and the Q-channel, respectively.

Similarly, the I-component and the Q-component of the of the complex symbol of the j-th sub-band with frequency of the sub-carrier fj between t(r−1) and tr are shown by C^{I}rj and C^{Q}rj, respectively. These symbols are sent to IDFT block 704b for inverse discrete Fourier transform. In the figure, r represents an integer between 1 and KN, where K*N represents the number of the chips per period of the multiply added basic pulse sequence.

On the other hand, FIG. 32 B represents waveforms of the output signals for the I-channel and the Q-channel from FFT circuit 248b2 of the localizable signal detecting means 240 of the embodiment of the code type transmitting device 1 shown in FIG. 16. The FIG. 32B shows that the output signal from the FFT circuit 248b2 replicates the waveforms shown in (a).

FIG. 32A expresses the waveforms of the input signals to S/P converting block 714c of the embodiment of the code type transmitting device 1 for OFDM system using the parallel modulation having the transmission signal generating means 70S shown in FIG. 9A. Between t0 and t_{NK}, multiply added basic pulse sequence I1 having the period T, and the number of chips per period KN and chip i1j with chip width Tc for j-th chip and the multiply added basic pulse sequence Q1 having a chip q1j for Q-channel are sent to the S/P converting block 714c by which the signals to be converted to a set of complex symbols (i1l, q1j) which is the modulating signal of the j-th sub-band. In this invention, the number of the sub-channel J is equal to the number of chips KN. Similarly, for tj defined by the duration, (n−1)T+t0≦tj≦nT+tKN, 2≦n, the S/P converting block 714c converts a multiply added basic pulse sequence In having chips Inj for I-channel and a sequence Qn with chips qnj are converted into complex sets of chips (inj, qnj).

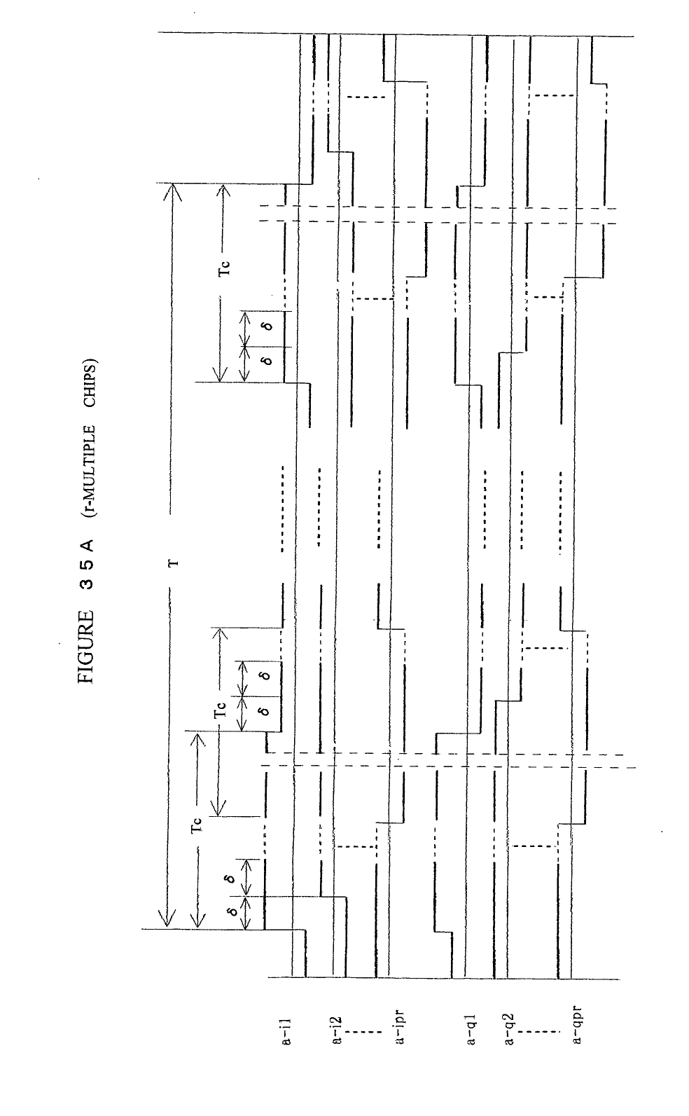

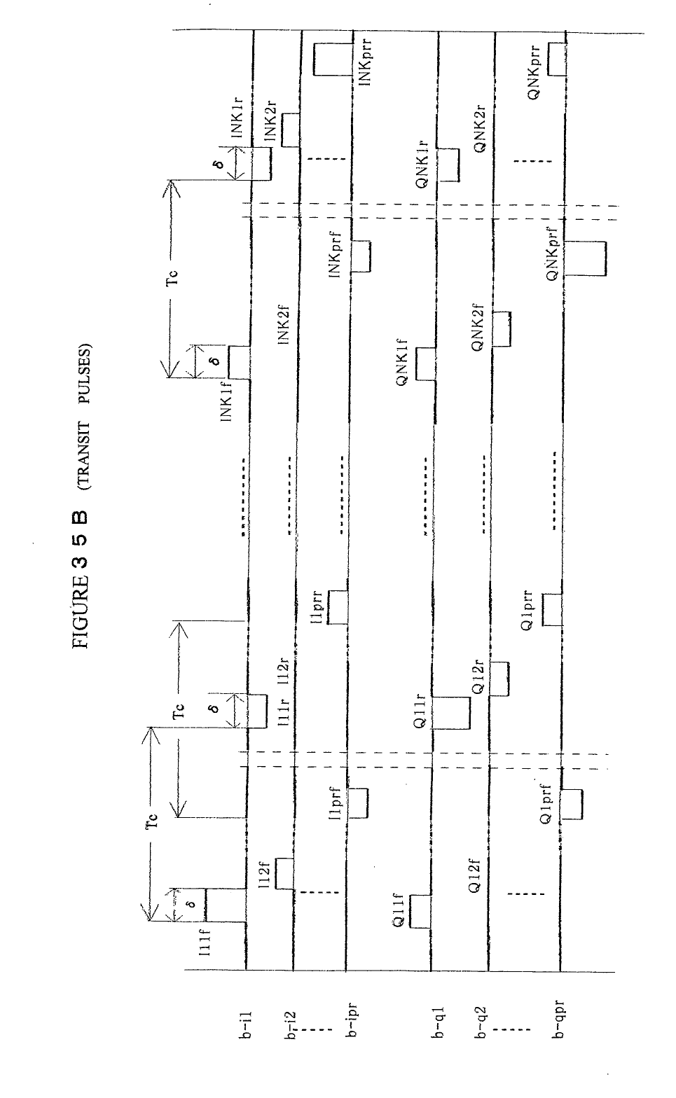

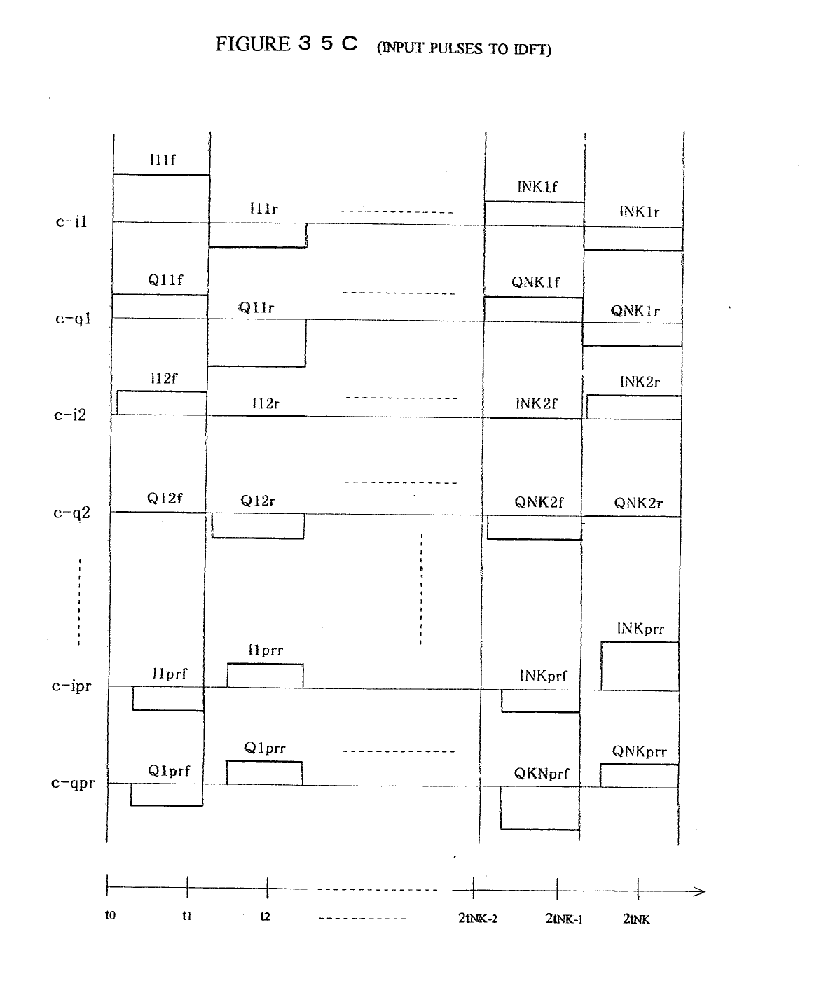

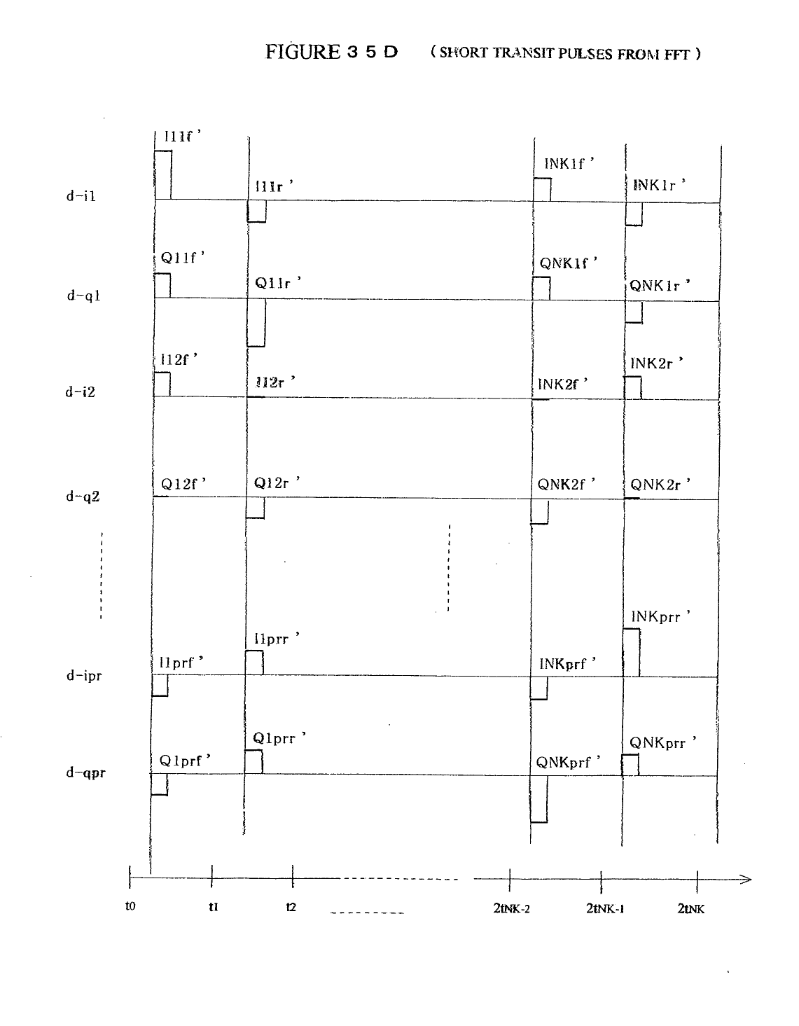

FIG. 32B expresses waveforms of parallel input signals of the IDFT block 704c shown in FIG. 9A of the embodiment of the code type transmitting device 1. The sub-carriers having frequency fj of the j-th sub-band are allocated the chip set (inj, qnj), respectively and chips of In and Qn for a period are sent between tj−1 and tj. The waveforms of the output signals from the P/S circuit involved in the FFT block of the localizable signal detecting means 240 of the embodiment of the code type receiving device 200 that are communicable with the code type transmitting device 1 having the transmission signal generating means shown in FIG. 9A are similar to those shown in FIG. 35A, for example, the waveforms of the output signals from the P/S circuit 248c3 involved in the FFT block of the localizable signal detecting means 240 of the embodiment of the code type receiving device 240 shown in FIG. 17 are the same as those shown in FIG. 35A.

FIG. 33A shows the waveforms of the embodiment of the code type transmitting device 1 including the data mapped code pulse sequence generating means 30 shown in FIG. 5, the waveforms of the embodiment of the code type transmitting device 1 for UWB system using the transmitting means 70 shown in FIG. 10A and those of the embodiment of the code type receiving device 200 having the localizable signal detecting means 240 shown in FIG. 21. The chip regenerating block 249I shown in FIG. 22 has the similar waveforms.

FIG. 33A (a) shows waveforms of clock pulses of the embodiment of the code type transmitting device 1. (b) shows waveforms of the r−δsignals of the embodiment of the invention. The signals are generated from the r-multiple addition circuits from 712d21 to 712d2pr of the impulse generating block 712d by making use of the chips of the r-multiple basic pulse sequences that are made by dividing the multiply added basic pulse sequences having the degree of multiple addition 15 into the pr multiply added basic pulse sequences each of which has the degree of multiple addition 5 and a delay interval of δ and in this case pr is equal to 3. b-1 shows the first r-multiple basic pulse sequence synchronizing with the clock pulses with delay time 0. b-2 shows the second r-multiple basic pulse sequence having a delay time of δ from the clock and b-3 expresses the third r-multiple basic pulse sequence having a delay time of 2δ. It is possible that a separator made of an interval for separation is inserted between the rear edge and the front edge of the adjacent chips.

In FIG. 33A (b), the waveforms of b-1 has an amplitude of 3E, a chip width of Tc, and a delay time of 0 between t0 and tL. The front edge of the pulse changes from −E to 3E at t0 and becomes E, the amplitude of the rear edge, at tL that represents the time after Tc from t0. The waveform of b-2 is the second pulse the front edge of which changes from −E to E after δ from t0 but its rear edge changes nothing at tL+δ since the amplitude of the next edge is E. The waveform of b-3 shows the third pulse the front edge of which changes from E to −E at 2δ after t0 and the rear edge changes from −E to E at t0+2δ.

The waveform shown in (c) is an example of the output signal generated by impulse generating circuit from 712d3i to 712d3pr of the impulse generating block 712d3. This waveform can be replaced by such waveforms as average are zero by making use of APPM (Amplitude Pulse Position Modulation) that changes the position of the impulses according to data and the amplitudes are linear to the chips of the multiply added basic pulse sequence, AOOK (Amplitude ON-OFF Keying) by which the amplitude of the impulses are zero when no impulse exists while the amplitude are linear to the chips, and so forth.

c-1 shows examples of waveforms of the output signals from the impulse generating circuit 712d31. The first impulse representing a positive change is generated in synchronization with the front edge of the chip of b-1 and has an average of zero and two peaks one of which is −4E and the other is 4E, while the second impulse representing a negative change is generated in synchronization with the rear edge of the chip and has an average of zero and two peaks one of which is 2E and the other is −2E.

c-2 shows waveforms of the output signals generated from the circuit 712d32. The first impulse representing a positive change is generated in synchronization with the front edge of b-2 and its first peak is −2E and the second peak is 2E while the second impulse is null.

c-3 shows waveforms of the output signal generated from the circuit 712d33. The first impulse representing a inverse change is generated in synchronization with the front edge of the chip of b-3 and has an average of zero and two peaks one of which is 2E and the other is −2E, while the second impulse representing a positive change is generated in synchronization with the rear edge of the chip and has an average of zero and two peaks one of which is −2E and the other is 2E.

FIG. 33A (d) shows waveforms of the output signals generated from multiply adding circuit 712d4. The position corresponding to the front edge has 3 impulses shown by (c) at δ interval while there are 2 impulses at the position corresponding to the rear edge: one is at tL and the other is at tL+2δ.

It is obvious that waveforms of the output signals from the multiply adding block 712d4 having the delay time of zero represent impulses generated from the chips of the multiply added basic pulse sequence.

FIG. 33A (e) shows examples of waveforms of the unipolar signals output from the unipolar circuit 249h1 of the chip regenerating circuit 249h of the localizable signal detecting means 240 of the code type receiving device 200. The first waveform in the position of the front edge shows a unipolar signal that is generated from the first impulse shown by (d) with the aid of the template. The unipolar signal has two peaks both of which have the amplitude of 4E starting from t0.

The waveforms also include the second unipolar signal that is generated from the second impulse and has two peaks with amplitudes of 2E starting from t0+δ. It has the third unipolar signal with two peaks generated from the third impulse and the amplitudes are −2E starting from t0+2δ. On the other hand, the rear position has the first unipolar, bi-peak signal, starting from t0+Tc, converted from the first impulse and the third unipolar, bi-peak signal, starting from t0+Tc+2δ, converted from the third impulse. There is no impulse starting from t0+Tc+δ.

FIG. 33A(f) shows an example of the waveform of the output signal generated from the pulse synthesizing circuit 249h2. The amplitude of the output signal from the pulse synthesizing circuit 249h2 changes from −E to 3E at t0+δ through an integration of the unipolar, bi-peak signal. Then, the amplitude of the output signal changes to 5E at t0+2δ due to an integration of the second unipolar signal. Next, due to an integration of the third unipolar signal, the output signal changes from 5E to 3E which is held until tL+δ. The amplitude of the output signal changes to E at t0+Tc+δ due to an integration of the fourth unipolar signal with amplitude of −2E. In addition, the output signal becomes 3E at t0+Tc+3δ due to an integration of the fifth unipolar signal.

FIG. 33A (g) shows waveforms of sampling pulses having period T for sampling of the synthesized pulses shown by (f). Since the synthesized pulse represents the chip having the degree of multiple addition of 15 between t0+3δ and tL+δ, the sampling is done between t0+3δ and tL+δ.

FIG. 33A (h) shows waveform of the hold circuit holding the regenerated signal output from the sampler 249h3. The front edge and the rear edge of the pulse are ts and ts+Tc, respectively and the delay time is ts−t0.

Waveforms shown in FIG. 33B (a) to (e) are the same as those shown in FIG. 33A (a) to (e), respectively. In (e), the chips of the multiply added basic pulse sequence are shown by the symbols from C1 to Cn.

FIG. 33C illustrates the data format of the pulses converted from chips represented by C1 to Cn. Since the chip is represented by 3 bits for amplitude and a sign bit, the format has sign bit represented by djs, j=1 to n and 3 data bits represented by dj,r, j=1 to n, r=0, 1 and 2. The conversion is done by making use of ADC or digital arithmetic operation. Or, it is possible that conversion is done by making of, but not limited to, DPSK (Differentially Encoded Phase Shift Keying).

This method to convert the chips of the multiply added basic pulse sequence to binary pulses is applicable to various devices, including but not limited to, UWB transmission devices, pulse transmission devices, frequency hopping devices, OFDM transmission devices, orthogonal modulation devices, transmission device using mono-carrier modulation, memory devices.

FIG. 33D shows examples of waveforms of the impulses used in the embodiment of the code type transmitting device 1. The impulses are generated at the edges of the chips shown in FIG. 33C. The impulse representing the edge that changes from positive level to negative level has the first negative peak and the second positive peak while the impulse that expresses the edge changing from positive level to negative level has an inverse phase. In case of no changing edges, the phase of the impulse remains the same. The method of representing the change by the impulse is not limited to the methods described hereinabove, but includes the method in which null impulse is generated in case of no change appears. In addition, other impulses than those shown in FIG. 33D may be used as far as those impulses have null averages.

The impulses shown in FIG. 33D may be used for regeneration of the pulses in the way that they are converted to unipolar signals by making use of differentially configured templates, next the signals are integrated, and then the output signals are sampled.

FIGS. 34A through 34D exemplify the waveforms of the signals used in the embodiment of the invention for OFDM system using the stream modulation shown in FIG. 11B. FIG. 34A shows the waveforms of the output signal from the r-multiple addition block 712eb2, representing chip waveforms of pr sets of complex r-multiple basic pulse sequences. In this Figure, the number of sub-channels is J.

FIG. 34B shows waveforms of the output signals from δ-pulse generating sub-block.

The δ-pulses are generated in the sub-bands in synchronization with the edges of the chips of the complex multiply added basic pulse sequences and have short widths of δ, respectively. The pulse width δ can be set within the limit of IDFT conversion characteristics.

FIG. 34C shows waveforms of the output signals from δ-multiple addition sub-block 712eb4. The i-th complex δ-pulse Itpj−if, Qtpj−if) of the j-th sub-band is synchronously sent to IDFT block 715eb in parallel with other δ-impulses for the primary modulation. The process to generate the primary modulated signals by making use of IDFT will be sequentially repeated until pr-th δ-pulses in respective sub-channels.

FIG. 34D illustrates waveforms of the output signals from FFT block 245kb shown in FIG. 23B. In the FIG. 34D, pr sets of the complex short pulses at the front edges and the same number of sets of the complex short pulses at the rear edges are detected sequentially, then those pulses are sent to the corresponding localizable signal detecting block 246kbj in which chips are regenerated, and then, data mapped code pulse sequences are separated from the input signals regenerated by making use of NK chips.

FIG. 35A to FIG. 35D exemplify waveforms of the signals used in the embodiment of the device for UWB system using OFDM method employing parallel modulation shown in FIG. 11C. FIG. 35A shows the waveforms of the chips output from r-multiple addition circuit 712ec2. The signals are so arranged that the multiply added basic pulse sequences that have the degree of addition of m are allocated to I-channel and Q-channel and in each channel the sequences are divided into pr sets of sequences having the degree of multiple addition of r. The waveforms shown by a-i1 to a-ipr and a-q1 to a-qpr represent r-multiple−δ-delay pulses output from the I-channel and the Q-channel of the r-multiple addition circuits from 712ec21 to 712ec2pr, respectively.

Waveforms shown in FIG. 35B b-i1 to b-ipr and b-q1 to b-qpr represent the output signals generated from the I-channel and the Q-channel of the i-pulse generating circuits form 712ec31 to 712ec3pr in synchronization with the edges of the r-multiple-δ-delay pulses shown in FIG. 35A. The pulse widths are assumed to be δin the waveforms, but any width less than that within the limits of calculability of IDFT may also be used.

FIG. 35C exemplifies waveforms of the input signals to IDFT. The waveforms shown by c-i1 to c-ipr and c-q1 to c-qpr represent the output signals from the δ-pulse generating circuits 712ec31 to 712ec3pr, respectively and those signals are sent to the IDFT block 715ec. The pulses I11f to I1prf and Q11f to Q1prf that form the front edges of the first chips of the I-channel and the Q-channel of the sub-band shown in FIG. 35B are sent to the IDFT block 715ec in parallel in which those pulses are held until the IDFT calculation is completed between t0 and t1. Similarly, the IDFT calculation of the rear edges of the first chip pulse is completed between t1 and t2, so that the IDFT conversion of thee first chips is completed. Similarly, IDFT transformation of pr chips for one period is completed.

FIG. 35D exemplifies waveforms of the output signals from the FFT block 245kc in FIG. 23. Through an FFT transformation, pr sets of complex short transient pulses of the front edges of the first chips are generated in each sub-band between t0 and t1, then pr sets of complex short transient pulses of the rear edges are generated between t1 and t2. Similarly, complex short transient pulse sets are generated from NK complex chips for a period.

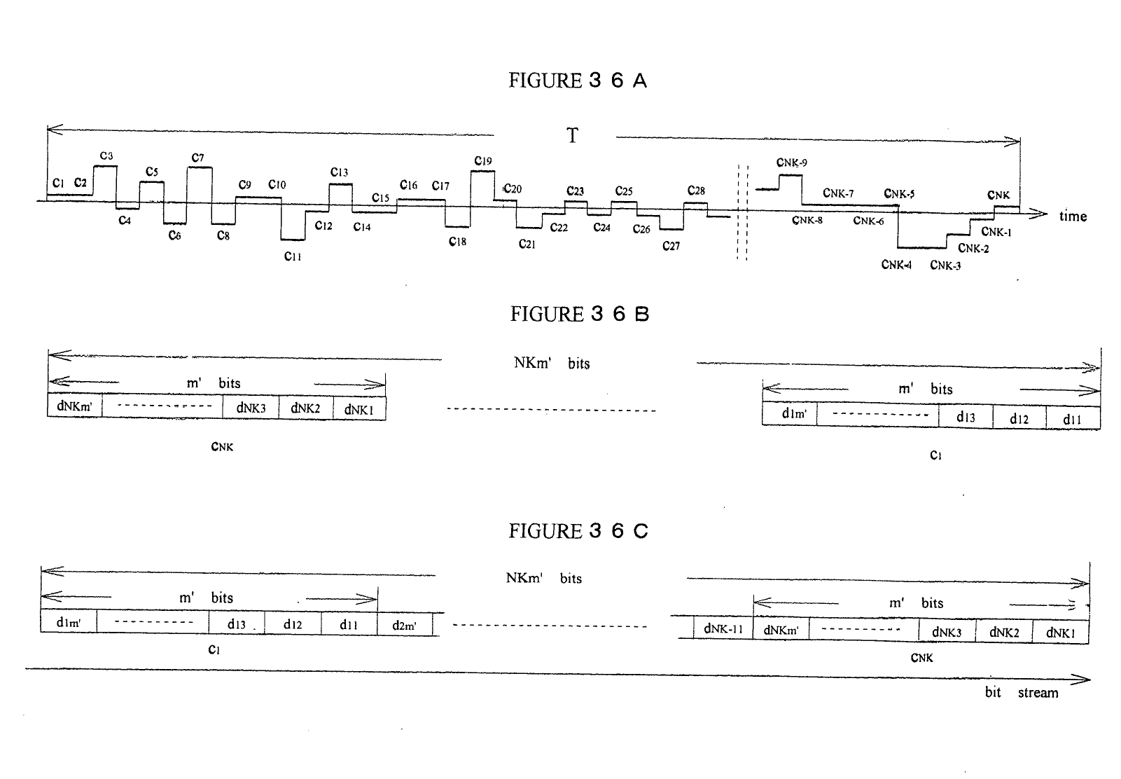

FIG. 36A to FIG. 36C exemplify waveforms of the binary pulses converted from multiply added basic pulse sequence and the data formats for transmission and the memorization.

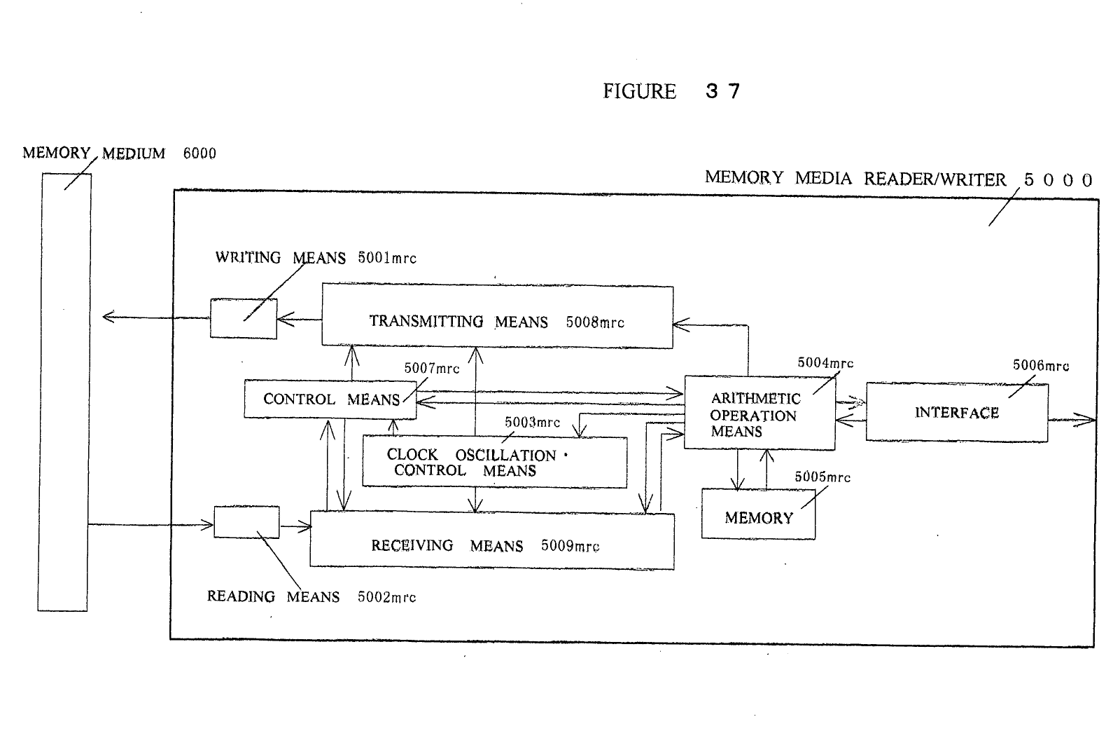

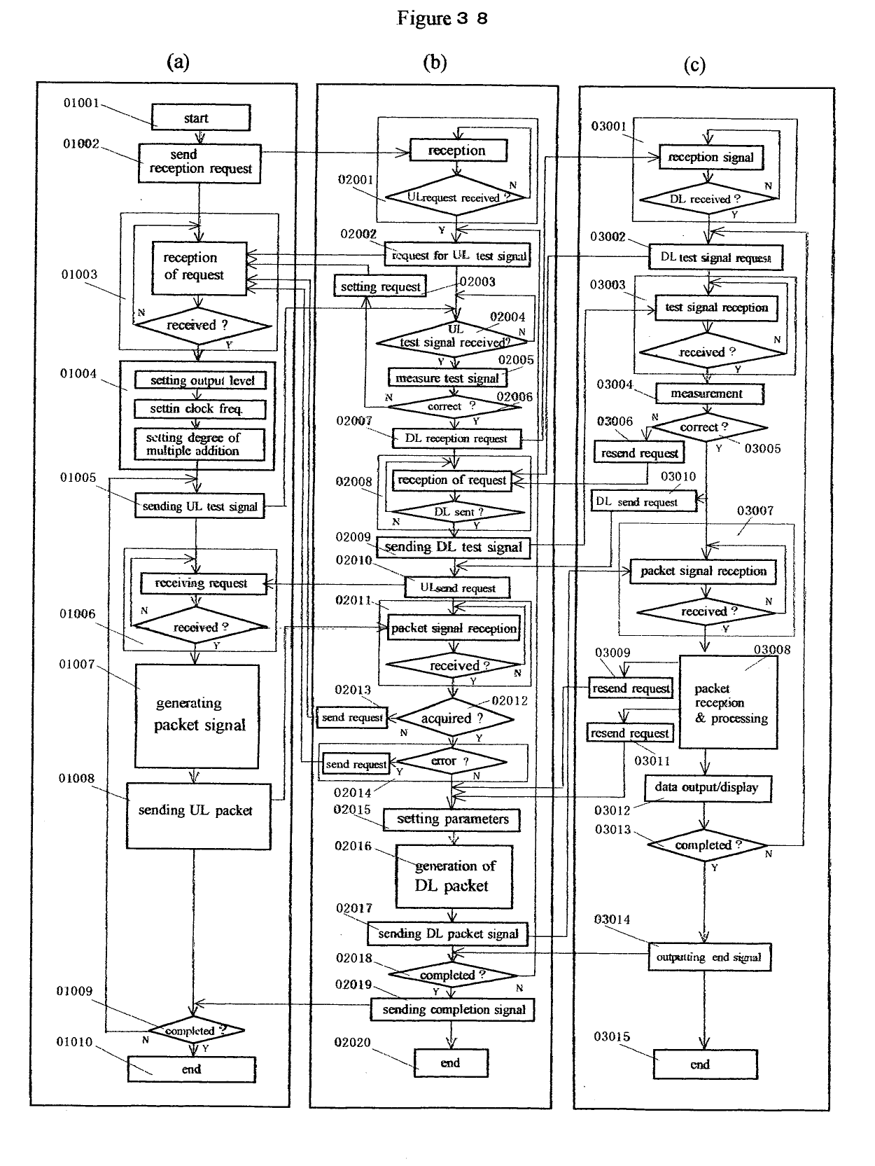

FIG. 36A is an example of the waveform of multiply added basic pulse sequence and FIG. 36B shows an data format of the binary data converted from the sequence for transmission, but other format may be used. The format shown in FIG. 36B is used for memorization, but other format may be used. Moreover, FIG. 36C shows a bit stream converted from the multiply added basic pulse sequence shown in Figure B although other format may be used. The technique to use the bit stream is applicable to an internal and/or external communications of ICs, internal transmission of devices, transmission of communication systems. FIG. 37 illustrate an embodiment of the memory reader/writer 500 using bit streams and comprising transmitting means making use of the code type transmitting device 1 and the receiving means making use of the code type receiving device 200.

FIG. 36A exemplifies waveforms of the multiply added basic pulse sequence. FIG. 36B exemplifies a format of the bit data that are generated from a chip Cj of a multiply added basic pulse sequence and have m′ bits.

The binary data converted from the chips of a multiply added basic pulse sequence may be used for transmission, memorization and so forth. Obviously, binary system is applicable to the packet transmission system which transmits, but not limited to, m′KN bits representing a period of multiply added basic pulse sequence in a batch.

Chip pulses are regenerated from the bit stream received. The procedures up to calculation of the original data are the same as those of linear modulation system in which separation of the data mapped code pulse sequences, detection of the localized pulses and calculation of the original data will be done, sequentially. Some noise superimposed on the bit stream is suppressed in the process of separation and localization of the data mapped code pulse sequences, contributing to the improvement of SNR.

FIG. 37 illustrate an embodiment of the memory reader/writer 5000 having transmitting means making use of the code type transmitting device 1 and the receiving means making use of the code type receiving device 200, in which binary pulses are used for read and write to the memory media 6000mrc. The device comprises a writing means 5001mrc, a reading means 5002mrc, a clock oscillation and control means 5003mrc, an arithmetic operation means 5004mrc, a memory 5005mrc, an interface means 5006mrc, control means 5007mrc, a transmitting means 5008mrc and a receiving means 5009mrc. It will be obvious to those skilled in the art that various changes to the invention may be made without departing from the scope of the invention. The transmitting means 5008mrc comprising a part of or a whole the code type transmitting device 1 is used to generate a transmission signal based on the multiply added basic pulse sequence by making use of the data and IDs input through the interface. Receiving means 5009mrc comprising a part of or whole the code type receiving device 200 calculate the information on the original data and so forth from the data based on the multiply added basic pulse sequences stored in the memory 6000mrc through an despreading and a localization. The calculated data are sent to the arithmetic operation means 5004mrc in which collation test between the ID stored in the memory 5005mrc are done. Simultaneously, the data collated are sent to the external devices via the interface. The memory reader/writer 5000 may be embedded in other device.

Memory media 6000mrc includes, but not limited to, optical memory media to which laser beam is used for read and/or write, magnetic memory media, electromagnetic memory media, electric memory media.

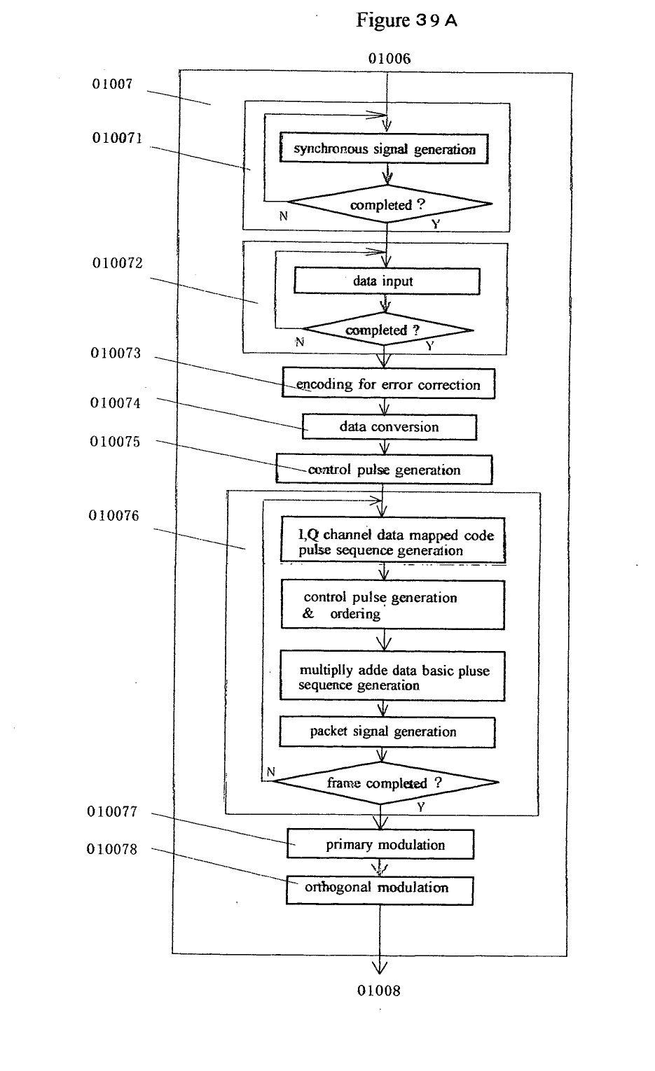

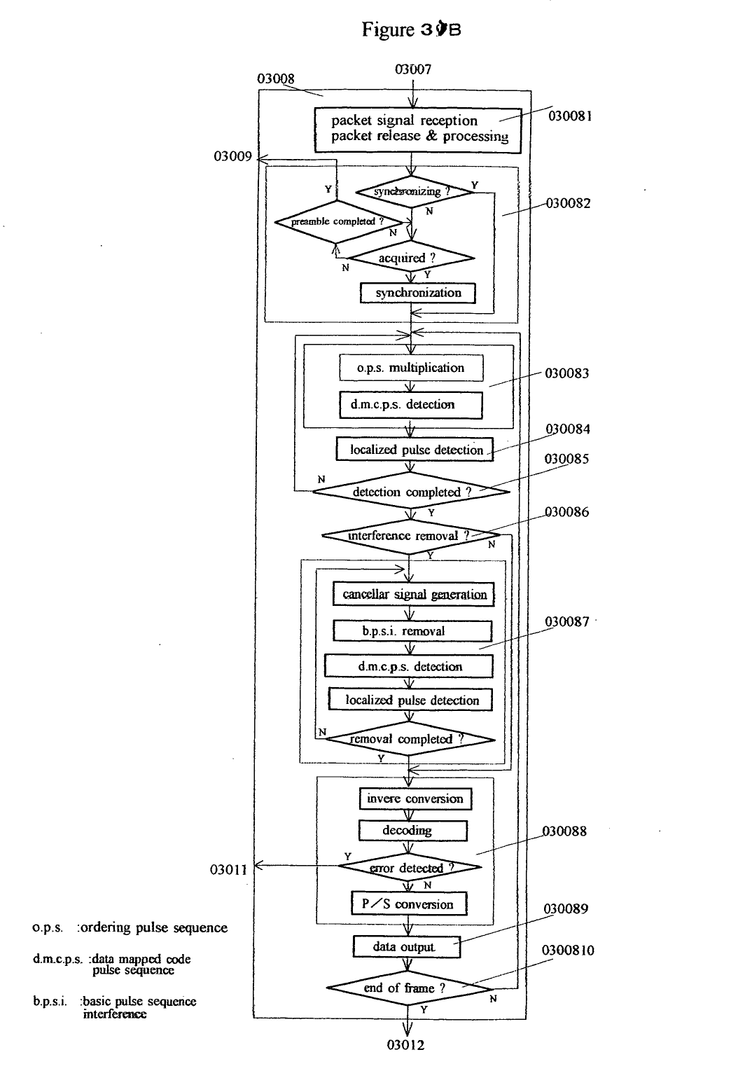

FIGS. 38 (a) to (c), FIG. 39A, and FIG. 39B exemplify a flow chart for processing of the packet type transmission system, using orthogonal modulation, comprising a number of code type transmitting device 1s, a base station and a number of code type receiving device 200s. The packet is so composed that the data slots of the packet frame use binary data converted from the chips of the multiply added basic pulse sequences. The packet may use linear modulated signals generated through a modulation by the multiply added basic pulse sequences instead of the binary pulses. The base station may be constructed by making use of a hub or a router. The system may be so composed that a direct communication among the transmitters and the receivers will be done instead of the use of the base station.

FIG. 38 (a) exemplifies a flow chart for processing at the transmitting side at which the code type transmitting device is are used, (b) shows an example of a flow chart for processing at the base station, and (c) exemplifies a flow chart for processing at the receiving side at which code type receiving device 200s using orthogonal demodulation and communicable with the code type transmitting device is following the flowchart shown in FIG. 38(a). The code type transmitting device 1 generates multiply added basic pulse sequences by multiplying the data mapped code pulse sequences by a kind of or kinds of ordering sequences having a period of or an integral multiplication of the period of the data mapped code pulse sequences, then makes and sends the packet signals composed by making use of the multiply added basic pulse sequences and, at least, synchronous signal, or the code type transmitting device 1 generates multiply added basic pulse sequence in every period of the data mapped code pulse sequence and makes a packet signal including data signals for transmission. The generation of the packet signal may be done in the base station instead of the code type transmitting device 1. The base station controls the transmission power, the transmission speed, the degree of multiple addition of the transmission signal, and so forth of the code type transmitting device is via communication means 100. Simultaneously, it controls the code type receiving device 200s. Then, the base station calculate the original data form the up-link (UL) packet signals and generates the packet signal with converted carrier frequency for down-link (DL) and sends it to the receiving device 200. The packet signal for DL is generated by making use of the data calculated from the UP packet signal or it is made by converting the frequency of the UP packet signal to that of DL although the ways the base station employs for generation is not limited to those described herein above and it is obvious to those skilled in the art that various changes will be made without departing from the scope of the invention.

The code type receiving device 200 receives the DL signal to calculate the original data.

When the transmission starts in step 01001 in FIG. 38 (a), the starting signal including ID is sent to the base station at 38 (b). The base station detects the signal in step 02001 and, in step 02002, send to the transmitting side request signal asking for transmission of a UL test signal. When the transmitting side receives the signal in step 01003, it sets up an output power, clock frequency and the degree of the multiple addition in step 01004 and send a test signal in step 01005. The base station receives the test signal and judges it from step 020004 to 02006 and sends back a request signal asking for set up in step 0203 if the signal is not properly set. Accordingly, the transmitting side repeats the steps from 01003 to 01005 to resend the test signal. The step 02005 includes equalizing process.

The base station sends a signal asking for reception to the receiving side in step 02007 if it judges the UL signal is properly set. Accordingly, the receiving side sends to the base station a signal requesting for transmission of DL test signal from steps 03001 to 03002. Then, the base station sends a DL test signal to the receiving side from steps 02008 to 02009. The receiving side receives the test signal from steps 03003 to 03005. If the test signal is not properly set it sends a signal requesting for resend to the base station in step 03006. Accordingly, the base station resets the signal in step 02008 and resends it in step 02009. Then the receiving side receives, equalizes and judges the signal from step 03003 to 03005.

If the signal is properly set, the receiver side send to the base station a request for send of the signal including data information in step 03009. Then, the base station sends to the transmitting side a request for transmission of the UL signal including data information in step 02010. Accordingly, the transmitting side generates a packet signal for UL and sends it to the base station from the step 01006 to 01008. The base station receives the signal and proceeds it from step 02011 to 02012. If it fails acquisition and/or tracking, it will send to the transmitting side a request for retransmission in step 02013. If it detects a error or errors, it will send a request for retransmission to the transmitting side in step 02014. If properly received and processed, a DL packet signal the parameters of which are set properly is generated and sent to the receiving side from step 02015 to 02017. Accordingly, the receiving side releases packet of the received signal from step 03007 to 03008 to calculate, process and display the data from step 03012 and 03013.

If the receiving side fails acquisition, it will send to the base station a request for retransmission in step 03010. Similarly, if it detects an error, it will sends to the base station a retransmission request in step 03011. When reception is completed at the receiving side, a signal for completion will be generated and sent to the base station in step 03014. Then, the transmission is completed in step 03015. Accordingly, the base station generates an completion signal that is sent to the transmitting side from step 02018 to 02019 and complete the exchange service in step 03015. Consequently, the transmitting side completes transmission from step 01009 to 01010.

FIG. 39A shows a detailed flowchart for production of a packet signal shown in step 01007. If the transmitting side judges a signal requesting for retransmission in step 01006, a synchronous signal is generated in step 010071, then data are input in step 010072, next, encoding for error correction is performed in step 010073, and in step 010074 the data are converted into the notation system of base N consisting of m-figures, and then control pulses are generated according to the converted data of base N in step 01007. In step 010076, data mapped code pulse sequences for I-channel and for Q-channel, then those sequences are multiplied by ordering sequences having the code lengths that cover at least a periodic time of the basic pulse sequences or more than one periodic time of the data mapped code pulse sequences to generate basic pulse sequences. The ordering pulse sequences may consist of either a single code or more than one code, and each ordering pulse sequence provide an order to a data mapped code pulse sequence contained in a periodic time or provide an order, in a lump, to a set of data mapped code pulse sequences allocated consecutively for more than one periodic time.

If control pulses are used for reduction of interference noise, the data mapped code pulse sequences are multiplied by those pulses together with ordering pulses, then added multiply to generate a multiply added basic pulse sequence. Next, the sequence is converted into binary pulses that are used for composition of the data slots of the packet frame in which control signals such as synchronous pulses are included.

In step 010077, a primary modulation is performed, then in step 010078 an orthogonal modulation is performed, and then the step 01008 starts.

FIG. 39B illustrates the flow chart for processing packet signal shown in step 03008.

According to the step 03007, the packet signal will be received, then the packet will be unconfigured in order that the multiply added basic pulse sequence are reconstructed and control signals and so forth are processed. In step 030082, synchronous signals are detected to perform an acquisition and tracking. If the performance of the acquisition and/or tracking is failed, a signal request for retransmission is sent to the transmission side in step 03009. When the tracking is performed, the reconstructed multiply added basic pulse sequence is multiplied by an ordering sequence to separate the data mapped code pulse sequence of the order in step 030083, then the sequence is localized to detect the localized pulse in step in step 030084. The steps from 030083 to 030085 will be repeated until localized pulses are detected from all the basic pulse sequences. Next, in steps from 030086 to 030087, interference noise is removed with the aids of feedback between the localizable signal detecting means 240 and localized pulse detecting means 250.

If the step to remove interference noise is passed the flow will jump to step 030088 in which an inverse conversion from the numbers of the notation system of base N to binary numbers, decimal numbers, octal numbers, or others, a decoding from the encoded data for error correction and a P/S conversion will be done sequentially, then the original data will be output in step 030089. If any error is detected, a request for retransmission will be sent to the transmitting side in step 030011.

Steps from 030083 to 0300810 will be repeated until the processing of all the slots in the frame is completed. When the processing of the packet is completed, step will move to 03012 in which data are output to external computers, transmission lines, displays and so.

It is obvious to those skilled in the art that various changes will be made to respective steps without departing from the scope of the invention.

As explained hereinabove, the basic technical idea of the invention is related to the communications system, and the system comprises transmitting means by which the data are mapped onto the shift time of the code pulse sequences to produce data mapped code pulse sequences, receiving means that detect the transmitted signals, detect the shift times of the data mapped code pulse sequences from the detected signals and calculate the original data bay making use of the shift times, and base stations that send at least control signals by making use of which the transmitting means and/or the receiving means control the output power, and the transmitting sides and the receiving sides are directly communicable among themselves. The transmitting means may be made by making use of any code type transmitting device 1s said hereinbefore and the receiving means may be made by making use of any code type receiving device 200s that are communicable with the transmitting device Is. Moreover, instead of use of systems that contain one or more than one base station, systems, devices or IC circuits the transmitting sides and the receiving sides of which are directly communicable among themselves will be made without departing from the scope of the invention.

One of the embodiments of the present invention is machine-readable memory media that store a program for transmission which makes computers to generate ordering pulse sequences, to generate data mapped code pulse sequences having shift times onto which data are mapped in accordance with an ordering sequence, to generate basic pulse sequences having said data mapped code pulse sequences, to generate transmission signals based on the transmission signal generating pulses that contains said basic pulse sequences and to send said transmission signals. Said basic pulse sequences represent the data mapped ordering pulse sequences or the product basic pulse sequences.

Another embodiment of the present invention is machine-readable memory media that store a program for reception which makes computers to detect the transmission signals, to detect the data mapped code pulse sequences from the detected signals, to detect the shift times by localizing the signals and to calculate the data by making use of said shift times.

Another embodiment of the present invention is machine-readable memory media that store said program for transmission and said program for reception.

Another embodiment of the present invention is machine-readable memory media that store data of the signals based on the basic pulse sequences that contain data mapped code pulse sequences having shift times onto which data are mapped in accordance with the ordering sequence. Said memory media include at least, but not limited to, magnetic memories, IC memory chips, optically-readable memory media, hologram storage media, image storage media and bar codes. These media are used in the way, but not limited to, that they are buried, embedded, printed or formed in or on bills, securities, books, containers and so forth.

### INDUSTRIAL APPLICABILITY

The present invention is applicable to, but not limited to, ADSL communications via telephone line, VDSL communications, power line communications, cable television broadcasting systems, picture telephone systems, mobile phone systems (cellular phone systems), portable television systems, wireless LAN systems, RF IC tag systems, wireless communication systems, satellite telecommunication systems, optical communication systems, unidirectional and bi-directional television broadcasting systems, intra-device communications, intra-IC communications, intra- or inter-ubiquitous device communications, memory media storing data generated based on the data mapped code pulse sequences and ciphers for communications. The invention enables the systems, the devices, the Ics and so forth to have bi-directional as well as high speed unidirectional communication capabilities.

1. A code type transmitting device transmitting input data by making use of code pulse sequences representing code sequences, comprising:
means producing synchronous signals for acquisition and/or tracking;
means producing ordering pulse sequences synchronizing with said synchronous signals;
means producing data mapped code pulse sequences by making use of code pulse sequences having shift times set by said data according to said ordering pulses sequences; and
means producing transmission signals by making use of signals based on transmission signal generating pulse sequences containing at least basic pulse sequences including said code pulse sequences.

2. The code type transmitting device according to claim 1, wherein said ordering pulse sequences consist of code pulse sequences indicating orders by making use of types of said code sequences or shift times changing in ascending or descending order or in accordance with predetermined order to represent said orders.

3. The code type transmitting device according to claim 1, wherein said transmission signal generating pulse sequences are produced by making use of said data encoded for error correction and/or pulse sequences encoded for error correction.

4. The code type transmitting device according to claim 1, wherein said signals based on transmission signal generating pulse sequences comprise said multiply added data mapped code pulse sequence, impulse sequences generated based on said multiply added data mapped code pulse sequence, modulated signals modulated by either said multiply added data mapped code pulse sequence or said impulse sequences, or hopping signals generated by making use of one of said signals.

5. A code type receiving device for receiving transmission signals representing data by making use of shift times of code pulse sequences and calculating said data, comprising:
means detecting said transmission signals and generating detection signals;
means detecting signals containing data-mapped code pulse sequences having
said shift times representing said data from said detection signals;
means localizing said data-mapped code pulse sequences to generate localized pulses and detecting said shift times from said localized pulses; and
means calculating said data by making use of said shift times.

6. The code type receiving device according to claim 5, wherein said transmission signals contain encoded data, basic pulse sequences and/or multiply added basic pulse sequence for error correction and said code type receiving device contains means to decode said transmission signals to calculate said data.

7. The code type receiving device according to claim 5, wherein said code type receiving device contains means to remove interference noise superimposed on said code pulse sequences having said shift times representing said data and/or said localized pulses.

8. The code type receiving device according to claim 5, wherein said signals containing said data-mapped code pulse sequences having said shift times include either said code pulse sequences having said shift times or signals modulated by said code pulse sequences having said shift times.

9. A communications system, comprising:
code type transmitting devices converting input data into shift times of code pulse sequences, including:
means producing synchronous signals for acquisitions and/or tracking;
means producing ordering pulse sequences synchronizing with said synchronous signals;
means producing data mapped code pulse sequences by making use of said code pulse sequences having said shift times set by said data according to said ordering pulses sequences; and
means producing transmission signals by making use of signals based on transmission signal generating pulse sequences containing at least basic pulse sequences including said code pulse sequences; and
code type receiving devices for receiving said transmission signals representing said data by making use of said shift times of said code pulse sequences and calculating said data,
including:
means detecting said transmission signals to generate detection signals;
means detecting signals containing said code pulse sequences having said shift times representing said data from said detection signals;
means localizing said code pulse sequences to generate localized pulses and detecting said shift times from said localized pulses; and
means calculating said data by making use of said shift times.
